(19) United States
(12) Patent Application Publication
(10) Pub. No.: US 2025/0308271 A1
(43) Pub. Date: Oct. 2, 2025

(54) METHODS AND USER INTERFACES FOR SCANNING AND MANAGING ACCESS OF DOCUMENTS

(71) Applicant: Apple Inc., Cupertino, CA (US)

(72) Inventors: Johnnie B. MANZARI, San Francisco, CA (US); Jose N. AFONSECA ALVES, San Francisco, CA (US); Bradley F. CRADDOCK, San Francisco, CA (US); Julian K. MISSIG, Redwood City, CA (US); Fiona P. O'LEARY, Palo Alto, CA (US); Grant R. PAUL, San Francisco, CA (US)

(21) Appl. No.: 19/072,563

(22) Filed: Mar. 6, 2025

Related U.S. Application Data
(60) Provisional application No. 63/570,176, filed on Mar. 26, 2024.

(51) Int. Cl. G06V 30/14; G06V 30/20; H04N 23/56; H04N 23/73

(52) U.S. Cl. CPC G06V 30/1431; G06V 30/20; H04N 23/56; H04N 23/73

(57) ABSTRACT

The present disclosure generally relates to embodiments of document scanning processes using a dynamic flash and providing access to scanned documents.

### CROSS-REFERENCE TO RELATED APPLICATIONS

This application claims the benefit of U.S. Provisional Patent Application 63/570,176, entitled “METHODS AND USER INTERFACES FOR SCANNING AND MANAGING ACCESS OF DOCUMENTS,” filed Mar. 26, 2024, the contents of which is hereby incorporated in its entirety.

### FIELD

The present disclosure relates generally to computer user interfaces, and more specifically to techniques for managing a document scanning process.

### BACKGROUND

Computer systems can include hardware and/or software for performing a document scanning process.

### BRIEF SUMMARY

Some techniques for managing a document scanning process using electronic devices, however, are generally cumbersome and inefficient. For example, some existing techniques use a complex and time-consuming user interface, which may include multiple key presses or keystrokes. Existing techniques require more time than necessary, wasting user time and device energy. This latter consideration is particularly important in battery-operated devices.

Accordingly, the present technique provides electronic devices with faster, more efficient methods and interfaces for managing a document scanning process. Such methods and interfaces optionally complement or replace other methods for managing a document scanning process. Such methods and interfaces reduce the cognitive burden on a user and produce a more efficient human-machine interface. For battery-operated computing devices, such methods and interfaces conserve power and increase the time between battery charges by reducing the number of inputs required to perform the document scanning process.

In accordance with some embodiments, a method performed at a computer system that is in communication with a display generation component, one or more input devices, a camera, and a light source is described. The method comprises: detecting, via the one or more input devices, a request to capture image data with the camera; in response to detecting, via the one or more input devices, the request to capture image data with the camera: in accordance with a determination that the request to capture image data corresponds to a request to scan a document: illuminating at least a first portion of an environment within a field-of-view of the camera by generating light from the light source in a first manner; and capturing, via the camera, first image data; and in accordance with a determination that the request to capture image data corresponds to a request to capture visual media: illuminating at least a second portion of the environment within a field-of-view of the camera by generating light from the light source in a second manner different from the first manner; and capturing, via the camera, second image data different from the first image data.

In accordance with some embodiments, a non-transitory computer-readable storage medium is described. The non-transitory computer-readable storage medium stores one or more programs configured to be executed by one or more processors of a computer system that is in communication with a display generation component, one or more input devices, a camera, and a light source, the one or more programs including instructions for: detecting, via the one or more input devices, a request to capture image data with the camera; in response to detecting, via the one or more input devices, the request to capture image data with the camera: in accordance with a determination that the request to capture image data corresponds to a request to scan a document: illuminating at least a first portion of an environment within a field-of-view of the camera by generating light from the light source in a first manner; and capturing, via the camera, first image data; and in accordance with a determination that the request to capture image data corresponds to a request to capture visual media: illuminating at least a second portion of the environment within a field-of-view of the camera by generating light from the light source in a second manner different from the first manner; and capturing, via the camera, second image data different from the first image data.

In accordance with some embodiments, a transitory computer-readable storage medium is described. The transitory computer-readable storage medium stores one or more programs configured to be executed by one or more processors of a computer system that is in communication with a display generation component, one or more input devices, a camera, and a light source, the one or more programs including instructions for: detecting, via the one or more input devices, a request to capture image data with the camera; in response to detecting, via the one or more input devices, the request to capture image data with the camera: in accordance with a determination that the request to capture image data corresponds to a request to scan a document: illuminating at least a first portion of an environment within a field-of-view of the camera by generating light from the light source in a first manner; and capturing, via the camera, first image data; and in accordance with a determination that the request to capture image data corresponds to a request to capture visual media: illuminating at least a second portion of the environment within a field-of-view of the camera by generating light from the light source in a second manner different from the first manner; and capturing, via the camera, second image data different from the first image data.

In accordance with some embodiments, a computer system is described. The computer system comprises one or more processors, wherein the computer system is configured to communicate with a display generation component, one or more input devices, a camera, a light source, and memory storing one or more programs configured to be executed by the one or more processors, the one or more programs including instructions for: detecting, via the one or more input devices, a request to capture image data with the camera; in response to detecting, via the one or more input devices, the request to capture image data with the camera: in accordance with a determination that the request to capture image data corresponds to a request to scan a document: illuminating at least a first portion of an environment within a field-of-view of the camera by generating light from the light source in a first manner; and capturing, via the camera, first image data; and in accordance with a determination that the request to capture image data corresponds to a request to capture visual media: illuminating at least a second portion of the environment within a field-of-view of the camera by generating light from the light source in a second manner different from the first manner; and capturing, via the camera, second image data different from the first image data.

In accordance with some embodiments, a computer system is described. The computer system is configured to communicate with a display generation component, one or more input devices, a camera, and a light source. The computer system comprises: means for detecting, via the one or more input devices, a request to capture image data with the camera; means, in response to detecting, via the one or more input devices, the request to capture image data with the camera, for: in accordance with a determination that the request to capture image data corresponds to a request to scan a document: illuminating at least a first portion of an environment within a field-of-view of the camera by generating light from the light source in a first manner; and capturing, via the camera, first image data; and in accordance with a determination that the request to capture image data corresponds to a request to capture visual media: illuminating at least a second portion of the environment within a field-of-view of the camera by generating light from the light source in a second manner different from the first manner; and capturing, via the camera, second image data different from the first image data.

In accordance with some embodiments, a computer program product is described. The computer program product comprises one or more programs configured to be executed by one or more processors of a computer system that is in communication with a display generation component, one or more input devices, a camera, and a light source, the one or more programs including instructions for: detecting, via the one or more input devices, a request to capture image data with the camera; in response to detecting, via the one or more input devices, the request to capture image data with the camera: in accordance with a determination that the request to capture image data corresponds to a request to scan a document: illuminating at least a first portion of an environment within a field-of-view of the camera by generating light from the light source in a first manner; and capturing, via the camera, first image data; and in accordance with a determination that the request to capture image data corresponds to a request to capture visual media: illuminating at least a second portion of the environment within a field-of-view of the camera by generating light from the light source in a second manner different from the first manner; and capturing, via the camera, second image data different from the first image data.

In accordance with some embodiments, a method performed at a computer system that is in communication with a display generation component and one or more input devices is described. The method comprises: obtaining image data including visual information corresponding to a document; in response to obtaining the image data including the visual information corresponding to the document: in accordance with a determination that the document includes a first type of content, providing access to a representation of the document via a first application; and in accordance with a determination that the document includes a second type of content different from the first type of content, providing access to the representation of the document via a second application different from the first application.

In accordance with some embodiments, a non-transitory computer-readable storage medium is described. The non-transitory computer-readable storage medium stores one or more programs configured to be executed by one or more processors of a computer system that is in communication with a display generation component and one or more input devices, the one or more programs including instructions for: obtaining image data including visual information corresponding to a document; in response to obtaining the image data including the visual information corresponding to the document: in accordance with a determination that the document includes a first type of content, providing access to a representation of the document via a first application; and in accordance with a determination that the document includes a second type of content different from the first type of content, providing access to the representation of the document via a second application different from the first application.

In accordance with some embodiments, a transitory computer-readable storage medium is described. The transitory computer-readable storage medium stores one or more programs configured to be executed by one or more processors of a computer system that is in communication with a display generation component and one or more input devices, the one or more programs including instructions for: obtaining image data including visual information corresponding to a document; in response to obtaining the image data including the visual information corresponding to the document: in accordance with a determination that the document includes a first type of content, providing access to a representation of the document via a first application; and in accordance with a determination that the document includes a second type of content different from the first type of content, providing access to the representation of the document via a second application different from the first application.

In accordance with some embodiments, a computer system is described. The computer system comprises one or more processors, wherein the computer system is configured to communicate with a display generation component, one or more input devices, and memory storing one or more programs configured to be executed by the one or more processors, the one or more programs including instructions for: obtaining image data including visual information corresponding to a document; in response to obtaining the image data including the visual information corresponding to the document: in accordance with a determination that the document includes a first type of content, providing access to a representation of the document via a first application; and in accordance with a determination that the document includes a second type of content different from the first type of content, providing access to the representation of the document via a second application different from the first application.

In accordance with some embodiments, a computer system is described. The computer system is configured to communicate with a display generation component and one or more input devices. The computer system comprises: means for obtaining image data including visual information corresponding to a document; means, in response to obtaining the image data including the visual information corresponding to the document, for: in accordance with a determination that the document includes a first type of content, providing access to a representation of the document via a first application; and in accordance with a determination that the document includes a second type of content different from the first type of content, providing access to the representation of the document via a second application different from the first application.

In accordance with some embodiments, a computer program product is described. The computer program product comprises one or more programs configured to be executed by one or more processors of a computer system that is in communication with a display generation component and one or more input devices, the one or more programs including instructions for: obtaining image data including visual information corresponding to a document; in response to obtaining the image data including the visual information corresponding to the document: in accordance with a determination that the document includes a first type of content, providing access to a representation of the document via a first application; and in accordance with a determination that the document includes a second type of content different from the first type of content, providing access to the representation of the document via a second application different from the first application.

Executable instructions for performing these functions are, optionally, included in a non-transitory computer-readable storage medium or other computer program product configured for execution by one or more processors. Executable instructions for performing these functions are, optionally, included in a transitory computer-readable storage medium or other computer program product configured for execution by one or more processors.

Thus, devices are provided with faster, more efficient methods and interfaces for managing a document scanning process, thereby increasing the effectiveness, efficiency, and user satisfaction with such devices. Such methods and interfaces may complement or replace other methods for managing a document scanning process.

### DESCRIPTION OF THE FIGURES

For a better understanding of the various described embodiments, reference should be made to the Description of Embodiments below, in conjunction with the following drawings in which like reference numerals refer to corresponding parts throughout the figures.

FIG. 1A is a block diagram illustrating a portable multifunction device with a touch-sensitive display in accordance with some embodiments.

FIG. 1B is a block diagram illustrating exemplary components for event handling in accordance with some embodiments.

FIG. 2 illustrates a portable multifunction device having a touch screen in accordance with some embodiments.

FIG. 3A is a block diagram of an exemplary multifunction device with a display and a touch-sensitive surface in accordance with some embodiments.

FIGS. 3B-3G illustrate the use of Application Programming Interfaces (APIs) to perform operations.

FIG. 4A illustrates an exemplary user interface for a menu of applications on a portable multifunction device in accordance with some embodiments.

FIG. 4B illustrates an exemplary user interface for a multifunction device with a touch-sensitive surface that is separate from the display in accordance with some embodiments.

FIG. 5A illustrates a personal electronic device in accordance with some embodiments.

FIG. 5B is a block diagram illustrating a personal electronic device in accordance with some embodiments.

FIGS. 6A-6O illustrate exemplary user interfaces and illumination techniques for scanning documents, in accordance with some embodiments.

FIG. 7 is a flow diagram illustrating a method for scanning documents, in accordance with some embodiments.

FIGS. 8A-8AC illustrate exemplary user interfaces for managing access to scanned documents, in accordance with some embodiments.

FIG. 9 is a flow diagram illustrating a method for managing access to scanned documents, in accordance with some embodiments.

### DESCRIPTION OF EMBODIMENTS

The following description sets forth exemplary methods, parameters, and the like. It should be recognized, however, that such description is not intended as a limitation on the scope of the present disclosure but is instead provided as a description of exemplary embodiments.

There is a need for electronic devices that provide efficient methods and interfaces for document scanning. For example, there is a need for electronic devices with improved scan quality and improved management of scanned documents. Such techniques can reduce the cognitive burden on a user who scans documents, thereby enhancing productivity. Further, such techniques can reduce processor and battery power otherwise wasted on redundant user inputs.

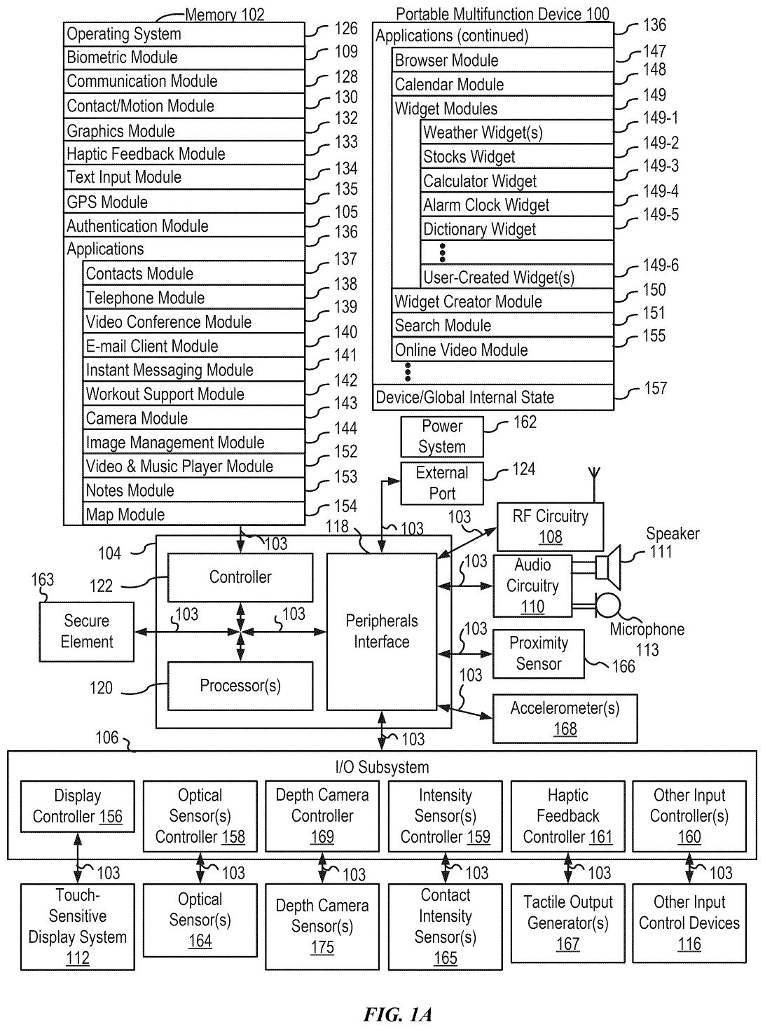

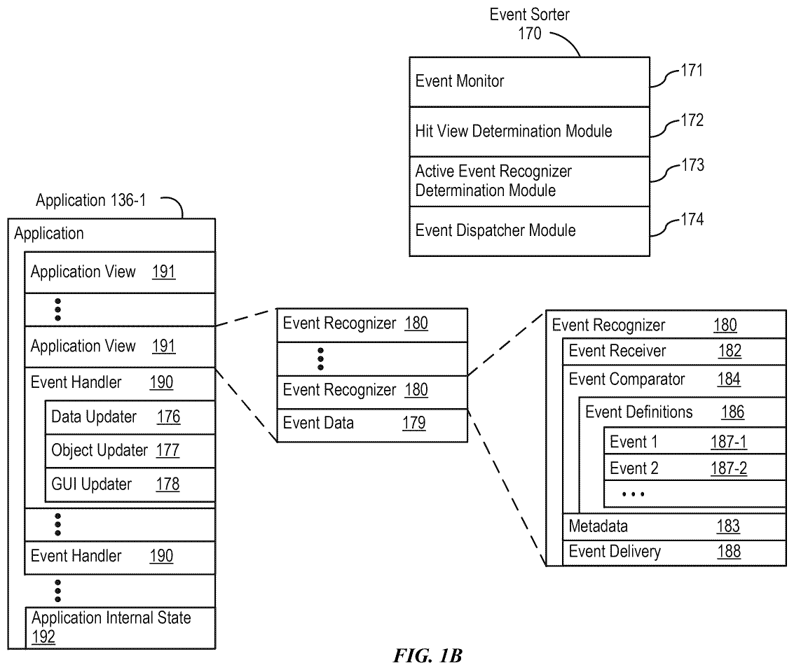

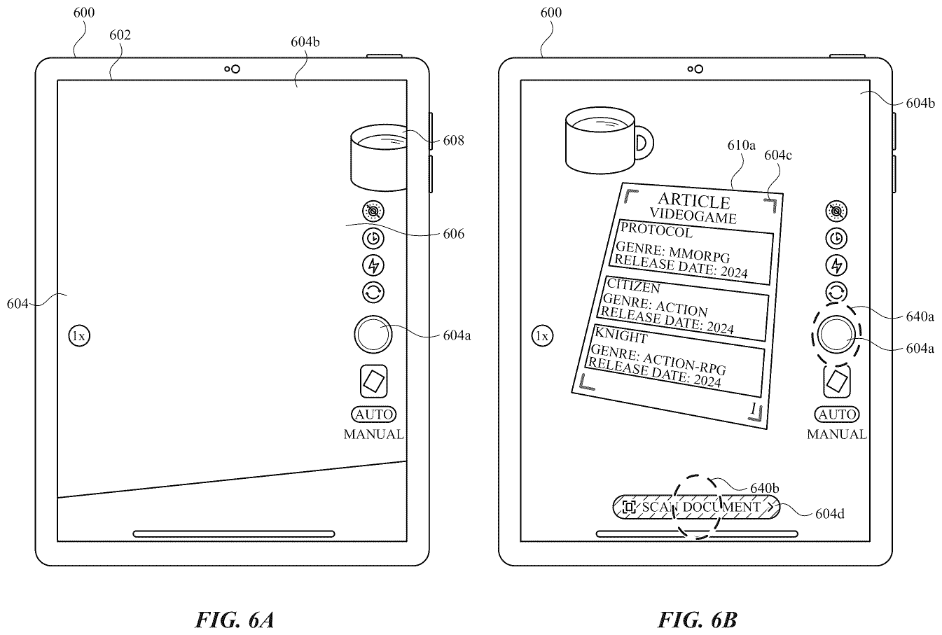

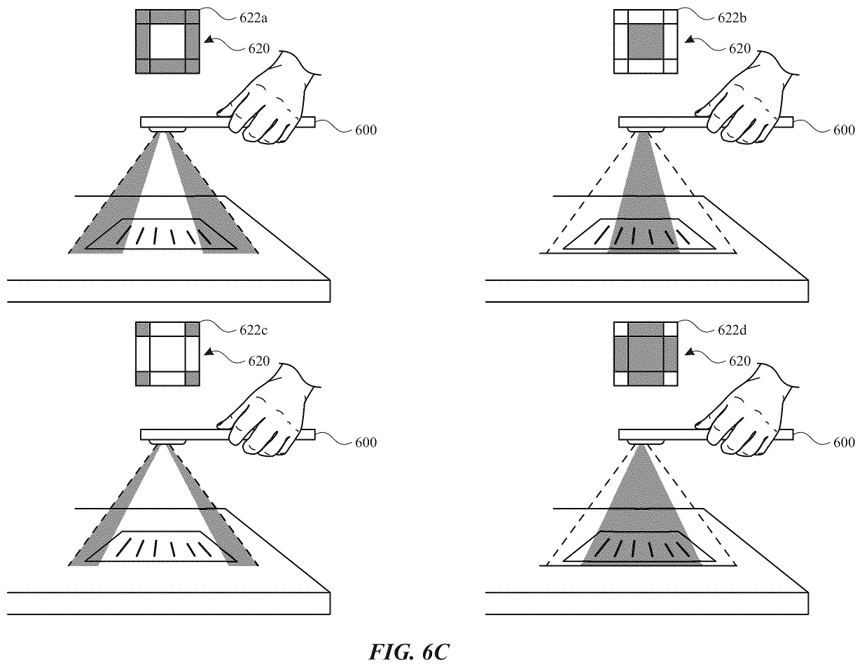

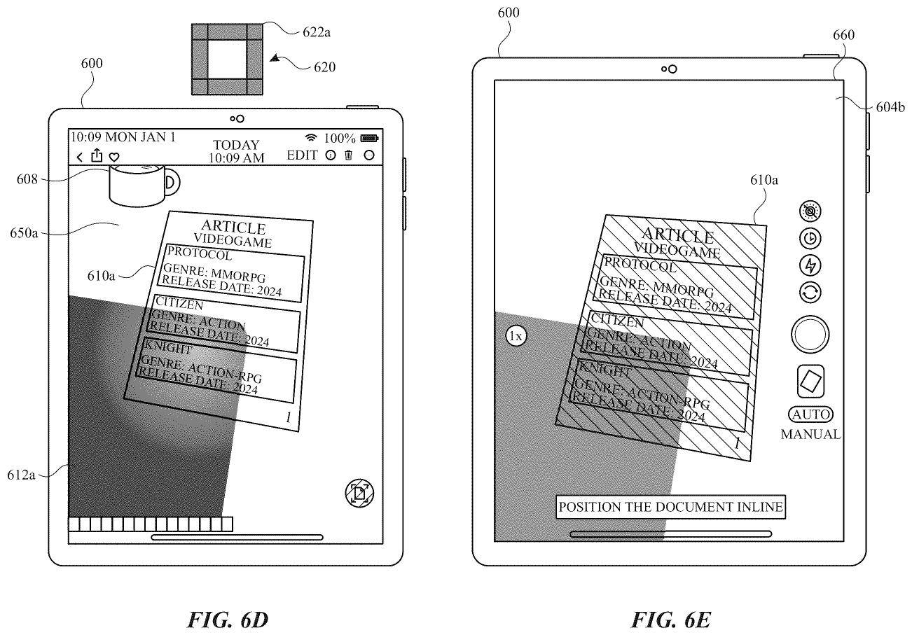

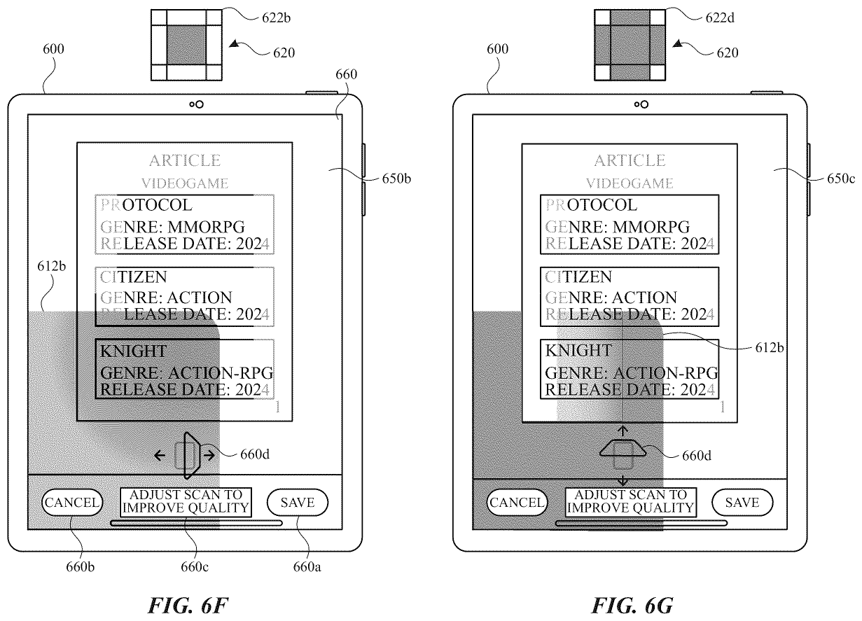

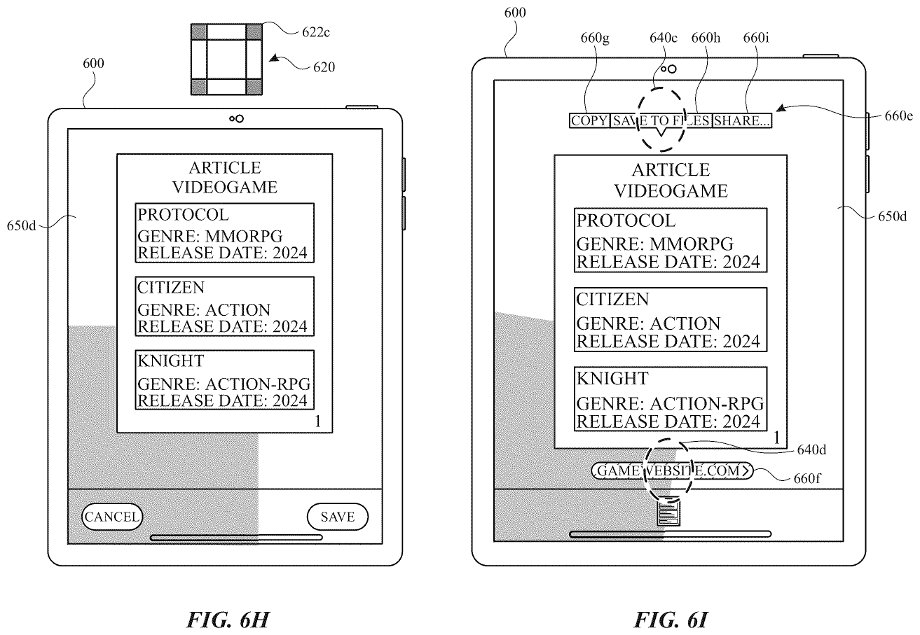

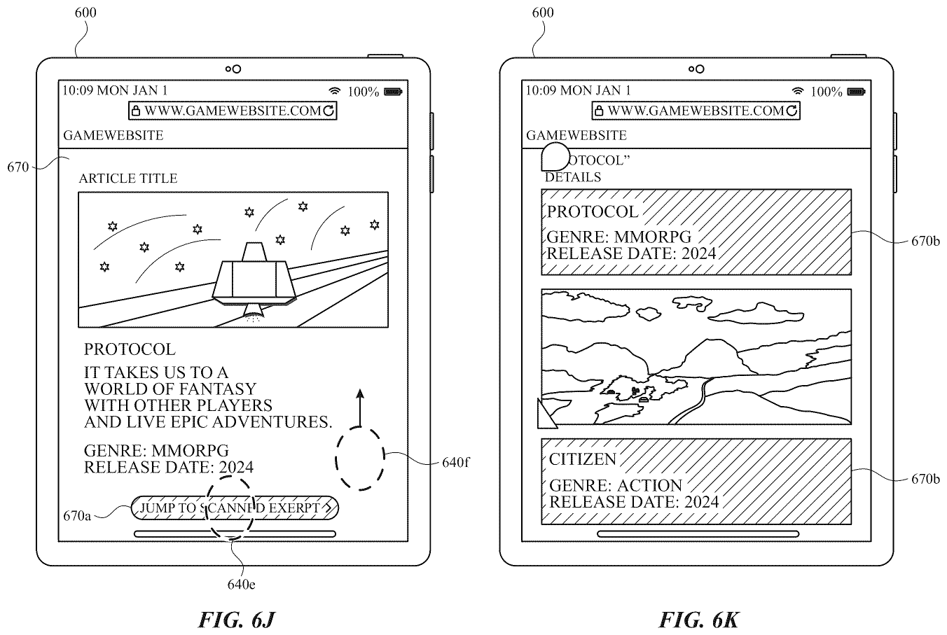

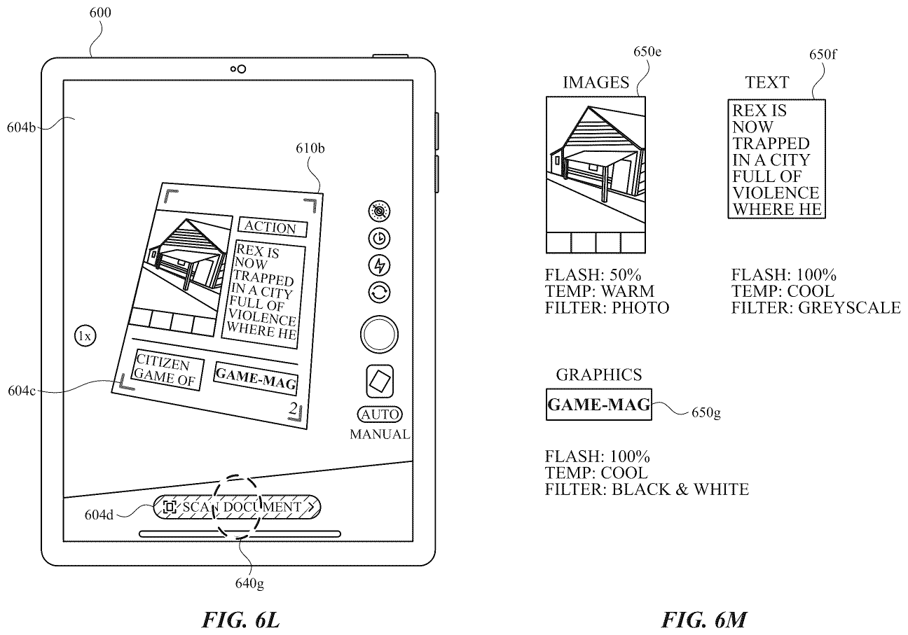

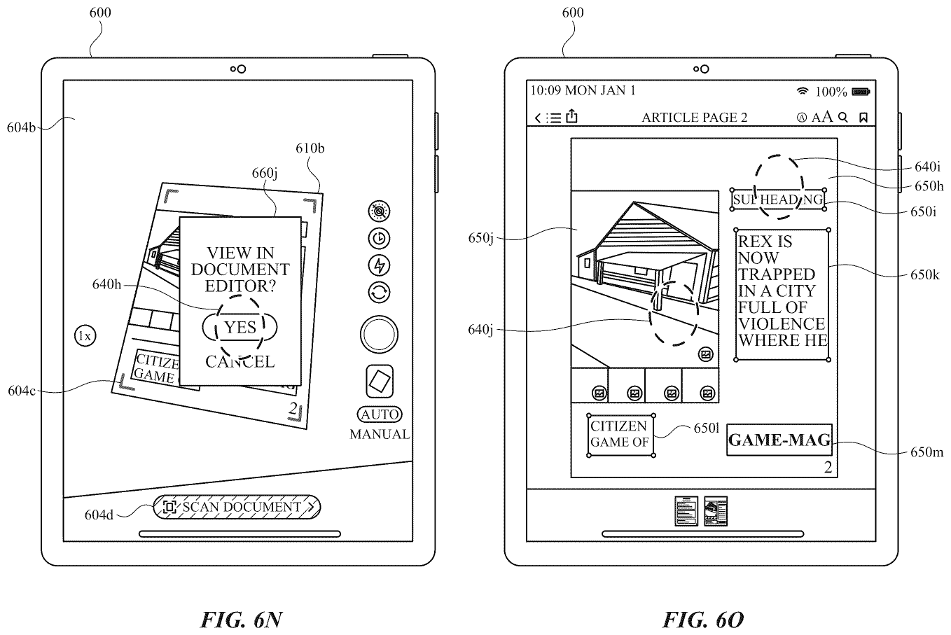

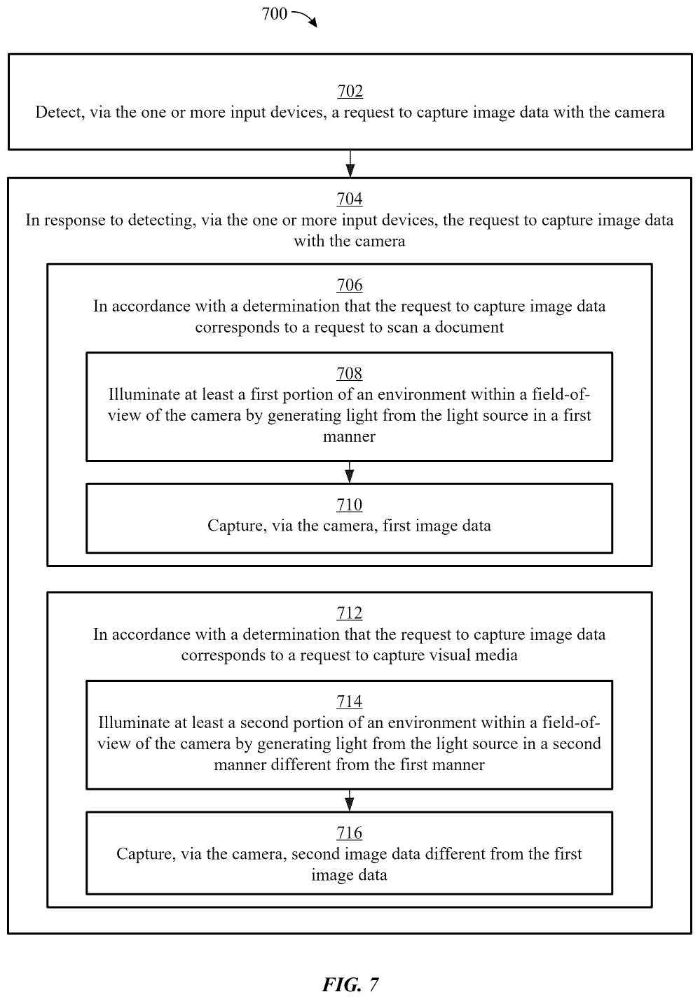

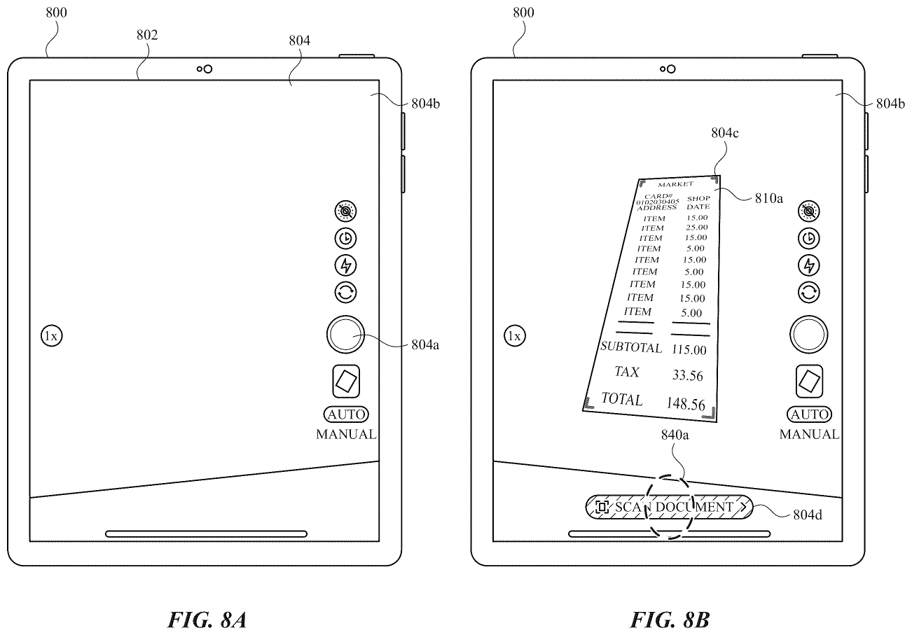

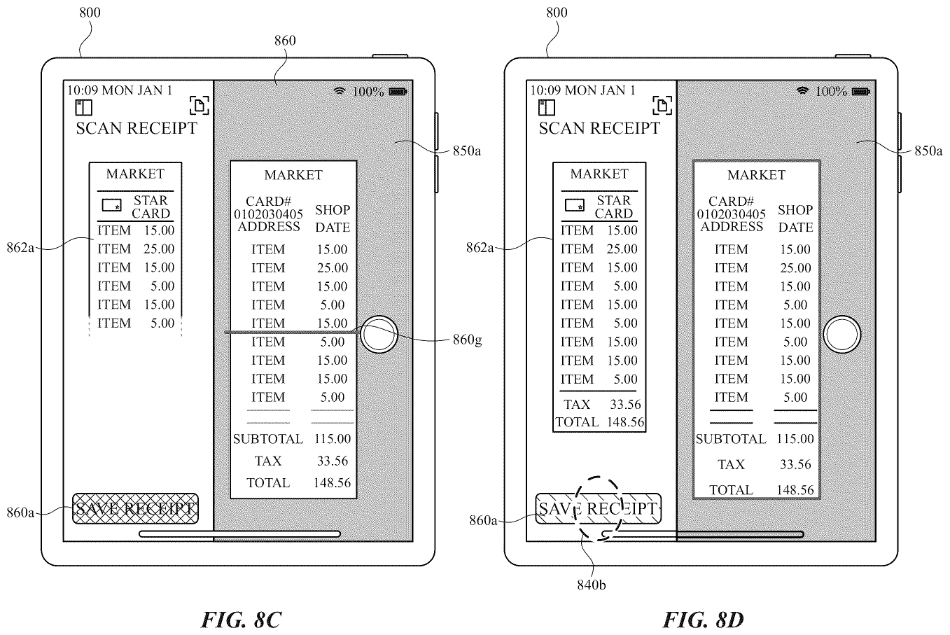

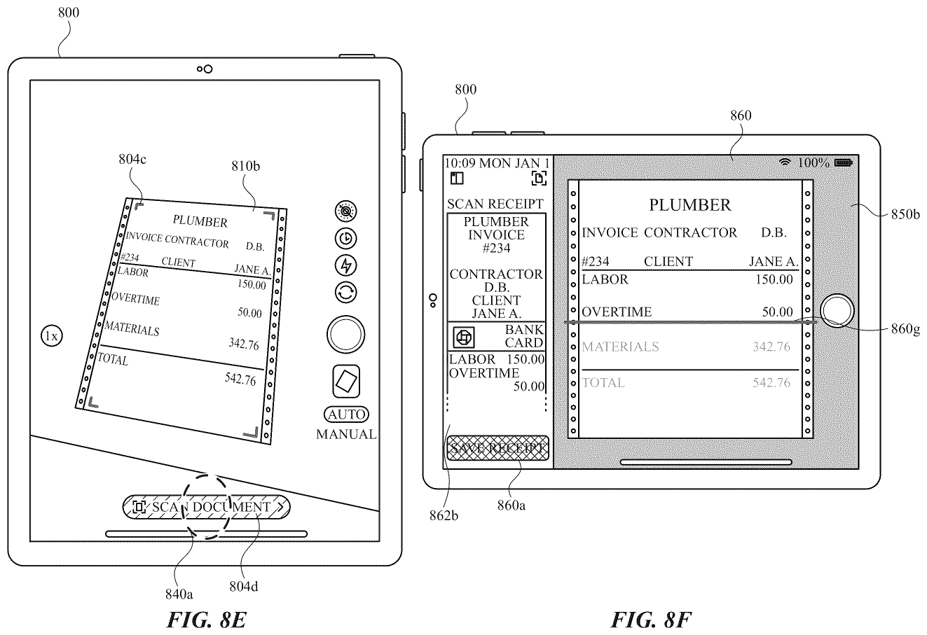

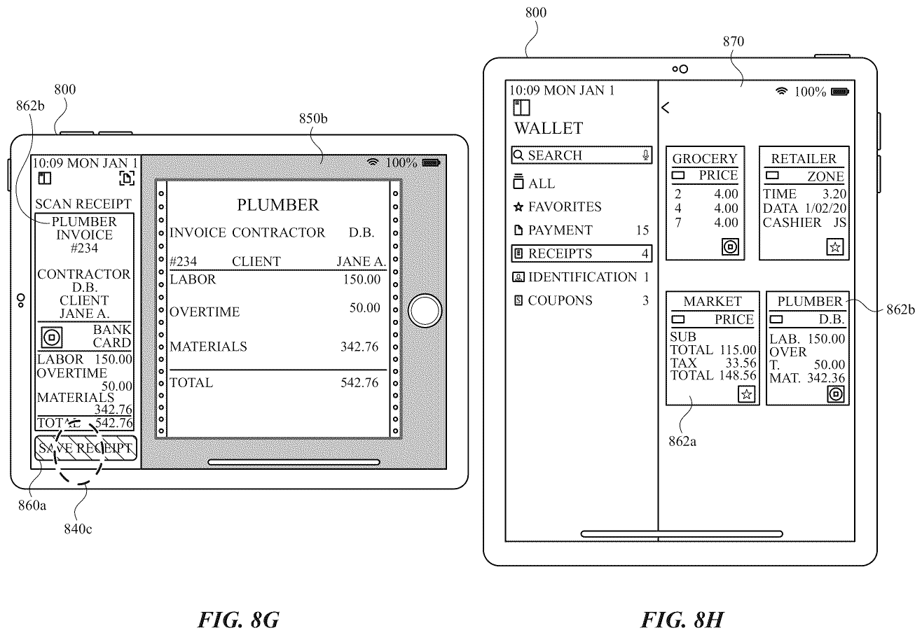

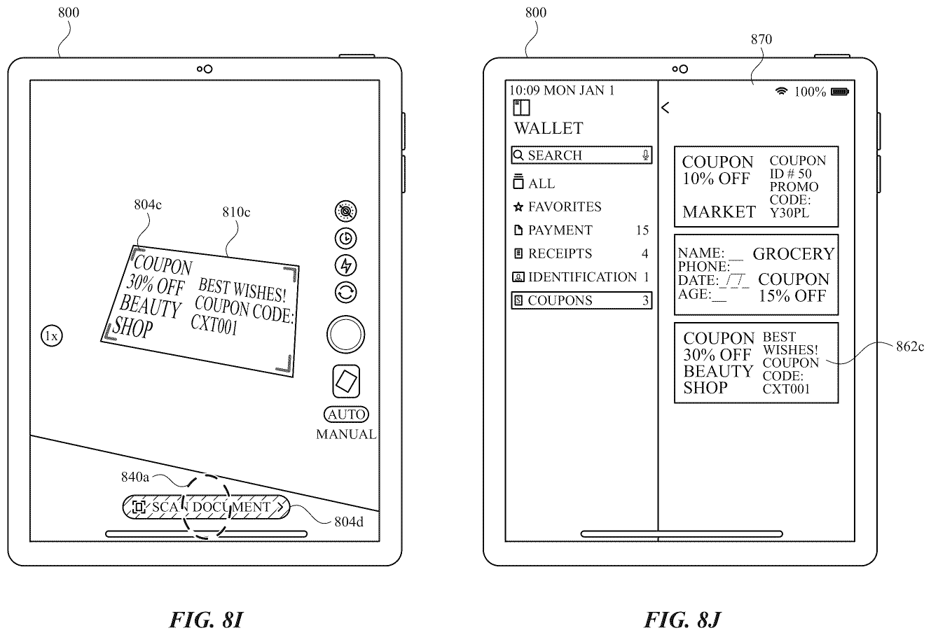

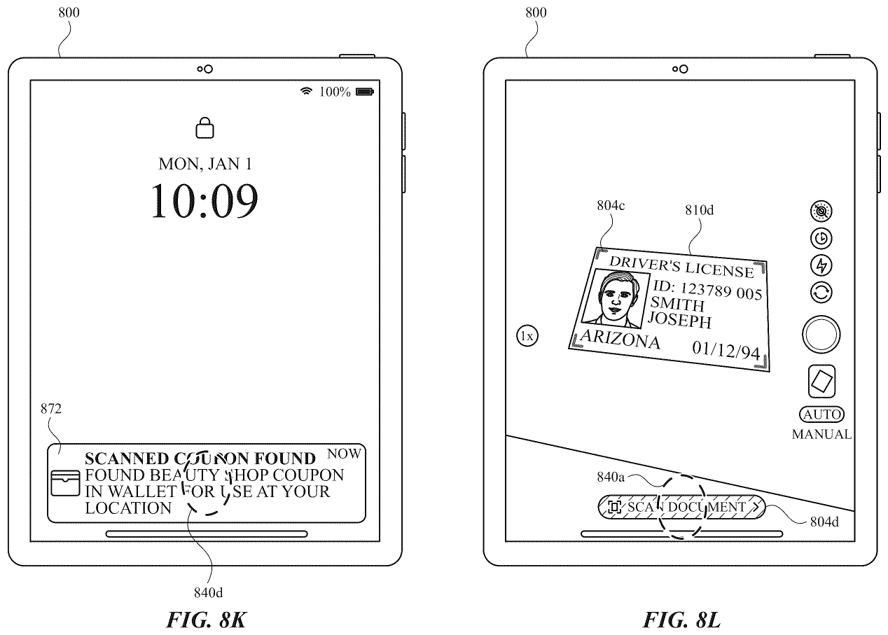

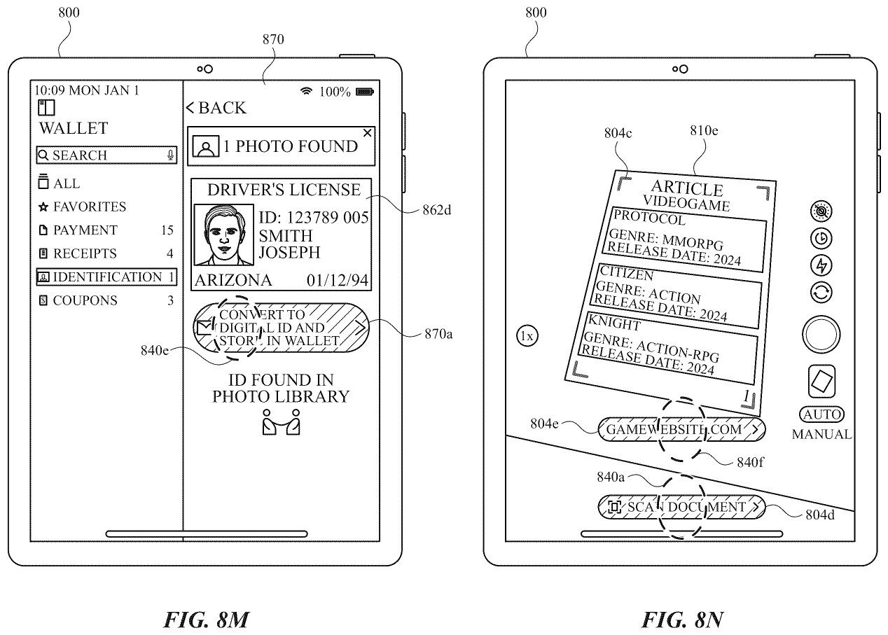

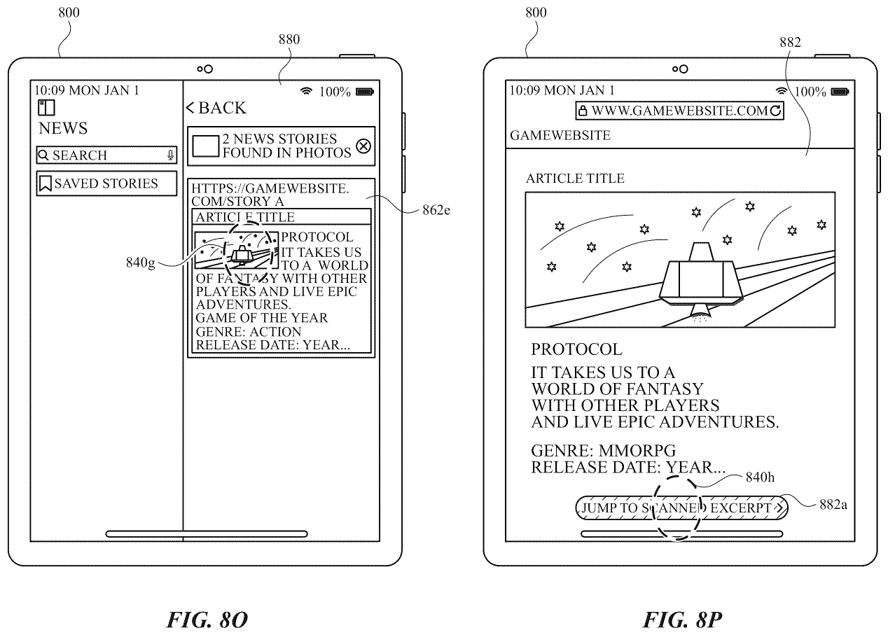

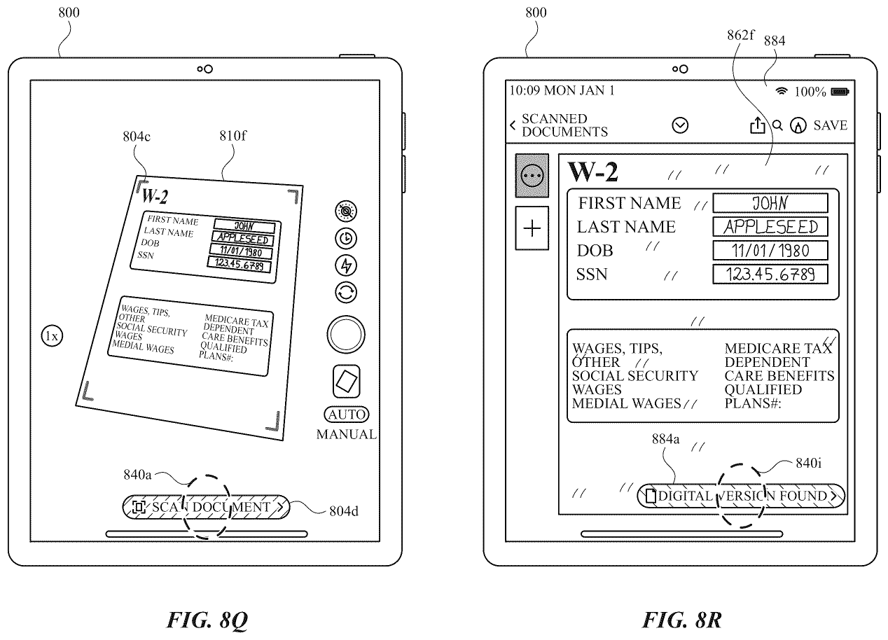

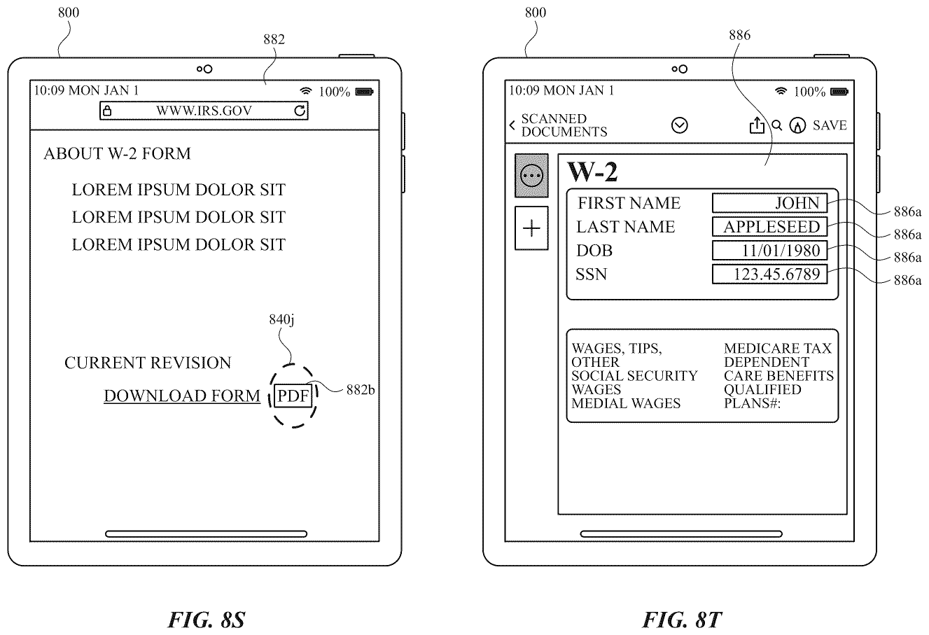

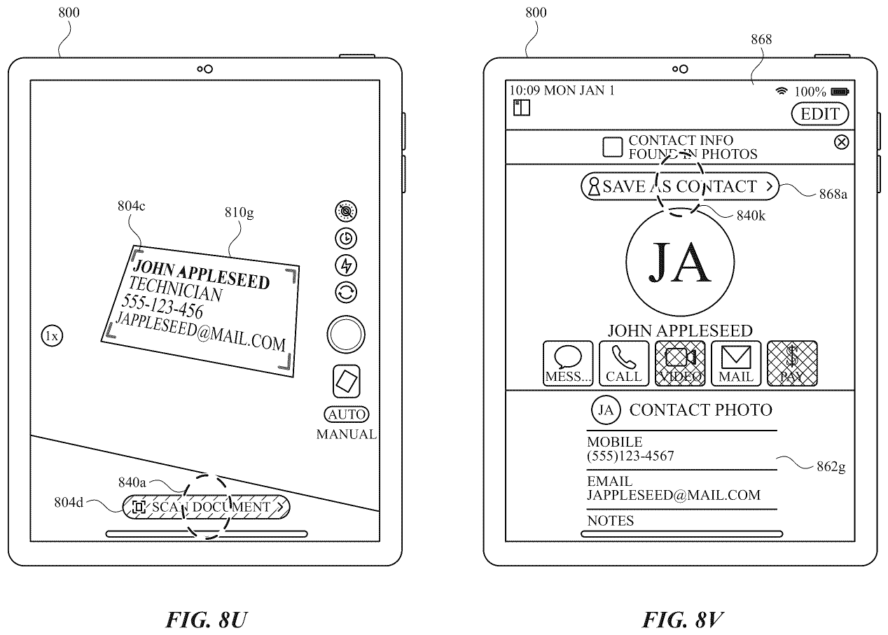

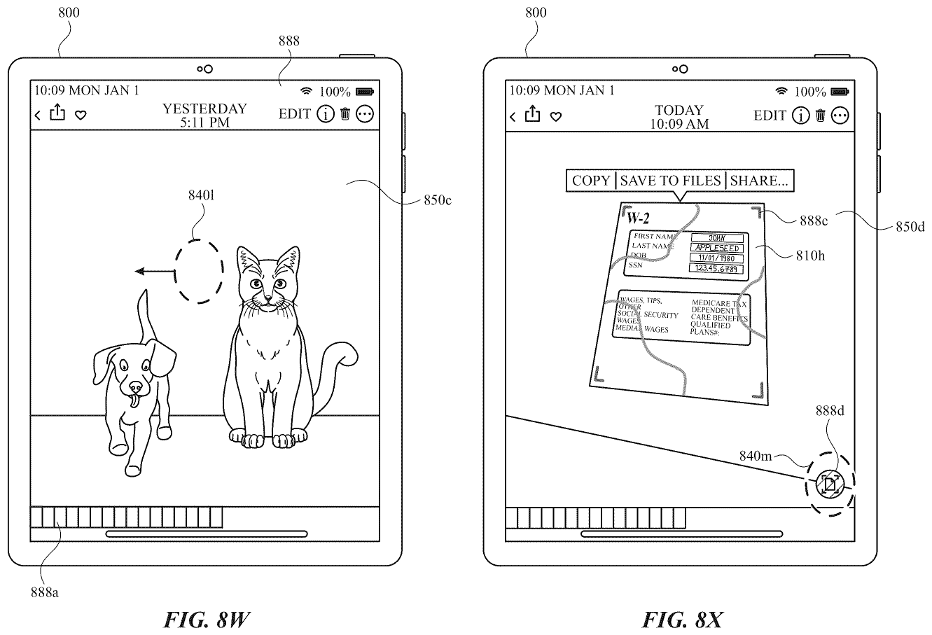

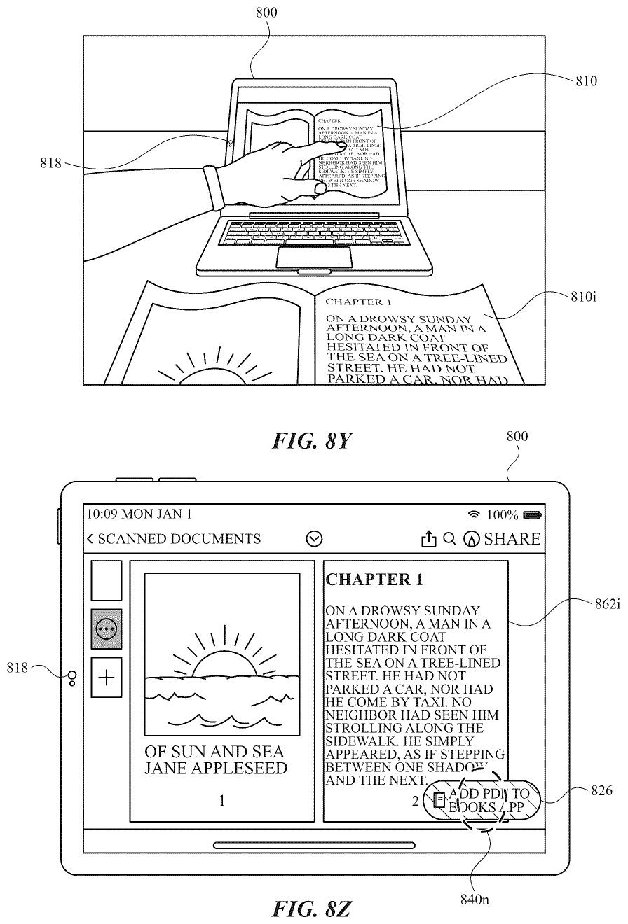

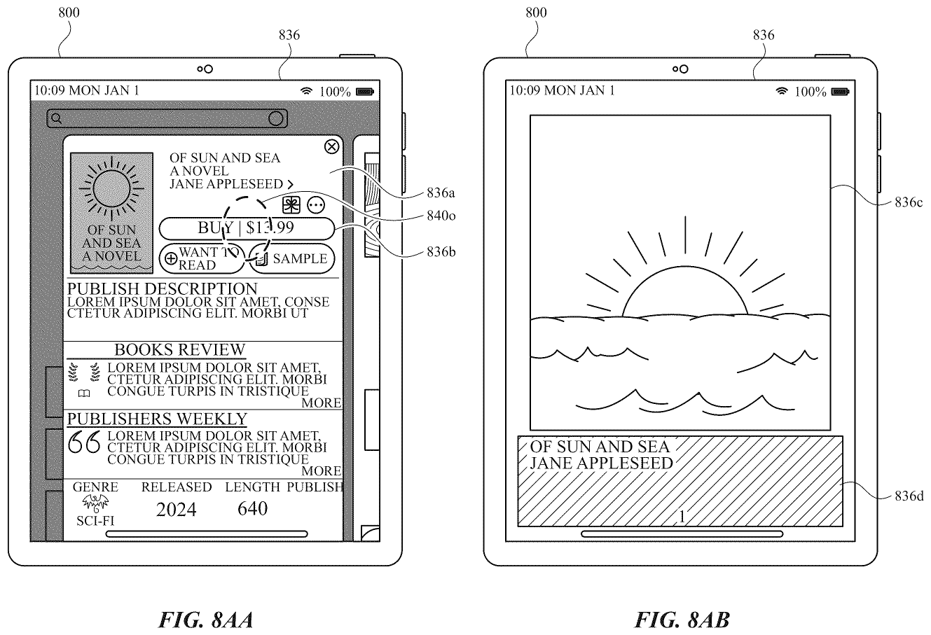

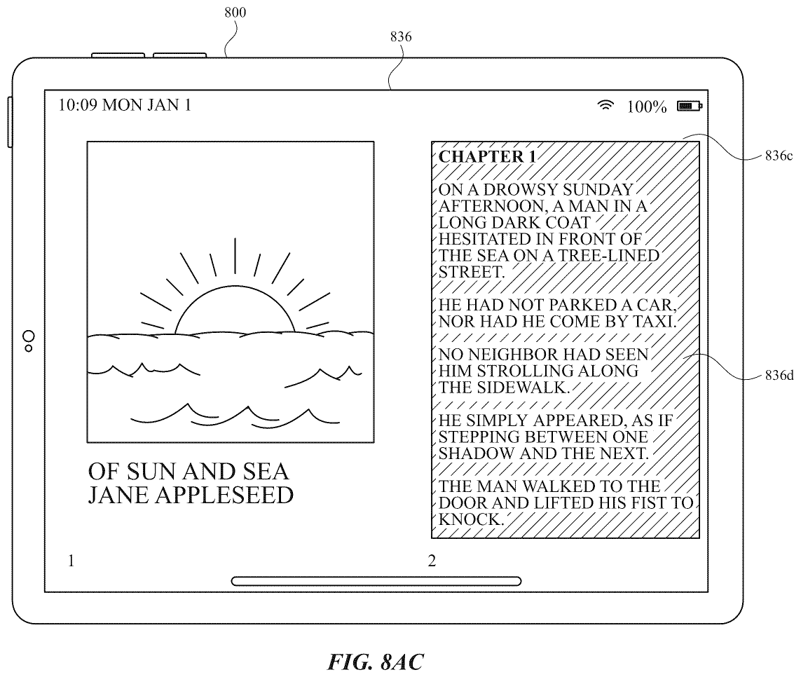

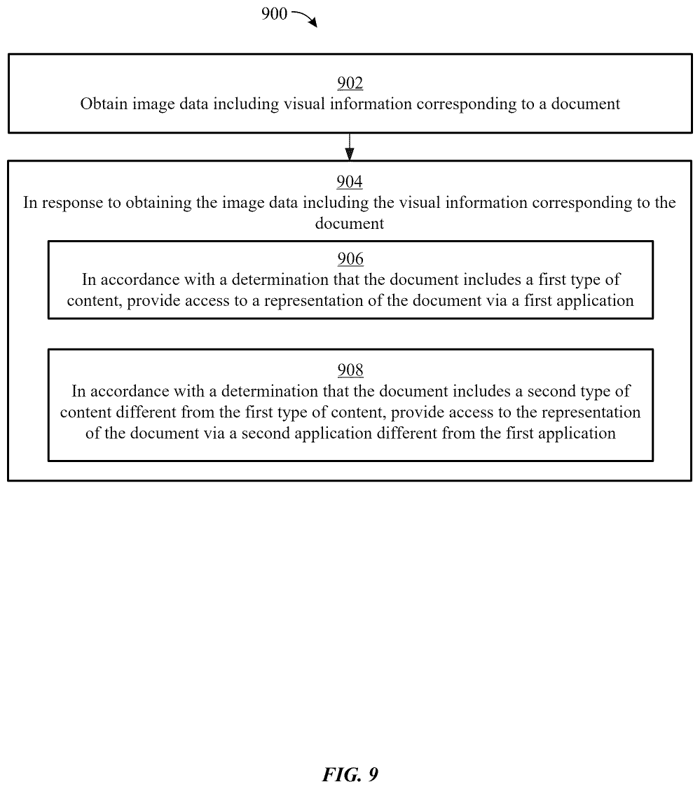

Below, FIGS. 1A-1B, 2, 3, 4A-4B, and 5A-5B provide a description of exemplary devices for performing the techniques for managing event notifications. FIGS. 6A-6O illustrate exemplary user interfaces and illumination techniques for scanning documents. FIG. 7 is a flow diagram illustrating a method for scanning documents in accordance with some embodiments. The user interfaces in FIGS. 6A-6O are used to illustrate the processes described below, including the processes in FIG. 7. FIGS. 8A-8AC illustrate exemplary user interfaces for managing access to scanned documents. FIG. 9 is a flow diagram illustrating a method for managing access to scanned documents, in accordance with some embodiments. The user interfaces in FIGS. 8A-8AC are used to illustrate the processes described below, including the processes in FIG. 9.

The processes described below enhance the operability of the devices and make the user-device interfaces more efficient (e.g., by helping the user to provide proper inputs and reducing user mistakes when operating/interacting with the device) through various techniques, including by providing improved visual feedback to the user, reducing the number of inputs needed to perform an operation, providing additional control options without cluttering the user interface with additional displayed controls, performing an operation when a set of conditions has been met without requiring further user input, and/or additional techniques. These techniques also reduce power usage and improve battery life of the device by enabling the user to use the device more quickly and efficiently.

In addition, in methods described herein where one or more steps are contingent upon one or more conditions having been met, it should be understood that the described method can be repeated in multiple repetitions so that over the course of the repetitions all of the conditions upon which steps in the method are contingent have been met in different repetitions of the method. For example, if a method requires performing a first step if a condition is satisfied, and a second step if the condition is not satisfied, then a person of ordinary skill would appreciate that the claimed steps are repeated until the condition has been both satisfied and not satisfied, in no particular order. Thus, a method described with one or more steps that are contingent upon one or more conditions having been met could be rewritten as a method that is repeated until each of the conditions described in the method has been met. This, however, is not required of system or computer readable medium claims where the system or computer readable medium contains instructions for performing the contingent operations based on the satisfaction of the corresponding one or more conditions and thus is capable of determining whether the contingency has or has not been satisfied without explicitly repeating steps of a method until all of the conditions upon which steps in the method are contingent have been met. A person having ordinary skill in the art would also understand that, similar to a method with contingent steps, a system or computer readable storage medium can repeat the steps of a method as many times as are needed to ensure that all of the contingent steps have been performed.

Although the following description uses terms “first,” “second,” etc. to describe various elements, these elements should not be limited by the terms. In some embodiments, these terms are used to distinguish one element from another. For example, a first touch could be termed a second touch, and, similarly, a second touch could be termed a first touch, without departing from the scope of the various described embodiments. In some embodiments, the first touch and the second touch are two separate references to the same touch. In some embodiments, the first touch and the second touch are both touches, but they are not the same touch.

The terminology used in the description of the various described embodiments herein is for the purpose of describing particular embodiments only and is not intended to be limiting. As used in the description of the various described embodiments and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

The term “if” is, optionally, construed to mean “when” or “upon” or “in response to determining” or “in response to detecting,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event],” depending on the context.

Embodiments of electronic devices, user interfaces for such devices, and associated processes for using such devices are described. In some embodiments, the device is a portable communications device, such as a mobile telephone, that also contains other functions, such as PDA and/or music player functions. Exemplary embodiments of portable multifunction devices include, without limitation, the iPhone®, iPod Touch®, and iPad® devices from Apple Inc. of Cupertino, California. Other portable electronic devices, such as laptops or tablet computers with touch-sensitive surfaces (e.g., touch screen displays and/or touchpads), are, optionally, used. It should also be understood that, in some embodiments, the device is not a portable communications device, but is a desktop computer with a touch-sensitive surface (e.g., a touch screen display and/or a touchpad). In some embodiments, the electronic device is a computer system that is in communication (e.g., via wireless communication, via wired communication) with a display generation component (e.g., a display device such as a head-mounted display (HMD), a display, a projector, a touch-sensitive display, or other device or component that presents visual content to a user, for example on or in the display generation component itself or produced from the display generation component and visible elsewhere). The display generation component is configured to provide visual output, such as display via a CRT display, display via an LED display, or display via image projection. In some embodiments, the display generation component is integrated with the computer system. In some embodiments, the display generation component is separate from the computer system. As used herein, “displaying” content includes causing to display the content (e.g., video data rendered or decoded by display controller 156) by transmitting, via a wired or wireless connection, data (e.g., image data or video data) to an integrated or external display generation component to visually produce the content.

In the discussion that follows, an electronic device that includes a display and a touch-sensitive surface is described. It should be understood, however, that the electronic device optionally includes one or more other physical user-interface devices, such as a physical keyboard, a mouse, and/or a joystick.

The device typically supports a variety of applications, such as one or more of the following: a drawing application, a presentation application, a word processing application, a website creation application, a disk authoring application, a spreadsheet application, a gaming application, a telephone application, a video conferencing application, an e-mail application, an instant messaging application, a workout support application, a photo management application, a digital camera application, a digital video camera application, a web browsing application, a digital music player application, and/or a digital video player application.

The various applications that are executed on the device optionally use at least one common physical user-interface device, such as the touch-sensitive surface. One or more functions of the touch-sensitive surface as well as corresponding information displayed on the device are, optionally, adjusted and/or varied from one application to the next and/or within a respective application. In this way, a common physical architecture (such as the touch-sensitive surface) of the device optionally supports the variety of applications with user interfaces that are intuitive and transparent to the user.

Attention is now directed toward embodiments of portable devices with touch-sensitive displays. FIG. 1A is a block diagram illustrating portable multifunction device 100 with touch-sensitive display system 112 in accordance with some embodiments. Touch-sensitive display 112 is sometimes called a “touch screen” for convenience and is sometimes known as or called a “touch-sensitive display system.” Device 100 includes memory 102 (which optionally includes one or more computer-readable storage media), memory controller 122, one or more processing units (CPUs) 120, peripherals interface 118, RF circuitry 108, audio circuitry 110, speaker 111, microphone 113, input/output (I/O) subsystem 106, other input control devices 116, and external port 124. Device 100 optionally includes one or more optical sensors 164. Device 100 optionally includes one or more contact intensity sensors 165 for detecting intensity of contacts on device 100 (e.g., a touch-sensitive surface such as touch-sensitive display system 112 of device 100). Device 100 optionally includes one or more tactile output generators 167 for generating tactile outputs on device 100 (e.g., generating tactile outputs on a touch-sensitive surface such as touch-sensitive display system 112 of device 100 or touchpad 355 of device 300). These components optionally communicate over one or more communication buses or signal lines 103.

As used in the specification and claims, the term “intensity” of a contact on a touch-sensitive surface refers to the force or pressure (force per unit area) of a contact (e.g., a finger contact) on the touch-sensitive surface, or to a substitute (proxy) for the force or pressure of a contact on the touch-sensitive surface. The intensity of a contact has a range of values that includes at least four distinct values and more typically includes hundreds of distinct values (e.g., at least 256). Intensity of a contact is, optionally, determined (or measured) using various approaches and various sensors or combinations of sensors. For example, one or more force sensors underneath or adjacent to the touch-sensitive surface are, optionally, used to measure force at various points on the touch-sensitive surface. In some implementations, force measurements from multiple force sensors are combined (e.g., a weighted average) to determine an estimated force of a contact. Similarly, a pressure-sensitive tip of a stylus is, optionally, used to determine a pressure of the stylus on the touch-sensitive surface. Alternatively, the size of the contact area detected on the touch-sensitive surface and/or changes thereto, the capacitance of the touch-sensitive surface proximate to the contact and/or changes thereto, and/or the resistance of the touch-sensitive surface proximate to the contact and/or changes thereto are, optionally, used as a substitute for the force or pressure of the contact on the touch-sensitive surface. In some implementations, the substitute measurements for contact force or pressure are used directly to determine whether an intensity threshold has been exceeded (e.g., the intensity threshold is described in units corresponding to the substitute measurements). In some implementations, the substitute measurements for contact force or pressure are converted to an estimated force or pressure, and the estimated force or pressure is used to determine whether an intensity threshold has been exceeded (e.g., the intensity threshold is a pressure threshold measured in units of pressure). Using the intensity of a contact as an attribute of a user input allows for user access to additional device functionality that may otherwise not be accessible by the user on a reduced-size device with limited real estate for displaying affordances (e.g., on a touch-sensitive display) and/or receiving user input (e.g., via a touch-sensitive display, a touch-sensitive surface, or a physical/mechanical control such as a knob or a button).

As used in the specification and claims, the term “tactile output” refers to physical displacement of a device relative to a previous position of the device, physical displacement of a component (e.g., a touch-sensitive surface) of a device relative to another component (e.g., housing) of the device, or displacement of the component relative to a center of mass of the device that will be detected by a user with the user's sense of touch. For example, in situations where the device or the component of the device is in contact with a surface of a user that is sensitive to touch (e.g., a finger, palm, or other part of a user's hand), the tactile output generated by the physical displacement will be interpreted by the user as a tactile sensation corresponding to a perceived change in physical characteristics of the device or the component of the device. For example, movement of a touch-sensitive surface (e.g., a touch-sensitive display or trackpad) is, optionally, interpreted by the user as a “down click” or “up click” of a physical actuator button. In some cases, a user will feel a tactile sensation such as an “down click” or “up click” even when there is no movement of a physical actuator button associated with the touch-sensitive surface that is physically pressed (e.g., displaced) by the user's movements. As another example, movement of the touch-sensitive surface is, optionally, interpreted or sensed by the user as “roughness” of the touch-sensitive surface, even when there is no change in smoothness of the touch-sensitive surface. While such interpretations of touch by a user will be subject to the individualized sensory perceptions of the user, there are many sensory perceptions of touch that are common to a large majority of users. Thus, when a tactile output is described as corresponding to a particular sensory perception of a user (e.g., an “up click,” a “down click,” “roughness”), unless otherwise stated, the generated tactile output corresponds to physical displacement of the device or a component thereof that will generate the described sensory perception for a typical (or average) user.

It should be appreciated that device 100 is only one example of a portable multifunction device, and that device 100 optionally has more or fewer components than shown, optionally combines two or more components, or optionally has a different configuration or arrangement of the components. The various components shown in FIG. 1A are implemented in hardware, software, or a combination of both hardware and software, including one or more signal processing and/or application-specific integrated circuits.

Memory 102 optionally includes high-speed random access memory and optionally also includes non-volatile memory, such as one or more magnetic disk storage devices, flash memory devices, or other non-volatile solid-state memory devices. Memory controller 122 optionally controls access to memory 102 by other components of device 100.

Peripherals interface 118 can be used to couple input and output peripherals of the device to CPU 120 and memory 102. The one or more processors 120 run or execute various software programs (such as computer programs (e.g., including instructions)) and/or sets of instructions stored in memory 102 to perform various functions for device 100 and to process data. In some embodiments, peripherals interface 118, CPU 120, and memory controller 122 are, optionally, implemented on a single chip, such as chip 104. In some other embodiments, they are, optionally, implemented on separate chips.

RF (radio frequency) circuitry 108 receives and sends RF signals, also called electromagnetic signals. RF circuitry 108 converts electrical signals to/from electromagnetic signals and communicates with communications networks and other communications devices via the electromagnetic signals. RF circuitry 108 optionally includes well-known circuitry for performing these functions, including but not limited to an antenna system, an RF transceiver, one or more amplifiers, a tuner, one or more oscillators, a digital signal processor, a CODEC chipset, a subscriber identity module (SIM) card, memory, and so forth. RF circuitry 108 optionally communicates with networks, such as the Internet, also referred to as the World Wide Web (WWW), an intranet and/or a wireless network, such as a cellular telephone network, a wireless local area network (LAN) and/or a metropolitan area network (MAN), and other devices by wireless communication. The RF circuitry 108 optionally includes well-known circuitry for detecting near field communication (NFC) fields, such as by a short-range communication radio. The wireless communication optionally uses any of a plurality of communications standards, protocols, and technologies, including but not limited to Global System for Mobile Communications (GSM), Enhanced Data GSM Environment (EDGE), high-speed downlink packet access (HSDPA), high-speed uplink packet access (HSUPA), Evolution, Data-Only (EV-DO), HSPA, HSPA+, Dual-Cell HSPA (DC-HSPDA), long term evolution (LTE), near field communication (NFC), wideband code division multiple access (W-CDMA), code division multiple access (CDMA), time division multiple access (TDMA), Bluetooth, Bluetooth Low Energy (BTLE), Wireless Fidelity (Wi-Fi) (e.g., IEEE 802.11a, IEEE 802.11b, IEEE 802.11g, IEEE 802.11n, and/or IEEE 802.11ac), voice over Internet Protocol (VOIP), Wi-MAX, a protocol for e-mail (e.g., Internet message access protocol (IMAP) and/or post office protocol (POP)), instant messaging (e.g., extensible messaging and presence protocol (XMPP), Session Initiation Protocol for Instant Messaging and Presence Leveraging Extensions (SIMPLE), Instant Messaging and Presence Service (IMPS)), and/or Short Message Service (SMS), or any other suitable communication protocol, including communication protocols not yet developed as of the filing date of this document.

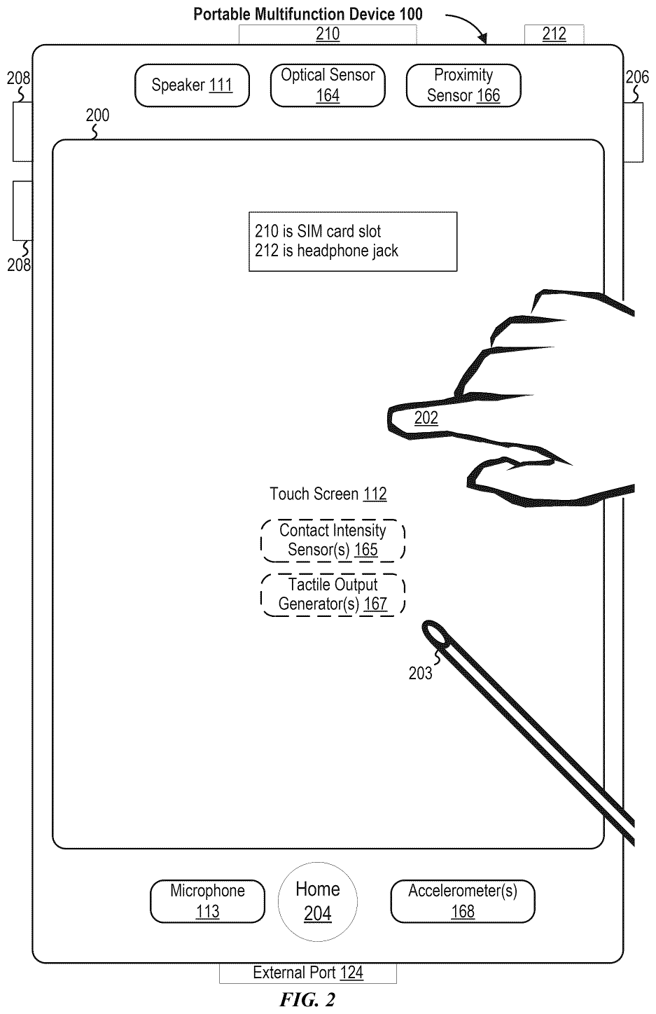

Audio circuitry 110, speaker 111, and microphone 113 provide an audio interface between a user and device 100. Audio circuitry 110 receives audio data from peripherals interface 118, converts the audio data to an electrical signal, and transmits the electrical signal to speaker 111. Speaker 111 converts the electrical signal to human-audible sound waves. Audio circuitry 110 also receives electrical signals converted by microphone 113 from sound waves. Audio circuitry 110 converts the electrical signal to audio data and transmits the audio data to peripherals interface 118 for processing. Audio data is, optionally, retrieved from and/or transmitted to memory 102 and/or RF circuitry 108 by peripherals interface 118. In some embodiments, audio circuitry 110 also includes a headset jack (e.g., 212, FIG. 2). The headset jack provides an interface between audio circuitry 110 and removable audio input/output peripherals, such as output-only headphones or a headset with both output (e.g., a headphone for one or both ears) and input (e.g., a microphone).

I/O subsystem 106 couples input/output peripherals on device 100, such as touch screen 112 and other input control devices 116, to peripherals interface 118. I/O subsystem 106 optionally includes display controller 156, optical sensor controller 158, depth camera controller 169, intensity sensor controller 159, haptic feedback controller 161, and one or more input controllers 160 for other input or control devices. The one or more input controllers 160 receive/send electrical signals from/to other input control devices 116. The other input control devices 116 optionally include physical buttons (e.g., push buttons, rocker buttons, etc.), dials, slider switches, joysticks, click wheels, and so forth. In some embodiments, input controller(s) 160 are, optionally, coupled to any (or none) of the following: a keyboard, an infrared port, a USB port, and a pointer device such as a mouse. The one or more buttons (e.g., 208, FIG. 2) optionally include an up/down button for volume control of speaker 111 and/or microphone 113. The one or more buttons optionally include a push button (e.g., 206, FIG. 2). In some embodiments, the electronic device is a computer system that is in communication (e.g., via wireless communication, via wired communication) with one or more input devices. In some embodiments, the one or more input devices include a touch-sensitive surface (e.g., a trackpad, as part of a touch-sensitive display). In some embodiments, the one or more input devices include one or more camera sensors (e.g., one or more optical sensors 164 and/or one or more depth camera sensors 175), such as for tracking a user's gestures (e.g., hand gestures and/or air gestures) as input. In some embodiments, the one or more input devices are integrated with the computer system. In some embodiments, the one or more input devices are separate from the computer system. In some embodiments, an air gesture is a gesture that is detected without the user touching an input element that is part of the device (or independently of an input element that is a part of the device) and is based on detected motion of a portion of the user's body through the air including motion of the user's body relative to an absolute reference (e.g., an angle of the user's arm relative to the ground or a distance of the user's hand relative to the ground), relative to another portion of the user's body (e.g., movement of a hand of the user relative to a shoulder of the user, movement of one hand of the user relative to another hand of the user, and/or movement of a finger of the user relative to another finger or portion of a hand of the user), and/or absolute motion of a portion of the user's body (e.g., a tap gesture that includes movement of a hand in a predetermined pose by a predetermined amount and/or speed, or a shake gesture that includes a predetermined speed or amount of rotation of a portion of the user's body).

A quick press of the push button optionally disengages a lock of touch screen 112 or optionally begins a process that uses gestures on the touch screen to unlock the device, as described in U.S. patent application Ser. No. 11/322,549, “Unlocking a Device by Performing Gestures on an Unlock Image,” filed Dec. 23, 2005, U.S. Pat. No. 7,657,849, which is hereby incorporated by reference in its entirety. A longer press of the push button (e.g., 206) optionally turns power to device 100 on or off. The functionality of one or more of the buttons are, optionally, user-customizable. Touch screen 112 is used to implement virtual or soft buttons and one or more soft keyboards.

Touch-sensitive display 112 provides an input interface and an output interface between the device and a user. Display controller 156 receives and/or sends electrical signals from/to touch screen 112. Touch screen 112 displays visual output to the user. The visual output optionally includes graphics, text, icons, video, and any combination thereof (collectively termed “graphics”). In some embodiments, some or all of the visual output optionally corresponds to user-interface objects.

Touch screen 112 has a touch-sensitive surface, sensor, or set of sensors that accepts input from the user based on haptic and/or tactile contact. Touch screen 112 and display controller 156 (along with any associated modules and/or sets of instructions in memory 102) detect contact (and any movement or breaking of the contact) on touch screen 112 and convert the detected contact into interaction with user-interface objects (e.g., one or more soft keys, icons, web pages, or images) that are displayed on touch screen 112. In an exemplary embodiment, a point of contact between touch screen 112 and the user corresponds to a finger of the user.

Touch screen 112 optionally uses LCD (liquid crystal display) technology, LPD (light emitting polymer display) technology, or LED (light emitting diode) technology, although other display technologies are used in other embodiments. Touch screen 112 and display controller 156 optionally detect contact and any movement or breaking thereof using any of a plurality of touch sensing technologies now known or later developed, including but not limited to capacitive, resistive, infrared, and surface acoustic wave technologies, as well as other proximity sensor arrays or other elements for determining one or more points of contact with touch screen 112. In an exemplary embodiment, projected mutual capacitance sensing technology is used, such as that found in the iPhone® and iPod Touch® from Apple Inc. of Cupertino, California.

A touch-sensitive display in some embodiments of touch screen 112 is, optionally, analogous to the multi-touch sensitive touchpads described in the following U.S. Pat. No. 6,323,846 (Westerman et al.), U.S. Pat. No. 6,570,557 (Westerman et al.), and/or U.S. Pat. No. 6,677,932 (Westerman), and/or U.S. Patent Publication 2002/0015024A1, each of which is hereby incorporated by reference in its entirety. However, touch screen 112 displays visual output from device 100, whereas touch-sensitive touchpads do not provide visual output.

A touch-sensitive display in some embodiments of touch screen 112 is described in the following applications: (1) U.S. patent application Ser. No. 11/381,313, “Multipoint Touch Surface Controller,” filed May 2, 2006; (2) U.S. patent application Ser. No. 10/840,862, “Multipoint Touchscreen,” filed May 6, 2004; (3) U.S. patent application Ser. No. 10/903,964, “Gestures For Touch Sensitive Input Devices,” filed Jul. 30, 2004; (4) U.S. patent application Ser. No. 11/048,264, “Gestures For Touch Sensitive Input Devices,” filed Jan. 31, 2005; (5) U.S. patent application Ser. No. 11/038,590, “Mode-Based Graphical User Interfaces For Touch Sensitive Input Devices,” filed Jan. 18, 2005; (6) U.S. patent application Ser. No. 11/228,758, “Virtual Input Device Placement On A Touch Screen User Interface,” filed Sep. 16, 2005; (7) U.S. patent application Ser. No. 11/228,700, “Operation Of A Computer With A Touch Screen Interface,” filed Sep. 16, 2005; (8) U.S. patent application Ser. No. 11/228,737, “Activating Virtual Keys Of A Touch-Screen Virtual Keyboard,” filed Sep. 16, 2005; and (9) U.S. patent application Ser. No. 11/367,749, “Multi-Functional Hand-Held Device,” filed Mar. 3, 2006. All of these applications are incorporated by reference herein in their entirety.

Touch screen 112 optionally has a video resolution in excess of 100 dpi. In some embodiments, the touch screen has a video resolution of approximately 160 dpi. The user optionally makes contact with touch screen 112 using any suitable object or appendage, such as a stylus, a finger, and so forth. In some embodiments, the user interface is designed to work primarily with finger-based contacts and gestures, which can be less precise than stylus-based input due to the larger area of contact of a finger on the touch screen. In some embodiments, the device translates the rough finger-based input into a precise pointer/cursor position or command for performing the actions desired by the user.

In some embodiments, in addition to the touch screen, device 100 optionally includes a touchpad for activating or deactivating particular functions. In some embodiments, the touchpad is a touch-sensitive area of the device that, unlike the touch screen, does not display visual output. The touchpad is, optionally, a touch-sensitive surface that is separate from touch screen 112 or an extension of the touch-sensitive surface formed by the touch screen.

Device 100 also includes power system 162 for powering the various components. Power system 162 optionally includes a power management system, one or more power sources (e.g., battery, alternating current (AC)), a recharging system, a power failure detection circuit, a power converter or inverter, a power status indicator (e.g., a light-emitting diode (LED)) and any other components associated with the generation, management and distribution of power in portable devices.

Device 100 optionally also includes secure element 163 for securely storing information. In some embodiments, secure element 163 is a hardware component (e.g., a secure microcontroller chip) configured to securely store data or an algorithm. In some embodiments, secure element 163 provides (e.g., releases) secure information (e.g., payment information (e.g., an account number and/or a transaction-specific dynamic security code), identification information (e.g., credentials of a state-approved digital identification), and/or authentication information (e.g., data generated using a cryptography engine and/or by performing asymmetric cryptography operations)). In some embodiments, secure element 163 provides (or releases) the secure information in response to device 100 receiving authorization, such as a user authentication (e.g., fingerprint authentication; passcode authentication; detecting double-press of a hardware button when device 100 is in an unlocked state, and optionally, while device 100 has been continuously on a user's wrist since device 100 was unlocked by providing authentication credentials to device 100, where the continuous presence of device 100 on the user's wrist is determined by periodically checking that the device is in contact with the user's skin). For example, device 100 detects a fingerprint at a fingerprint sensor (e.g., a fingerprint sensor integrated into a button) of device 100. Device 100 determines whether the detected fingerprint is consistent with an enrolled fingerprint. In accordance with a determination that the fingerprint is consistent with the enrolled fingerprint, secure element 163 provides (e.g., releases) the secure information. In accordance with a determination that the fingerprint is not consistent with the enrolled fingerprint, secure element 163 forgoes providing (e.g., releasing) the secure information.

Device 100 optionally also includes one or more optical sensors 164. FIG. 1A shows an optical sensor coupled to optical sensor controller 158 in I/O subsystem 106. Optical sensor 164 optionally includes charge-coupled device (CCD) or complementary metal-oxide semiconductor (CMOS) phototransistors. Optical sensor 164 receives light from the environment, projected through one or more lenses, and converts the light to data representing an image. In conjunction with imaging module 143 (also called a camera module), optical sensor 164 optionally captures still images or video. In some embodiments, an optical sensor is located on the back of device 100, opposite touch screen display 112 on the front of the device so that the touch screen display is enabled for use as a viewfinder for still and/or video image acquisition. In some embodiments, an optical sensor is located on the front of the device so that the user's image is, optionally, obtained for video conferencing while the user views the other video conference participants on the touch screen display. In some embodiments, the position of optical sensor 164 can be changed by the user (e.g., by rotating the lens and the sensor in the device housing) so that a single optical sensor 164 is used along with the touch screen display for both video conferencing and still and/or video image acquisition.

Device 100 optionally also includes one or more depth camera sensors 175. FIG. 1A shows a depth camera sensor coupled to depth camera controller 169 in I/O subsystem 106. Depth camera sensor 175 receives data from the environment to create a three dimensional model of an object (e.g., a face) within a scene from a viewpoint (e.g., a depth camera sensor). In some embodiments, in conjunction with imaging module 143 (also called a camera module), depth camera sensor 175 is optionally used to determine a depth map of different portions of an image captured by the imaging module 143. In some embodiments, a depth camera sensor is located on the front of device 100 so that the user's image with depth information is, optionally, obtained for video conferencing while the user views the other video conference participants on the touch screen display and to capture selfies with depth map data. In some embodiments, the depth camera sensor 175 is located on the back of device, or on the back and the front of the device 100. In some embodiments, the position of depth camera sensor 175 can be changed by the user (e.g., by rotating the lens and the sensor in the device housing) so that a depth camera sensor 175 is used along with the touch screen display for both video conferencing and still and/or video image acquisition.

In some embodiments, a depth map (e.g., depth map image) contains information (e.g., values) that relates to the distance of objects in a scene from a viewpoint (e.g., a camera, an optical sensor, a depth camera sensor). In one embodiment of a depth map, each depth pixel defines the position in the viewpoint's Z-axis where its corresponding two-dimensional pixel is located. In some embodiments, a depth map is composed of pixels wherein each pixel is defined by a value (e.g., 0-255). For example, the “0” value represents pixels that are located at the most distant place in a “three dimensional” scene and the “255” value represents pixels that are located closest to a viewpoint (e.g., a camera, an optical sensor, a depth camera sensor) in the “three dimensional” scene. In other embodiments, a depth map represents the distance between an object in a scene and the plane of the viewpoint. In some embodiments, the depth map includes information about the relative depth of various features of an object of interest in view of the depth camera (e.g., the relative depth of eyes, nose, mouth, ears of a user's face). In some embodiments, the depth map includes information that enables the device to determine contours of the object of interest in a z direction.

Device 100 optionally also includes one or more contact intensity sensors 165. FIG. 1A shows a contact intensity sensor coupled to intensity sensor controller 159 in I/O subsystem 106. Contact intensity sensor 165 optionally includes one or more piezoresistive strain gauges, capacitive force sensors, electric force sensors, piezoelectric force sensors, optical force sensors, capacitive touch-sensitive surfaces, or other intensity sensors (e.g., sensors used to measure the force (or pressure) of a contact on a touch-sensitive surface). Contact intensity sensor 165 receives contact intensity information (e.g., pressure information or a proxy for pressure information) from the environment. In some embodiments, at least one contact intensity sensor is collocated with, or proximate to, a touch-sensitive surface (e.g., touch-sensitive display system 112). In some embodiments, at least one contact intensity sensor is located on the back of device 100, opposite touch screen display 112, which is located on the front of device 100.

Device 100 optionally also includes one or more proximity sensors 166. FIG. 1A shows proximity sensor 166 coupled to peripherals interface 118. Alternately, proximity sensor 166 is, optionally, coupled to input controller 160 in I/O subsystem 106. Proximity sensor 166 optionally performs as described in U.S. patent application Ser. No. 11/241,839, “Proximity Detector In Handheld Device”; Ser. No. 11/240,788, “Proximity Detector In Handheld Device”; Ser. No. 11/620,702, “Using Ambient Light Sensor To Augment Proximity Sensor Output”; Ser. No. 11/586,862, “Automated Response To And Sensing Of User Activity In Portable Devices”; and Ser. No. 11/638,251, “Methods And Systems For Automatic Configuration Of Peripherals,” which are hereby incorporated by reference in their entirety. In some embodiments, the proximity sensor turns off and disables touch screen 112 when the multifunction device is placed near the user's ear (e.g., when the user is making a phone call).

Device 100 optionally also includes one or more tactile output generators 167. FIG. 1A shows a tactile output generator coupled to haptic feedback controller 161 in I/O subsystem 106. Tactile output generator 167 optionally includes one or more electroacoustic devices such as speakers or other audio components and/or electromechanical devices that convert energy into linear motion such as a motor, solenoid, electroactive polymer, piezoelectric actuator, electrostatic actuator, or other tactile output generating component (e.g., a component that converts electrical signals into tactile outputs on the device). Contact intensity sensor 165 receives tactile feedback generation instructions from haptic feedback module 133 and generates tactile outputs on device 100 that are capable of being sensed by a user of device 100. In some embodiments, at least one tactile output generator is collocated with, or proximate to, a touch-sensitive surface (e.g., touch-sensitive display system 112) and, optionally, generates a tactile output by moving the touch-sensitive surface vertically (e.g., in/out of a surface of device 100) or laterally (e.g., back and forth in the same plane as a surface of device 100). In some embodiments, at least one tactile output generator sensor is located on the back of device 100, opposite touch screen display 112, which is located on the front of device 100.

Device 100 optionally also includes one or more accelerometers 168. FIG. 1A shows accelerometer 168 coupled to peripherals interface 118. Alternately, accelerometer 168 is, optionally, coupled to an input controller 160 in I/O subsystem 106. Accelerometer 168 optionally performs as described in U.S. Patent Publication No. 20050190059, “Acceleration-based Theft Detection System for Portable Electronic Devices,” and U.S. Patent Publication No. 20060017692, “Methods And Apparatuses For Operating A Portable Device Based On An Accelerometer,” both of which are incorporated by reference herein in their entirety. In some embodiments, information is displayed on the touch screen display in a portrait view or a landscape view based on an analysis of data received from the one or more accelerometers. Device 100 optionally includes, in addition to accelerometer(s) 168, a magnetometer and a GPS (or GLONASS or other global navigation system) receiver for obtaining information concerning the location and orientation (e.g., portrait or landscape) of device 100.

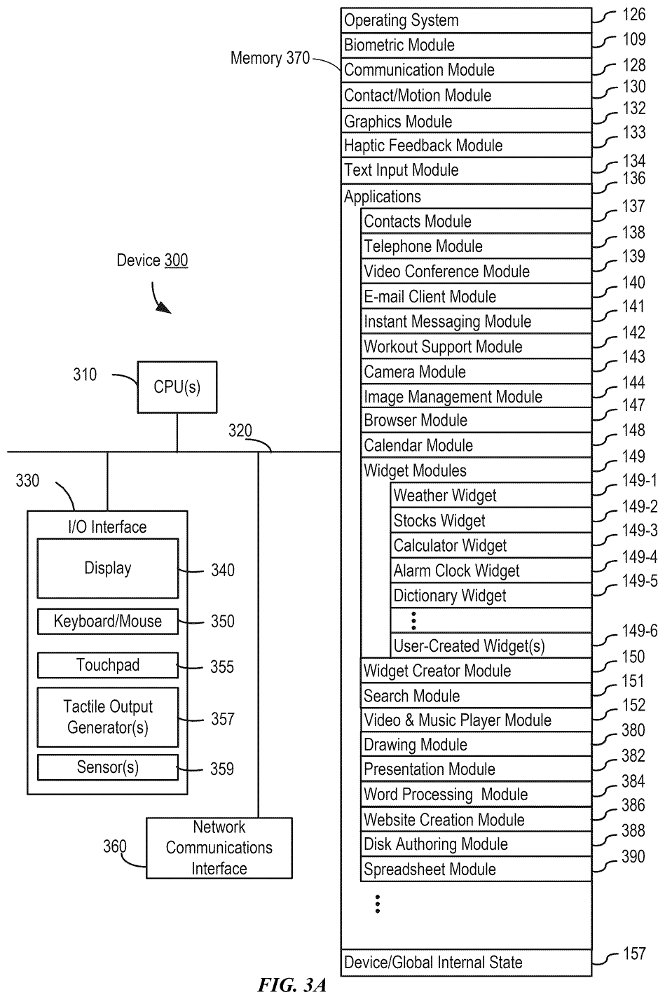

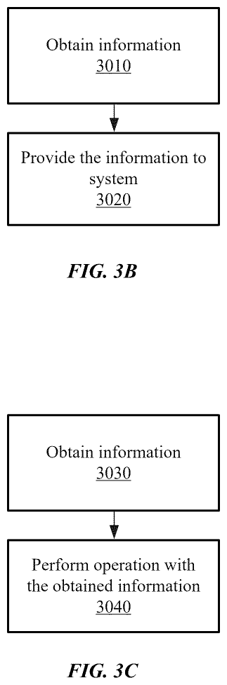

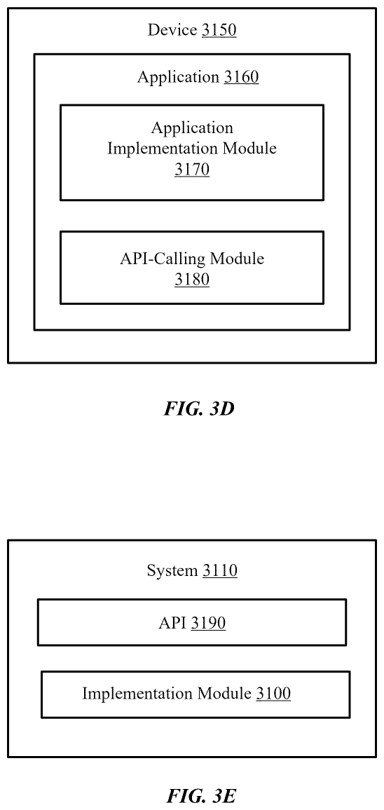

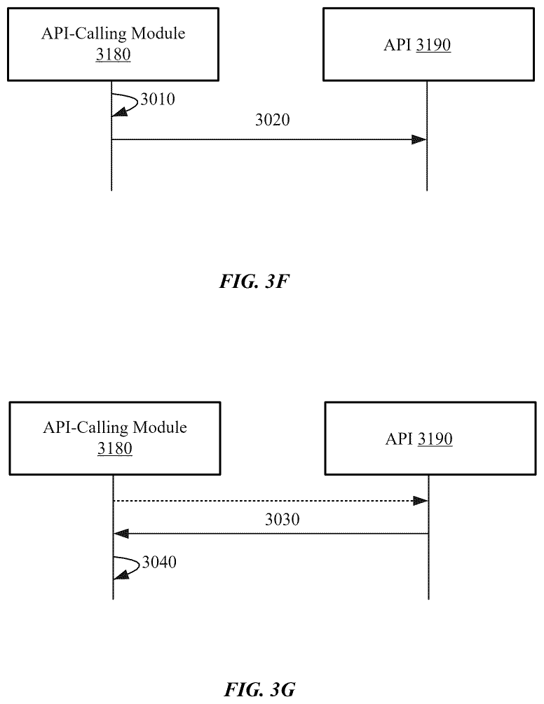

In some embodiments, the software components stored in memory 102 include operating system 126, biometric module 109, communication module (or set of instructions) 128, contact/motion module (or set of instructions) 130, graphics module (or set of instructions) 132, text input module (or set of instructions) 134, Global Positioning System (GPS) module (or set of instructions) 135, authentication module 105, and applications (or sets of instructions) 136. Furthermore, in some embodiments, memory 102 (FIG. 1A) or 370 (FIG. 3A) stores device/global internal state 157, as shown in FIGS. 1A and 3A. Device/global internal state 157 includes one or more of: active application state, indicating which applications, if any, are currently active; display state, indicating what applications, views or other information occupy various regions of touch screen display 112; sensor state, including information obtained from the device's various sensors and input control devices 116; and location information concerning the device's location and/or attitude.

Operating system 126 (e.g., Darwin, RTXC, LINUX, UNIX, OS X, IOS, WINDOWS, or an embedded operating system such as VxWorks) includes various software components and/or drivers for controlling and managing general system tasks (e.g., memory management, storage device control, power management, etc.) and facilitates communication between various hardware and software components.

Communication module 128 facilitates communication with other devices over one or more external ports 124 and also includes various software components for handling data received by RF circuitry 108 and/or external port 124. External port 124 (e.g., Universal Serial Bus (USB), FIREWIRE®, etc.) is adapted for coupling directly to other devices or indirectly over a network (e.g., the Internet, wireless LAN, etc.). In some embodiments, the external port is a multi-pin (e.g., 30-pin) connector that is the same as, or similar to and/or compatible with, the 30-pin connector used on iPod® (trademark of Apple Inc.) devices.

Biometric module 109 optionally stores information about one or more enrolled biometric features (e.g., fingerprint feature information, facial recognition feature information, eye and/or iris feature information) for use to verify whether received biometric information matches the enrolled biometric features. In some embodiments, the information stored about the one or more enrolled biometric features includes data that enables the comparison between the stored information and received biometric information without including enough information to reproduce the enrolled biometric features. In some embodiments, biometric module 109 stores the information about the enrolled biometric features in association with a user account of device 100. In some embodiments, biometric module 109 compares the received biometric information to an enrolled biometric feature to determine whether the received biometric information matches the enrolled biometric feature.

Contact/motion module 130 optionally detects contact with touch screen 112 (in conjunction with display controller 156) and other touch-sensitive devices (e.g., a touchpad or physical click wheel). Contact/motion module 130 includes various software components for performing various operations related to detection of contact, such as determining if contact has occurred (e.g., detecting a finger-down event), determining an intensity of the contact (e.g., the force or pressure of the contact or a substitute for the force or pressure of the contact), determining if there is movement of the contact and tracking the movement across the touch-sensitive surface (e.g., detecting one or more finger-dragging events), and determining if the contact has ceased (e.g., detecting a finger-up event or a break in contact). Contact/motion module 130 receives contact data from the touch-sensitive surface. Determining movement of the point of contact, which is represented by a series of contact data, optionally includes determining speed (magnitude), velocity (magnitude and direction), and/or an acceleration (a change in magnitude and/or direction) of the point of contact. These operations are, optionally, applied to single contacts (e.g., one finger contacts) or to multiple simultaneous contacts (e.g., “multitouch”/multiple finger contacts). In some embodiments, contact/motion module 130 and display controller 156 detect contact on a touchpad.

In some embodiments, contact/motion module 130 uses a set of one or more intensity thresholds to determine whether an operation has been performed by a user (e.g., to determine whether a user has “clicked” on an icon). In some embodiments, at least a subset of the intensity thresholds are determined in accordance with software parameters (e.g., the intensity thresholds are not determined by the activation thresholds of particular physical actuators and can be adjusted without changing the physical hardware of device 100). For example, a mouse “click” threshold of a trackpad or touch screen display can be set to any of a large range of predefined threshold values without changing the trackpad or touch screen display hardware. Additionally, in some implementations, a user of the device is provided with software settings for adjusting one or more of the set of intensity thresholds (e.g., by adjusting individual intensity thresholds and/or by adjusting a plurality of intensity thresholds at once with a system-level click “intensity” parameter).

Contact/motion module 130 optionally detects a gesture input by a user. Different gestures on the touch-sensitive surface have different contact patterns (e.g., different motions, timings, and/or intensities of detected contacts). Thus, a gesture is, optionally, detected by detecting a particular contact pattern. For example, detecting a finger tap gesture includes detecting a finger-down event followed by detecting a finger-up (liftoff) event at the same position (or substantially the same position) as the finger-down event (e.g., at the position of an icon). As another example, detecting a finger swipe gesture on the touch-sensitive surface includes detecting a finger-down event followed by detecting one or more finger-dragging events, and subsequently followed by detecting a finger-up (liftoff) event.

Graphics module 132 includes various known software components for rendering and displaying graphics on touch screen 112 or other display, including components for changing the visual impact (e.g., brightness, transparency, saturation, contrast, or other visual property) of graphics that are displayed. As used herein, the term “graphics” includes any object that can be displayed to a user, including, without limitation, text, web pages, icons (such as user-interface objects including soft keys), digital images, videos, animations, and the like.

In some embodiments, graphics module 132 stores data representing graphics to be used. Each graphic is, optionally, assigned a corresponding code. Graphics module 132 receives, from applications etc., one or more codes specifying graphics to be displayed along with, if necessary, coordinate data and other graphic property data, and then generates screen image data to output to display controller 156.

Haptic feedback module 133 includes various software components for generating instructions used by tactile output generator(s) 167 to produce tactile outputs at one or more locations on device 100 in response to user interactions with device 100.

Text input module 134, which is, optionally, a component of graphics module 132, provides soft keyboards for entering text in various applications (e.g., contacts module 137, e-mail client module 140, IM module 141, browser module 147, and any other application that needs text input).

GPS module 135 determines the location of the device and provides this information for use in various applications (e.g., to telephone module 138 for use in location-based dialing; to camera module 143 as picture/video metadata; and to applications that provide location-based services such as weather widgets, local yellow page widgets, and map/navigation widgets).

Authentication module 105 determines whether a requested operation (e.g., requested by an application of applications 136) is authorized to be performed. In some embodiments, authentication module 105 receives for an operation to be perform that optionally requires authentication. Authentication module 105 determines whether the operation is authorized to be performed, such as based on a series of factors, including the lock status of device 100, the location of device 100, whether a security delay has elapsed, whether received biometric information matches enrolled biometric features, and/or other factors. Once authentication module 105 determines that the operation is authorized to be performed, authentication module 105 triggers performance of the operation.

Applications 136 optionally include the following modules (or sets of instructions), or a subset or superset thereof:
Contacts module 137 (sometimes called an address book or contact list);
Telephone module 138;
Video conference module 139;
E-mail client module 140;
Instant messaging (IM) module 141;
Workout support module 142;
Camera module 143 for still and/or video images;
Image management module 144;
Video player module;
Music player module;
Browser module 147;
Calendar module 148;
Widget modules 149, which optionally include one or more of: weather widget 149-1, stocks widget 149-2, calculator widget 149-3, alarm clock widget 149-4, dictionary widget 149-5, and other widgets obtained by the user, as well as user-created widgets 149-6;
Widget creator module 150 for making user-created widgets 149-6;
Search module 151;
Video and music player module 152, which merges video player module and music player module;
Notes module 153;
Map module 154; and/or
Online video module 155.

Examples of other applications 136 that are, optionally, stored in memory 102 include other word processing applications, other image editing applications, drawing applications, presentation applications, JAVA-enabled applications, encryption, digital rights management, voice recognition, and voice replication.

In conjunction with touch screen 112, display controller 156, contact/motion module 130, graphics module 132, and text input module 134, contacts module 137 are, optionally, used to manage an address book or contact list (e.g., stored in application internal state 192 of contacts module 137 in memory 102 or memory 370), including: adding name(s) to the address book; deleting name(s) from the address book; associating telephone number(s), e-mail address(es), physical address(es) or other information with a name; associating an image with a name; categorizing and sorting names; providing telephone numbers or e-mail addresses to initiate and/or facilitate communications by telephone module 138, video conference module 139, e-mail client module 140, or IM module 141; and so forth.

In conjunction with RF circuitry 108, audio circuitry 110, speaker 111, microphone 113, touch screen 112, display controller 156, contact/motion module 130, graphics module 132, and text input module 134, telephone module 138 are optionally, used to enter a sequence of characters corresponding to a telephone number, access one or more telephone numbers in contacts module 137, modify a telephone number that has been entered, dial a respective telephone number, conduct a conversation, and disconnect or hang up when the conversation is completed. As noted above, the wireless communication optionally uses any of a plurality of communications standards, protocols, and technologies.

In conjunction with RF circuitry 108, audio circuitry 110, speaker 111, microphone 113, touch screen 112, display controller 156, optical sensor 164, optical sensor controller 158, contact/motion module 130, graphics module 132, text input module 134, contacts module 137, and telephone module 138, video conference module 139 includes executable instructions to initiate, conduct, and terminate a video conference between a user and one or more other participants in accordance with user instructions.

In conjunction with RF circuitry 108, touch screen 112, display controller 156, contact/motion module 130, graphics module 132, and text input module 134, e-mail client module 140 includes executable instructions to create, send, receive, and manage e-mail in response to user instructions. In conjunction with image management module 144, e-mail client module 140 makes it very easy to create and send e-mails with still or video images taken with camera module 143.

In conjunction with RF circuitry 108, touch screen 112, display controller 156, contact/motion module 130, graphics module 132, and text input module 134, the instant messaging module 141 includes executable instructions to enter a sequence of characters corresponding to an instant message, to modify previously entered characters, to transmit a respective instant message (for example, using a Short Message Service (SMS) or Multimedia Message Service (MMS) protocol for telephony-based instant messages or using XMPP, SIMPLE, or IMPS for Internet-based instant messages), to receive instant messages, and to view received instant messages. In some embodiments, transmitted and/or received instant messages optionally include graphics, photos, audio files, video files and/or other attachments as are supported in an MMS and/or an Enhanced Messaging Service (EMS). As used herein, “instant messaging” refers to both telephony-based messages (e.g., messages sent using SMS or MMS) and Internet-based messages (e.g., messages sent using XMPP, SIMPLE, or IMPS).

In conjunction with RF circuitry 108, touch screen 112, display controller 156, contact/motion module 130, graphics module 132, text input module 134, GPS module 135, map module 154, and music player module, workout support module 142 includes executable instructions to create workouts (e.g., with time, distance, and/or calorie burning goals); communicate with workout sensors (sports devices); receive workout sensor data; calibrate sensors used to monitor a workout; select and play music for a workout; and display, store, and transmit workout data.

In conjunction with touch screen 112, display controller 156, optical sensor(s) 164, optical sensor controller 158, contact/motion module 130, graphics module 132, and image management module 144, camera module 143 includes executable instructions to capture still images or video (including a video stream) and store them into memory 102, modify characteristics of a still image or video, or delete a still image or video from memory 102.

In conjunction with touch screen 112, display controller 156, contact/motion module 130, graphics module 132, text input module 134, and camera module 143, image management module 144 includes executable instructions to arrange, modify (e.g., edit), or otherwise manipulate, label, delete, present (e.g., in a digital slide show or album), and store still and/or video images.

In conjunction with RF circuitry 108, touch screen 112, display controller 156, contact/motion module 130, graphics module 132, and text input module 134, browser module 147 includes executable instructions to browse the Internet in accordance with user instructions, including searching, linking to, receiving, and displaying web pages or portions thereof, as well as attachments and other files linked to web pages.

In conjunction with RF circuitry 108, touch screen 112, display controller 156, contact/motion module 130, graphics module 132, text input module 134, e-mail client module 140, and browser module 147, calendar module 148 includes executable instructions to create, display, modify, and store calendars and data associated with calendars (e.g., calendar entries, to-do lists, etc.) in accordance with user instructions.

In conjunction with RF circuitry 108, touch screen 112, display controller 156, contact/motion module 130, graphics module 132, text input module 134, and browser module 147, widget modules 149 are mini-applications that are, optionally, downloaded and used by a user (e.g., weather widget 149-1, stocks widget 149-2, calculator widget 149-3, alarm clock widget 149-4, and dictionary widget 149-5) or created by the user (e.g., user-created widget 149-6). In some embodiments, a widget includes an HTML (Hypertext Markup Language) file, a CSS (Cascading Style Sheets) file, and a JavaScript® file. In some embodiments, a widget includes an XML (Extensible Markup Language) file and a JavaScript® file (e.g., Yahoo!® Widgets).

In conjunction with RF circuitry 108, touch screen 112, display controller 156, contact/motion module 130, graphics module 132, text input module 134, and browser module 147, the widget creator module 150 are, optionally, used by a user to create widgets (e.g., turning a user-specified portion of a web page into a widget).

In conjunction with touch screen 112, display controller 156, contact/motion module 130, graphics module 132, and text input module 134, search module 151 includes executable instructions to search for text, music, sound, image, video, and/or other files in memory 102 that match one or more search criteria (e.g., one or more user-specified search terms) in accordance with user instructions.

In conjunction with touch screen 112, display controller 156, contact/motion module 130, graphics module 132, audio circuitry 110, speaker 111, RF circuitry 108, and browser module 147, video and music player module 152 includes executable instructions that allow the user to download and play back recorded music and other sound files stored in one or more file formats, such as MP3 or AAC files, and executable instructions to display, present, or otherwise play back videos (e.g., on touch screen 112 or on an external, connected display via external port 124). In some embodiments, device 100 optionally includes the functionality of an MP3 player, such as an iPod (trademark of Apple Inc.).

In conjunction with touch screen 112, display controller 156, contact/motion module 130, graphics module 132, and text input module 134, notes module 153 includes executable instructions to create and manage notes, to-do lists, and the like in accordance with user instructions.

In conjunction with RF circuitry 108, touch screen 112, display controller 156, contact/motion module 130, graphics module 132, text input module 134, GPS module 135, and browser module 147, map module 154 are, optionally, used to receive, display, modify, and store maps and data associated with maps (e.g., driving directions, data on stores and other points of interest at or near a particular location, and other location-based data) in accordance with user instructions.

In conjunction with touch screen 112, display controller 156, contact/motion module 130, graphics module 132, audio circuitry 110, speaker 111, RF circuitry 108, text input module 134, e-mail client module 140, and browser module 147, online video module 155 includes instructions that allow the user to access, browse, receive (e.g., by streaming and/or download), play back (e.g., on the touch screen or on an external, connected display via external port 124), send an e-mail with a link to a particular online video, and otherwise manage online videos in one or more file formats, such as H.264. In some embodiments, instant messaging module 141, rather than e-mail client module 140, is used to send a link to a particular online video. Additional description of the online video application can be found in U.S. Provisional Patent Application No. 60/936,562, “Portable Multifunction Device, Method, and Graphical User Interface for Playing Online Videos,” filed Jun. 20, 2007, and U.S. patent application Ser. No. 11/968,067, “Portable Multifunction Device, Method, and Graphical User Interface for Playing Online Videos,” filed Dec. 31, 2007, the contents of which are hereby incorporated by reference in their entirety.

Each of the above-identified modules and applications corresponds to a set of executable instructions for performing one or more functions described above and the methods described in this application (e.g., the computer-implemented methods and other information processing methods described herein). These modules (e.g., sets of instructions) need not be implemented as separate software programs (such as computer programs (e.g., including instructions)), procedures, or modules, and thus various subsets of these modules are, optionally, combined or otherwise rearranged in various embodiments. For example, video player module is, optionally, combined with music player module into a single module (e.g., video and music player module 152, FIG. 1A). In some embodiments, memory 102 optionally stores a subset of the modules and data structures identified above. Furthermore, memory 102 optionally stores additional modules and data structures not described above.

In some embodiments, device 100 is a device where operation of a predefined set of functions on the device is performed exclusively through a touch screen and/or a touchpad. By using a touch screen and/or a touchpad as the primary input control device for operation of device 100, the number of physical input control devices (such as push buttons, dials, and the like) on device 100 is, optionally, reduced.

The predefined set of functions that are performed exclusively through a touch screen and/or a touchpad optionally include navigation between user interfaces. In some embodiments, the touchpad, when touched by the user, navigates device 100 to a main, home, or root menu from any user interface that is displayed on device 100. In such embodiments, a “menu button” is implemented using a touchpad. In some other embodiments, the menu button is a physical push button or other physical input control device instead of a touchpad.

FIG. 1B is a block diagram illustrating exemplary components for event handling in accordance with some embodiments. In some embodiments, memory 102 (FIG. 1A) or 370 (FIG. 3A) includes event sorter 170 (e.g., in operating system 126) and a respective application 136-1 (e.g., any of the aforementioned applications 137-151, 155, 380-390).

Event sorter 170 receives event information and determines the application 136-1 and application view 191 of application 136-1 to which to deliver the event information. Event sorter 170 includes event monitor 171 and event dispatcher module 174. In some embodiments, application 136-1 includes application internal state 192, which indicates the current application view(s) displayed on touch-sensitive display 112 when the application is active or executing. In some embodiments, device/global internal state 157 is used by event sorter 170 to determine which application(s) is (are) currently active, and application internal state 192 is used by event sorter 170 to determine application views 191 to which to deliver event information.

In some embodiments, application internal state 192 includes additional information, such as one or more of: resume information to be used when application 136-1 resumes execution, user interface state information that indicates information being displayed or that is ready for display by application 136-1, a state queue for enabling the user to go back to a prior state or view of application 136-1, and a redo/undo queue of previous actions taken by the user.

Event monitor 171 receives event information from peripherals interface 118. Event information includes information about a sub-event (e.g., a user touch on touch-sensitive display 112, as part of a multi-touch gesture). Peripherals interface 118 transmits information it receives from I/O subsystem 106 or a sensor, such as proximity sensor 166, accelerometer(s) 168, and/or microphone 113 (through audio circuitry 110). Information that peripherals interface 118 receives from I/O subsystem 106 includes information from touch-sensitive display 112 or a touch-sensitive surface.

In some embodiments, event monitor 171 sends requests to the peripherals interface 118 at predetermined intervals. In response, peripherals interface 118 transmits event information. In other embodiments, peripherals interface 118 transmits event information only when there is a significant event (e.g., receiving an input above a predetermined noise threshold and/or for more than a predetermined duration).

In some embodiments, event sorter 170 also includes a hit view determination module 172 and/or an active event recognizer determination module 173.

Hit view determination module 172 provides software procedures for determining where a sub-event has taken place within one or more views when touch-sensitive display 112 displays more than one view. Views are made up of controls and other elements that a user can see on the display.

Another aspect of the user interface associated with an application is a set of views, sometimes herein called application views or user interface windows, in which information is displayed and touch-based gestures occur. The application views (of a respective application) in which a touch is detected optionally correspond to programmatic levels within a programmatic or view hierarchy of the application. For example, the lowest level view in which a touch is detected is, optionally, called the hit view, and the set of events that are recognized as proper inputs are, optionally, determined based, at least in part, on the hit view of the initial touch that begins a touch-based gesture.

Hit view determination module 172 receives information related to sub-events of a touch-based gesture. When an application has multiple views organized in a hierarchy, hit view determination module 172 identifies a hit view as the lowest view in the hierarchy which should handle the sub-event. In most circumstances, the hit view is the lowest level view in which an initiating sub-event occurs (e.g., the first sub-event in the sequence of sub-events that form an event or potential event). Once the hit view is identified by the hit view determination module 172, the hit view typically receives all sub-events related to the same touch or input source for which it was identified as the hit view.

Active event recognizer determination module 173 determines which view or views within a view hierarchy should receive a particular sequence of sub-events. In some embodiments, active event recognizer determination module 173 determines that only the hit view should receive a particular sequence of sub-events. In other embodiments, active event recognizer determination module 173 determines that all views that include the physical location of a sub-event are actively involved views, and therefore determines that all actively involved views should receive a particular sequence of sub-events. In other embodiments, even if touch sub-events were entirely confined to the area associated with one particular view, views higher in the hierarchy would still remain as actively involved views.

Event dispatcher module 174 dispatches the event information to an event recognizer (e.g., event recognizer 180). In embodiments including active event recognizer determination module 173, event dispatcher module 174 delivers the event information to an event recognizer determined by active event recognizer determination module 173. In some embodiments, event dispatcher module 174 stores in an event queue the event information, which is retrieved by a respective event receiver 182.

In some embodiments, operating system 126 includes event sorter 170. Alternatively, application 136-1 includes event sorter 170. In yet other embodiments, event sorter 170 is a stand-alone module, or a part of another module stored in memory 102, such as contact/motion module 130.

In some embodiments, application 136-1 includes a plurality of event handlers 190 and one or more application views 191, each of which includes instructions for handling touch events that occur within a respective view of the application's user interface. Each application view 191 of the application 136-1 includes one or more event recognizers 180. Typically, a respective application view 191 includes a plurality of event recognizers 180. In other embodiments, one or more of event recognizers 180 are part of a separate module, such as a user interface kit or a higher level object from which application 136-1 inherits methods and other properties. In some embodiments, a respective event handler 190 includes one or more of: data updater 176, object updater 177, GUI updater 178, and/or event data 179 received from event sorter 170. Event handler 190 optionally utilizes or calls data updater 176, object updater 177, or GUI updater 178 to update the application internal state 192. Alternatively, one or more of the application views 191 include one or more respective event handlers 190. Also, in some embodiments, one or more of data updater 176, object updater 177, and GUI updater 178 are included in a respective application view 191.

A respective event recognizer 180 receives event information (e.g., event data 179) from event sorter 170 and identifies an event from the event information. Event recognizer 180 includes event receiver 182 and event comparator 184. In some embodiments, event recognizer 180 also includes at least a subset of: metadata 183, and event delivery instructions 188 (which optionally include sub-event delivery instructions).

Event receiver 182 receives event information from event sorter 170. The event information includes information about a sub-event, for example, a touch or a touch movement. Depending on the sub-event, the event information also includes additional information, such as location of the sub-event. When the sub-event concerns motion of a touch, the event information optionally also includes speed and direction of the sub-event. In some embodiments, events include rotation of the device from one orientation to another (e.g., from a portrait orientation to a landscape orientation, or vice versa), and the event information includes corresponding information about the current orientation (also called device attitude) of the device.

Event comparator 184 compares the event information to predefined event or sub-event definitions and, based on the comparison, determines an event or sub-event, or determines or updates the state of an event or sub-event. In some embodiments, event comparator 184 includes event definitions 186. Event definitions 186 contain definitions of events (e.g., predefined sequences of sub-events), for example, event 1 (187-1), event 2 (187-2), and others. In some embodiments, sub-events in an event (e.g., 187-1 and/or 187-2) include, for example, touch begin, touch end, touch movement, touch cancellation, and multiple touching. In one example, the definition for event 1 (187-1) is a double tap on a displayed object. The double tap, for example, comprises a first touch (touch begin) on the displayed object for a predetermined phase, a first liftoff (touch end) for a predetermined phase, a second touch (touch begin) on the displayed object for a predetermined phase, and a second liftoff (touch end) for a predetermined phase. In another example, the definition for event 2 (187-2) is a dragging on a displayed object. The dragging, for example, comprises a touch (or contact) on the displayed object for a predetermined phase, a movement of the touch across touch-sensitive display 112, and liftoff of the touch (touch end). In some embodiments, the event also includes information for one or more associated event handlers 190.

In some embodiments, event definitions 186 include a definition of an event for a respective user-interface object. In some embodiments, event comparator 184 performs a hit test to determine which user-interface object is associated with a sub-event. For example, in an application view in which three user-interface objects are displayed on touch-sensitive display 112, when a touch is detected on touch-sensitive display 112, event comparator 184 performs a hit test to determine which of the three user-interface objects is associated with the touch (sub-event). If each displayed object is associated with a respective event handler 190, the event comparator uses the result of the hit test to determine which event handler 190 should be activated. For example, event comparator 184 selects an event handler associated with the sub-event and the object triggering the hit test.

In some embodiments, the definition for a respective event (187) also includes delayed actions that delay delivery of the event information until after it has been determined whether the sequence of sub-events does or does not correspond to the event recognizer's event type.

When a respective event recognizer 180 determines that the series of sub-events do not match any of the events in event definitions 186, the respective event recognizer 180 enters an event impossible, event failed, or event ended state, after which it disregards subsequent sub-events of the touch-based gesture. In this situation, other event recognizers, if any, that remain active for the hit view continue to track and process sub-events of an ongoing touch-based gesture.

In some embodiments, a respective event recognizer 180 includes metadata 183 with configurable properties, flags, and/or lists that indicate how the event delivery system should perform sub-event delivery to actively involved event recognizers. In some embodiments, metadata 183 includes configurable properties, flags, and/or lists that indicate how event recognizers interact, or are enabled to interact, with one another. In some embodiments, metadata 183 includes configurable properties, flags, and/or lists that indicate whether sub-events are delivered to varying levels in the view or programmatic hierarchy.

In some embodiments, a respective event recognizer 180 activates event handler 190 associated with an event when one or more particular sub-events of an event are recognized. In some embodiments, a respective event recognizer 180 delivers event information associated with the event to event handler 190. Activating an event handler 190 is distinct from sending (and deferred sending) sub-events to a respective hit view. In some embodiments, event recognizer 180 throws a flag associated with the recognized event, and event handler 190 associated with the flag catches the flag and performs a predefined process.

In some embodiments, event delivery instructions 188 include sub-event delivery instructions that deliver event information about a sub-event without activating an event handler. Instead, the sub-event delivery instructions deliver event information to event handlers associated with the series of sub-events or to actively involved views. Event handlers associated with the series of sub-events or with actively involved views receive the event information and perform a predetermined process.

In some embodiments, data updater 176 creates and updates data used in application 136-1. For example, data updater 176 updates the telephone number used in contacts module 137, or stores a video file used in video player module. In some embodiments, object updater 177 creates and updates objects used in application 136-1. For example, object updater 177 creates a new user-interface object or updates the position of a user-interface object. GUI updater 178 updates the GUI. For example, GUI updater 178 prepares display information and sends it to graphics module 132 for display on a touch-sensitive display.

In some embodiments, event handler(s) 190 includes or has access to data updater 176, object updater 177, and GUI updater 178. In some embodiments, data updater 176, object updater 177, and GUI updater 178 are included in a single module of a respective application 136-1 or application view 191. In other embodiments, they are included in two or more software modules.

It shall be understood that the foregoing discussion regarding event handling of user touches on touch-sensitive displays also applies to other forms of user inputs to operate multifunction devices 100 with input devices, not all of which are initiated on touch screens. For example, mouse movement and mouse button presses, optionally coordinated with single or multiple keyboard presses or holds; contact movements such as taps, drags, scrolls, etc. on touchpads; pen stylus inputs; movement of the device; oral instructions; detected eye movements; biometric inputs; and/or any combination thereof are optionally utilized as inputs corresponding to sub-events which define an event to be recognized.

FIG. 2 illustrates a portable multifunction device 100 having a touch screen 112 in accordance with some embodiments. The touch screen optionally displays one or more graphics within user interface (UI) 200. In this embodiment, as well as others described below, a user is enabled to select one or more of the graphics by making a gesture on the graphics, for example, with one or more fingers 202 (not drawn to scale in the figure) or one or more styluses 203 (not drawn to scale in the figure). In some embodiments, selection of one or more graphics occurs when the user breaks contact with the one or more graphics. In some embodiments, the gesture optionally includes one or more taps, one or more swipes (from left to right, right to left, upward and/or downward), and/or a rolling of a finger (from right to left, left to right, upward and/or downward) that has made contact with device 100. In some implementations or circumstances, inadvertent contact with a graphic does not select the graphic. For example, a swipe gesture that sweeps over an application icon optionally does not select the corresponding application when the gesture corresponding to selection is a tap.

Device 100 optionally also include one or more physical buttons, such as “home” or menu button 204. As described previously, menu button 204 is, optionally, used to navigate to any application 136 in a set of applications that are, optionally, executed on device 100. Alternatively, in some embodiments, the menu button is implemented as a soft key in a GUI displayed on touch screen 112.

In some embodiments, device 100 includes touch screen 112, menu button 204, push button 206 for powering the device on/off and locking the device, volume adjustment button(s) 208, subscriber identity module (SIM) card slot 210, headset jack 212, and docking/charging external port 124. Push button 206 is, optionally, used to turn the power on/off on the device by depressing the button and holding the button in the depressed state for a predefined time interval; to lock the device by depressing the button and releasing the button before the predefined time interval has elapsed; and/or to unlock the device or initiate an unlock process. In an alternative embodiment, device 100 also accepts verbal input for activation or deactivation of some functions through microphone 113. Device 100 also, optionally, includes one or more contact intensity sensors 165 for detecting intensity of contacts on touch screen 112 and/or one or more tactile output generators 167 for generating tactile outputs for a user of device 100.

FIG. 3A is a block diagram of an exemplary multifunction device with a display and a touch-sensitive surface in accordance with some embodiments. Device 300 need not be portable. In some embodiments, device 300 is a laptop computer, a desktop computer, a tablet computer, a multimedia player device, a navigation device, an educational device (such as a child's learning toy), a gaming system, or a control device (e.g., a home or industrial controller). Device 300 typically includes one or more processing units (CPUs) 310, one or more network or other communications interfaces 360, memory 370, and one or more communication buses 320 for interconnecting these components. Communication buses 320 optionally include circuitry (sometimes called a chipset) that interconnects and controls communications between system components. Device 300 includes input/output (I/O) interface 330 comprising display 340, which is typically a touch screen display. I/O interface 330 also optionally includes a keyboard and/or mouse (or other pointing device) 350 and touchpad 355, tactile output generator 357 for generating tactile outputs on device 300 (e.g., similar to tactile output generator(s) 167 described above with reference to FIG. 1A), sensors 359 (e.g., optical, acceleration, proximity, touch-sensitive, and/or contact intensity sensors similar to contact intensity sensor(s) 165 described above with reference to FIG. 1A). Memory 370 includes high-speed random access memory, such as DRAM, SRAM, DDR RAM, or other random access solid state memory devices; and optionally includes non-volatile memory, such as one or more magnetic disk storage devices, optical disk storage devices, flash memory devices, or other non-volatile solid state storage devices. Memory 370 optionally includes one or more storage devices remotely located from CPU(s) 310. In some embodiments, memory 370 stores programs, modules, and data structures analogous to the programs, modules, and data structures stored in memory 102 of portable multifunction device 100 (FIG. 1A), or a subset thereof. Furthermore, memory 370 optionally stores additional programs, modules, and data structures not present in memory 102 of portable multifunction device 100. For example, memory 370 of device 300 optionally stores drawing module 380, presentation module 382, word processing module 384, website creation module 386, disk authoring module 388, and/or spreadsheet module 390, while memory 102 of portable multifunction device 100 (FIG. 1A) optionally does not store these modules.

Each of the above-identified elements in FIG. 3A is, optionally, stored in one or more of the previously mentioned memory devices. Each of the above-identified modules corresponds to a set of instructions for performing a function described above. The above-identified modules or computer programs (e.g., sets of instructions or including instructions) need not be implemented as separate software programs (such as computer programs (e.g., including instructions)), procedures, or modules, and thus various subsets of these modules are, optionally, combined or otherwise rearranged in various embodiments. In some embodiments, memory 370 optionally stores a subset of the modules and data structures identified above. Furthermore, memory 370 optionally stores additional modules and data structures not described above.

Implementations within the scope of the present disclosure can be partially or entirely realized using a tangible computer-readable storage medium (or multiple tangible computer-readable storage media of one or more types) encoding one or more computer-readable instructions. It should be recognized that computer-readable instructions can be organized in any format, including applications, widgets, processes, software, and/or components.

Implementations within the scope of the present disclosure include a computer-readable storage medium that encodes instructions organized as an application (e.g., application 3160) that, when executed by one or more processing units, control an electronic device (e.g., device 3150) to perform the method of FIG. 3B, the method of FIG. 3C, and/or one or more other processes and/or methods described herein.

It should be recognized that application 3160 (shown in FIG. 3D) can be any suitable type of application, including, for example, one or more of: a browser application, an application that functions as an execution environment for plug-ins, widgets or other applications, a fitness application, a health application, a digital payments application, a media application, a social network application, a messaging application, and/or a maps application. In some embodiments, application 3160 is an application that is pre-installed on device 3150 at purchase (e.g., a first-party application). In some embodiments, application 3160 is an application that is provided to device 3150 via an operating system update file (e.g., a first-party application or a second-party application). In some embodiments, application 3160 is an application that is provided via an application store. In some embodiments, the application store can be an application store that is pre-installed on device 3150 at purchase (e.g., a first-party application store). In some embodiments, the application store is a third-party application store (e.g., an application store that is provided by another application store, downloaded via a network, and/or read from a storage device).

Referring to FIG. 3B and FIG. 3F, application 3160 obtains information (e.g., 3010). In some embodiments, at 3010, information is obtained from at least one hardware component of device 3150. In some embodiments, at 3010, information is obtained from at least one software module of device 3150. In some embodiments, at 3010, information is obtained from at least one hardware component external to device 3150 (e.g., a peripheral device, an accessory device, and/or a server). In some embodiments, the information obtained at 3010 includes positional information, time information, notification information, user information, environment information, electronic device state information, weather information, media information, historical information, event information, hardware information, and/or motion information. In some embodiments, in response to and/or after obtaining the information at 3010, application 3160 provides the information to a system (e.g., 3020).

In some embodiments, the system (e.g., 3110 shown in FIG. 3E) is an operating system hosted on device 3150. In some embodiments, the system (e.g., 3110 shown in FIG. 3E) is an external device (e.g., a server, a peripheral device, an accessory, and/or a personal computing device) that includes an operating system.

Referring to FIG. 3C and FIG. 3G, application 3160 obtains information (e.g., 3030). In some embodiments, the information obtained at 3030 includes positional information, time information, notification information, user information, environment information electronic device state information, weather information, media information, historical information, event information, hardware information, and/or motion information. In response to and/or after obtaining the information at 3030, application 3160 performs an operation with the information (e.g., 3040). In some embodiments, the operation performed at 3040 includes: providing a notification based on the information, sending a message based on the information, displaying the information, controlling a user interface of a fitness application based on the information, controlling a user interface of a health application based on the information, controlling a focus mode based on the information, setting a reminder based on the information, adding a calendar entry based on the information, and/or calling an API of system 3110 based on the information.

In some embodiments, one or more steps of the method of FIG. 3B and/or the method of FIG. 3C is performed in response to a trigger. In some embodiments, the trigger includes detection of an event, a notification received from system 3110, a user input, and/or a response to a call to an API provided by system 3110.

In some embodiments, the instructions of application 3160, when executed, control device 3150 to perform the method of FIG. 3B and/or the method of FIG. 3C by calling an application programming interface (API) (e.g., API 3190) provided by system 3110. In some embodiments, application 3160 performs at least a portion of the method of FIG. 3B and/or the method of FIG. 3C without calling API 3190.

In some embodiments, one or more steps of the method of FIG. 3B and/or the method of FIG. 3C includes calling an API (e.g., API 3190) using one or more parameters defined by the API. In some embodiments, the one or more parameters include a constant, a key, a data structure, an object, an object class, a variable, a data type, a pointer, an array, a list or a pointer to a function or method, and/or another way to reference a data or other item to be passed via the API.

Referring to FIG. 3D, device 3150 is illustrated. In some embodiments, device 3150 is a personal computing device, a smart phone, a smart watch, a fitness tracker, a head mounted display (HMD) device, a media device, a communal device, a speaker, a television, and/or a tablet. As illustrated in FIG. 3D, device 3150 includes application 3160 and an operating system (e.g., system 3110 shown in FIG. 3E). Application 3160 includes application implementation module 3170 and API-calling module 3180. System 3110 includes API 3190 and implementation module 3100. It should be recognized that device 3150, application 3160, and/or system 3110 can include more, fewer, and/or different components than illustrated in FIGS. 3D and 3E.

In some embodiments, application implementation module 3170 includes a set of one or more instructions corresponding to one or more operations performed by application 3160. For example, when application 3160 is a messaging application, application implementation module 3170 can include operations to receive and send messages. In some embodiments, application implementation module 3170 communicates with API-calling module 3180 to communicate with system 3110 via API 3190 (shown in FIG. 3E).

In some embodiments, API 3190 is a software module (e.g., a collection of computer-readable instructions) that provides an interface that allows a different module (e.g., API-calling module 3180) to access and/or use one or more functions, methods, procedures, data structures, classes, and/or other services provided by implementation module 3100 of system 3110. For example, API-calling module 3180 can access a feature of implementation module 3100 through one or more API calls or invocations (e.g., embodied by a function or a method call) exposed by API 3190 (e.g., a software and/or hardware module that can receive API calls, respond to API calls, and/or send API calls) and can pass data and/or control information using one or more parameters via the API calls or invocations. In some embodiments, API 3190 allows application 3160 to use a service provided by a Software Development Kit (SDK) library. In some embodiments, application 3160 incorporates a call to a function or method provided by the SDK library and provided by API 3190 or uses data types or objects defined in the SDK library and provided by API 3190. In some embodiments, API-calling module 3180 makes an API call via API 3190 to access and use a feature of implementation module 3100 that is specified by API 3190. In such embodiments, implementation module 3100 can return a value via API 3190 to API-calling module 3180 in response to the API call. The value can report to application 3160 the capabilities or state of a hardware component of device 3150, including those related to aspects such as input capabilities and state, output capabilities and state, processing capability, power state, storage capacity and state, and/or communications capability. In some embodiments, API 3190 is implemented in part by firmware, microcode, or other low level logic that executes in part on the hardware component.

In some embodiments, API 3190 allows a developer of API-calling module 3180 (which can be a third-party developer) to leverage a feature provided by implementation module 3100. In such embodiments, there can be one or more API-calling modules (e.g., including API-calling module 3180) that communicate with implementation module 3100. In some embodiments, API 3190 allows multiple API-calling modules written in different programming languages to communicate with implementation module 3100 (e.g., API 3190 can include features for translating calls and returns between implementation module 3100 and API-calling module 3180) while API 3190 is implemented in terms of a specific programming language. In some embodiments, API-calling module 3180 calls APIs from different providers such as a set of APIs from an OS provider, another set of APIs from a plug-in provider, and/or another set of APIs from another provider (e.g., the provider of a software library) or creator of the another set of APIs.

Examples of API 3190 can include one or more of: a pairing API (e.g., for establishing secure connection, e.g., with an accessory), a device detection API (e.g., for locating nearby devices, e.g., media devices and/or smartphone), a payment API, a UIKit API (e.g., for generating user interfaces), a location detection API, a locator API, a maps API, a health sensor API, a sensor API, a messaging API, a push notification API, a streaming API, a collaboration API, a video conferencing API, an application store API, an advertising services API, a web browser API (e.g., WebKit API), a vehicle API, a networking API, a WiFi API, a Bluetooth API, an NFC API, a UWB API, a fitness API, a smart home API, contact transfer API, photos API, camera API, and/or image processing API. In some embodiments, the sensor API is an API for accessing data associated with a sensor of device 3150. For example, the sensor API can provide access to raw sensor data. For another example, the sensor API can provide data derived (and/or generated) from the raw sensor data. In some embodiments, the sensor data includes temperature data, image data, video data, audio data, heart rate data, IMU (inertial measurement unit) data, lidar data, location data, GPS data, and/or camera data. In some embodiments, the sensor includes one or more of an accelerometer, temperature sensor, infrared sensor, optical sensor, heartrate sensor, barometer, gyroscope, proximity sensor, temperature sensor, and/or biometric sensor.

In some embodiments, implementation module 3100 is a system (e.g., operating system and/or server system) software module (e.g., a collection of computer-readable instructions) that is constructed to perform an operation in response to receiving an API call via API 3190. In some embodiments, implementation module 3100 is constructed to provide an API response (via API 3190) as a result of processing an API call. By way of example, implementation module 3100 and API-calling module 3180 can each be any one of an operating system, a library, a device driver, an API, an application program, or other module. It should be understood that implementation module 3100 and API-calling module 3180 can be the same or different type of module from each other. In some embodiments, implementation module 3100 is embodied at least in part in firmware, microcode, or hardware logic.

In some embodiments, implementation module 3100 returns a value through API 3190 in response to an API call from API-calling module 3180. While API 3190 defines the syntax and result of an API call (e.g., how to invoke the API call and what the API call does), API 3190 might not reveal how implementation module 3100 accomplishes the function specified by the API call. Various API calls are transferred via the one or more application programming interfaces between API-calling module 3180 and implementation module 3100. Transferring the API calls can include issuing, initiating, invoking, calling, receiving, returning, and/or responding to the function calls or messages. In other words, transferring can describe actions by either of API-calling module 3180 or implementation module 3100. In some embodiments, a function call or other invocation of API 3190 sends and/or receives one or more parameters through a parameter list or other structure.

In some embodiments, implementation module 3100 provides more than one API, each providing a different view of or with different aspects of functionality implemented by implementation module 3100. For example, one API of implementation module 3100 can provide a first set of functions and can be exposed to third-party developers, and another API of implementation module 3100 can be hidden (e.g., not exposed) and provide a subset of the first set of functions and also provide another set of functions, such as testing or debugging functions which are not in the first set of functions. In some embodiments, implementation module 3100 calls one or more other components via an underlying API and thus is both an API-calling module and an implementation module. It should be recognized that implementation module 3100 can include additional functions, methods, classes, data structures, and/or other features that are not specified through API 3190 and are not available to API-calling module 3180. It should also be recognized that API-calling module 3180 can be on the same system as implementation module 3100 or can be located remotely and access implementation module 3100 using API 3190 over a network. In some embodiments, implementation module 3100, API 3190, and/or API-calling module 3180 is stored in a machine-readable medium, which includes any mechanism for storing information in a form readable by a machine (e.g., a computer or other data processing system). For example, a machine-readable medium can include magnetic disks, optical disks, random access memory; read only memory, and/or flash memory devices.

An application programming interface (API) is an interface between a first software process and a second software process that specifies a format for communication between the first software process and the second software process. Limited APIs (e.g., private APIs or partner APIs) are APIs that are accessible to a limited set of software processes (e.g., only software processes within an operating system or only software processes that are approved to access the limited APIs). Public APIs that are accessible to a wider set of software processes. Some APIs enable software processes to communicate about or set a state of one or more input devices (e.g., one or more touch sensors, proximity sensors, visual sensors, motion/orientation sensors, pressure sensors, intensity sensors, sound sensors, wireless proximity sensors, biometric sensors, buttons, switches, rotatable elements, and/or external controllers). Some APIs enable software processes to communicate about and/or set a state of one or more output generation components (e.g., one or more audio output generation components, one or more display generation components, and/or one or more tactile output generation components). Some APIs enable particular capabilities (e.g., scrolling, handwriting, text entry, image editing, and/or image creation) to be accessed, performed, and/or used by a software process (e.g., generating outputs for use by a software process based on input from the software process). Some APIs enable content from a software process to be inserted into a template and displayed in a user interface that has a layout and/or behaviors that are specified by the template.

Many software platforms include a set of frameworks that provides the core objects and core behaviors that a software developer needs to build software applications that can be used on the software platform. Software developers use these objects to display content onscreen, to interact with that content, and to manage interactions with the software platform. Software applications rely on the set of frameworks for their basic behavior, and the set of frameworks provides many ways for the software developer to customize the behavior of the application to match the specific needs of the software application. Many of these core objects and core behaviors are accessed via an API. An API will typically specify a format for communication between software processes, including specifying and grouping available variables, functions, and protocols. An API call (sometimes referred to as an API request) will typically be sent from a sending software process to a receiving software process as a way to accomplish one or more of the following: the sending software process requesting information from the receiving software process (e.g., for the sending software process to take action on), the sending software process providing information to the receiving software process (e.g., for the receiving software process to take action on), the sending software process requesting action by the receiving software process, or the sending software process providing information to the receiving software process about action taken by the sending software process. Interaction with a device (e.g., using a user interface) will in some circumstances include the transfer and/or receipt of one or more API calls (e.g., multiple API calls) between multiple different software processes (e.g., different portions of an operating system, an application and an operating system, or different applications) via one or more APIs (e.g., via multiple different APIs). For example, when an input is detected the direct sensor data is frequently processed into one or more input events that are provided (e.g., via an API) to a receiving software process that makes some determination based on the input events, and then sends (e.g., via an API) information to a software process to perform an operation (e.g., change a device state and/or user interface) based on the determination. While a determination and an operation performed in response could be made by the same software process, alternatively the determination could be made in a first software process and relayed (e.g., via an API) to a second software process, that is different from the first software process, that causes the operation to be performed by the second software process. Alternatively, the second software process could relay instructions (e.g., via an API) to a third software process that is different from the first software process and/or the second software process to perform the operation. It should be understood that some or all user interactions with a computer system could involve one or more API calls within a step of interacting with the computer system (e.g., between different software components of the computer system or between a software component of the computer system and a software component of one or more remote computer systems). It should be understood that some or all user interactions with a computer system could involve one or more API calls between steps of interacting with the computer system (e.g., between different software components of the computer system or between a software component of the computer system and a software component of one or more remote computer systems).

In some embodiments, the application can be any suitable type of application, including, for example, one or more of: a browser application, an application that functions as an execution environment for plug-ins, widgets or other applications, a fitness application, a health application, a digital payments application, a media application, a social network application, a messaging application, and/or a maps application.

In some embodiments, the application is an application that is pre-installed on the first computer system at purchase (e.g., a first-party application). In some embodiments, the application is an application that is provided to the first computer system via an operating system update file (e.g., a first-party application). In some embodiments, the application is an application that is provided via an application store. In some embodiments, the application store is pre-installed on the first computer system at purchase (e.g., a first-party application store) and allows download of one or more applications. In some embodiments, the application store is a third-party application store (e.g., an application store that is provided by another device, downloaded via a network, and/or read from a storage device). In some embodiments, the application is a third-party application (e.g., an app that is provided by an application store, downloaded via a network, and/or read from a storage device). In some embodiments, the application controls the first computer system to perform methods 700 and/or 900 (FIGS. 7 and/or 9) by calling an application programming interface (API) provided by the system process using one or more parameters.

In some embodiments, exemplary APIs provided by the system process include one or more of: a pairing API (e.g., for establishing secure connection, e.g., with an accessory), a device detection API (e.g., for locating nearby devices, e.g., media devices and/or smartphone), a payment API, a UIKit API (e.g., for generating user interfaces), a location detection API, a locator API, a maps API, a health sensor API, a sensor API, a messaging API, a push notification API, a streaming API, a collaboration API, a video conferencing API, an application store API, an advertising services API, a web browser API (e.g., WebKit API), a vehicle API, a networking API, a WiFi API, a Bluetooth API, an NFC API, a UWB API, a fitness API, a smart home API, contact transfer API, a photos API, a camera API, and/or an image processing API.

In some embodiments, at least one API is a software module (e.g., a collection of computer-readable instructions) that provides an interface that allows a different module (e.g., API-calling module 3180) to access and use one or more functions, methods, procedures, data structures, classes, and/or other services provided by an implementation module of the system process. The API can define one or more parameters that are passed between the API-calling module and the implementation module. In some embodiments, API 3190 defines a first API call that can be provided by API-calling module 3180. The implementation module is a system software module (e.g., a collection of computer-readable instructions) that is constructed to perform an operation in response to receiving an API call via the API. In some embodiments, the implementation module is constructed to provide an API response (via the API) as a result of processing an API call. In some embodiments, the implementation module is included in the device (e.g., 3150) that runs the application. In some embodiments, the implementation module is included in an electronic device that is separate from the device that runs the application.

Attention is now directed towards embodiments of user interfaces that are, optionally, implemented on, for example, portable multifunction device 100.

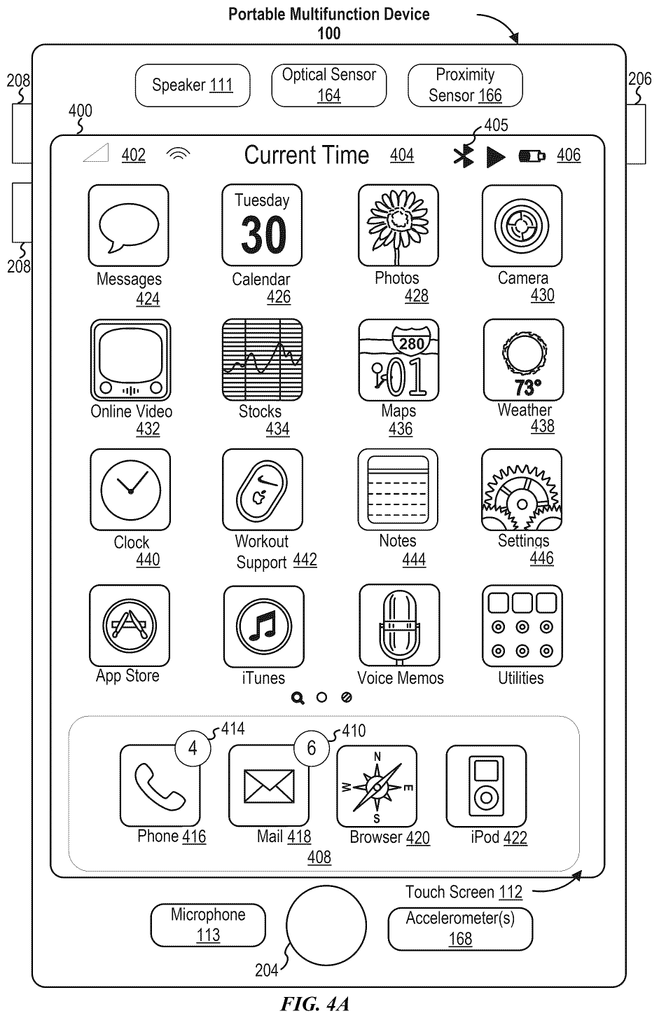

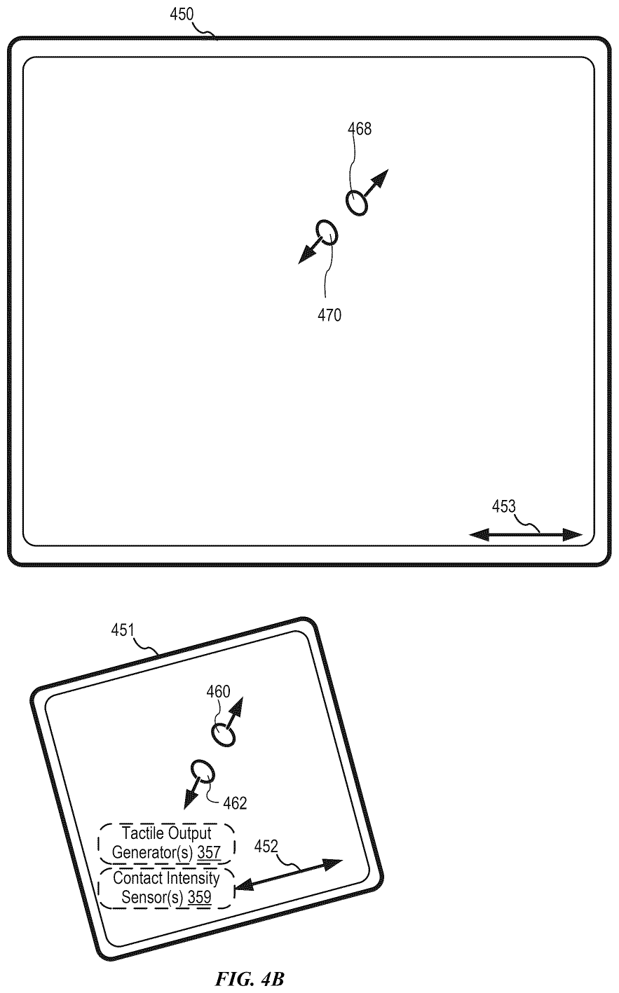

FIG. 4A illustrates an exemplary user interface for a menu of applications on portable multifunction device 100 in accordance with some embodiments. Similar user interfaces are, optionally, implemented on device 300. In some embodiments, user interface 400 includes the following elements, or a subset or superset thereof:
Signal strength indicator(s) 402 for wireless communication(s), such as cellular and Wi-Fi signals;
Time 404;
Bluetooth indicator 405;
Battery status indicator 406;
Tray 408 with icons for frequently used applications, such as:
   Icon 416 for telephone module 138, labeled “Phone,” which optionally includes an indicator 414 of the number of missed calls or voicemail messages;
   Icon 418 for e-mail client module 140, labeled “Mail,” which optionally includes an indicator 410 of the number of unread e-mails;
   Icon 420 for browser module 147, labeled “Browser;” and
   Icon 422 for video and music player module 152, also referred to as iPod (trademark of Apple Inc.) module 152, labeled “iPod;” and
Icons for other applications, such as:
   Icon 424 for IM module 141, labeled “Messages;”
   Icon 426 for calendar module 148, labeled “Calendar;”
   Icon 428 for image management module 144, labeled “Photos;”
   Icon 430 for camera module 143, labeled “Camera;”
   Icon 432 for online video module 155, labeled “Online Video;”
   Icon 434 for stocks widget 149-2, labeled “Stocks;”
   Icon 436 for map module 154, labeled “Maps;”
   Icon 438 for weather widget 149-1, labeled “Weather;”
   Icon 440 for alarm clock widget 149-4, labeled “Clock;”
   Icon 442 for workout support module 142, labeled “Workout Support;”
   Icon 444 for notes module 153, labeled “Notes;” and
   Icon 446 for a settings application or module, labeled “Settings,” which provides access to settings for device 100 and its various applications 136.

It should be noted that the icon labels illustrated in FIG. 4A are merely exemplary. For example, icon 422 for video and music player module 152 is labeled “Music” or “Music Player.” Other labels are, optionally, used for various application icons. In some embodiments, a label for a respective application icon includes a name of an application corresponding to the respective application icon. In some embodiments, a label for a particular application icon is distinct from a name of an application corresponding to the particular application icon.

FIG. 4B illustrates an exemplary user interface on a device (e.g., device 300, FIG. 3A) with a touch-sensitive surface 451 (e.g., a tablet or touchpad 355, FIG. 3A) that is separate from the display 450 (e.g., touch screen display 112). Device 300 also, optionally, includes one or more contact intensity sensors (e.g., one or more of sensors 359) for detecting intensity of contacts on touch-sensitive surface 451 and/or one or more tactile output generators 357 for generating tactile outputs for a user of device 300.

Although some of the examples that follow will be given with reference to inputs on touch screen display 112 (where the touch-sensitive surface and the display are combined), in some embodiments, the device detects inputs on a touch-sensitive surface that is separate from the display, as shown in FIG. 4B. In some embodiments, the touch-sensitive surface (e.g., touch-sensitive surface 451 in FIG. 4B) has a primary axis (e.g., 452 in FIG. 4B) that corresponds to a primary axis (e.g., 453 in FIG. 4B) on the display (e.g., display 450). In accordance with these embodiments, the device detects contacts (e.g., contact 460 and contact 462 in FIG. 4B) with the touch-sensitive surface 451 at locations that correspond to respective locations on the display (e.g., in FIG. 4B, contact 460 corresponds to 468 and contact 462 corresponds to 470). In this way, user inputs (e.g., contacts 460 and 462, and movements thereof) detected by the device on the touch-sensitive surface (e.g., touch-sensitive surface 451 in FIG. 4B) are used by the device to manipulate the user interface on the display (e.g., display 450 in FIG. 4B) of the multifunction device when the touch-sensitive surface is separate from the display. It should be understood that similar methods are, optionally, used for other user interfaces described herein.

Additionally, while the following examples are given primarily with reference to finger inputs (e.g., finger contacts, finger tap gestures, finger swipe gestures), it should be understood that, in some embodiments, one or more of the finger inputs are replaced with input from another input device (e.g., a mouse-based input or stylus input). For example, a swipe gesture is, optionally, replaced with a mouse click (e.g., instead of a contact) followed by movement of the cursor along the path of the swipe (e.g., instead of movement of the contact). As another example, a tap gesture is, optionally, replaced with a mouse click while the cursor is located over the location of the tap gesture (e.g., instead of detection of the contact followed by ceasing to detect the contact). Similarly, when multiple user inputs are simultaneously detected, it should be understood that multiple computer mice are, optionally, used simultaneously, or a mouse and finger contacts are, optionally, used simultaneously.

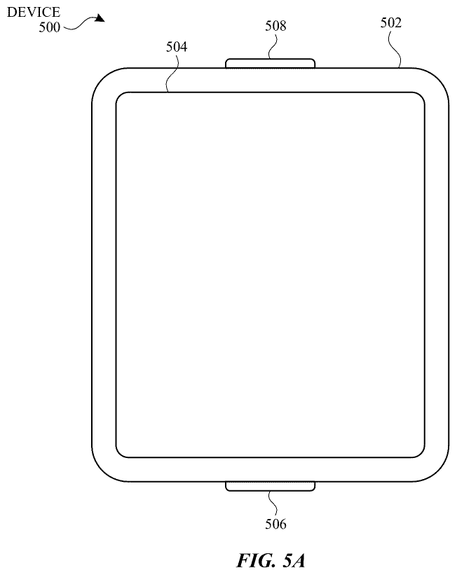

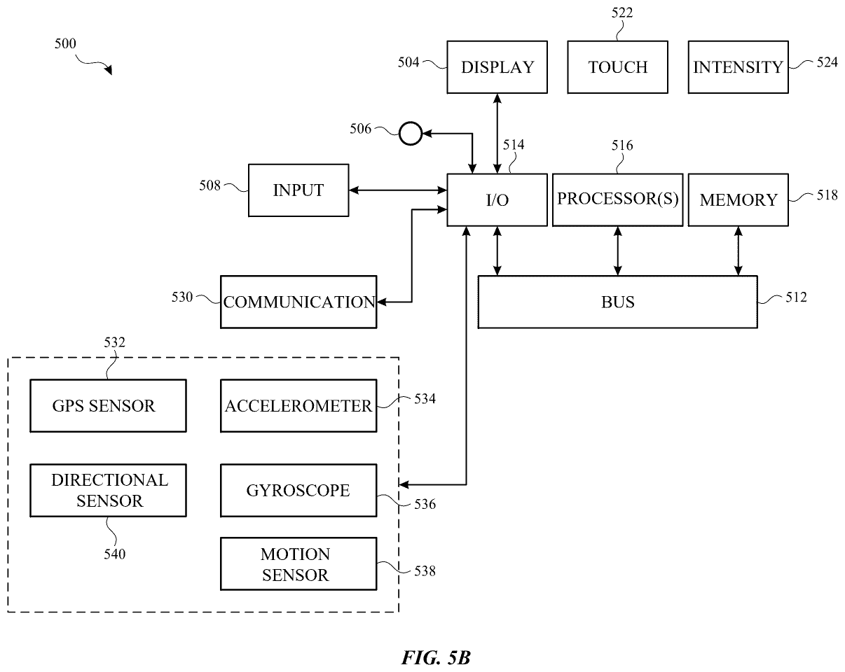

FIG. 5A illustrates exemplary personal electronic device 500. Device 500 includes body 502. In some embodiments, device 500 can include some or all of the features described with respect to devices 100 and 300 (e.g., FIGS. 1A-4B). In some embodiments, device 500 has touch-sensitive display screen 504, hereafter touch screen 504. Alternatively, or in addition to touch screen 504, device 500 has a display and a touch-sensitive surface. As with devices 100 and 300, in some embodiments, touch screen 504 (or the touch-sensitive surface) optionally includes one or more intensity sensors for detecting intensity of contacts (e.g., touches) being applied. The one or more intensity sensors of touch screen 504 (or the touch-sensitive surface) can provide output data that represents the intensity of touches. The user interface of device 500 can respond to touches based on their intensity, meaning that touches of different intensities can invoke different user interface operations on device 500.

Exemplary techniques for detecting and processing touch intensity are found, for example, in related applications: International Patent Application Serial No. PCT/US2013/040061, titled “Device, Method, and Graphical User Interface for Displaying User Interface Objects Corresponding to an Application,” filed May 8, 2013, published as WIPO Publication No. WO/2013/169849, and International Patent Application Serial No. PCT/US2013/069483, titled “Device, Method, and Graphical User Interface for Transitioning Between Touch Input to Display Output Relationships,” filed Nov. 11, 2013, published as WIPO Publication No. WO/2014/105276, each of which is hereby incorporated by reference in their entirety.

In some embodiments, device 500 has one or more input mechanisms 506 and 508. Input mechanisms 506 and 508, if included, can be physical. Examples of physical input mechanisms include push buttons and rotatable mechanisms. In some embodiments, device 500 has one or more attachment mechanisms. Such attachment mechanisms, if included, can permit attachment of device 500 with, for example, hats, eyewear, earrings, necklaces, shirts, jackets, bracelets, watch straps, chains, trousers, belts, shoes, purses, backpacks, and so forth. These attachment mechanisms permit device 500 to be worn by a user.

FIG. 5B depicts exemplary personal electronic device 500. In some embodiments, device 500 can include some or all of the components described with respect to FIGS. 1A, 1B, and 3A. Device 500 has bus 512 that operatively couples I/O section 514 with one or more computer processors 516 and memory 518. I/O section 514 can be connected to display screen 504, which can have touch-sensitive component 522 and, optionally, intensity sensor 524 (e.g., contact intensity sensor). In addition, I/O section 514 can be connected with communication unit 530 for receiving application and operating system data, using Wi-Fi, Bluetooth, near field communication (NFC), cellular, and/or other wireless communication techniques. Device 500 can include input mechanisms 506 and/or 508. Input mechanism 506 is, optionally, a rotatable input device or a depressible and rotatable input device, for example. Input mechanism 508 is, optionally, a button, in some examples.

Input mechanism 508 is, optionally, a microphone, in some examples. Personal electronic device 500 optionally includes various sensors, such as GPS sensor 532, accelerometer 534, directional sensor 540 (e.g., compass), gyroscope 536, motion sensor 538, and/or a combination thereof, all of which can be operatively connected to I/O section 514.

Memory 518 of personal electronic device 500 can include one or more non-transitory computer-readable storage mediums, for storing computer-executable instructions, which, when executed by one or more computer processors 516, for example, can cause the computer processors to perform the techniques described below, including processes 700 and 900 (FIGS. 7 and 9). A computer-readable storage medium can be any medium that can tangibly contain or store computer-executable instructions for use by or in connection with the instruction execution system, apparatus, or device. In some examples, the storage medium is a transitory computer-readable storage medium. In some examples, the storage medium is a non-transitory computer-readable storage medium. The non-transitory computer-readable storage medium can include, but is not limited to, magnetic, optical, and/or semiconductor storages. Examples of such storage include magnetic disks, optical discs based on CD, DVD, or Blu-ray technologies, as well as persistent solid-state memory such as flash, solid-state drives, and the like. Personal electronic device 500 is not limited to the components and configuration of FIG. 5B, but can include other or additional components in multiple configurations.

As used here, the term “affordance” refers to a user-interactive graphical user interface object that is, optionally, displayed on the display screen of devices 100, 300, and/or 500 (FIGS. 1A, 3A, and 5A-5B). For example, an image (e.g., icon), a button, and text (e.g., hyperlink) each optionally constitute an affordance.

As used herein, the term “focus selector” refers to an input element that indicates a current part of a user interface with which a user is interacting. In some implementations that include a cursor or other location marker, the cursor acts as a “focus selector” so that when an input (e.g., a press input) is detected on a touch-sensitive surface (e.g., touchpad 355 in FIG. 3A or touch-sensitive surface 451 in FIG. 4B) while the cursor is over a particular user interface element (e.g., a button, window, slider, or other user interface element), the particular user interface element is adjusted in accordance with the detected input. In some implementations that include a touch screen display (e.g., touch-sensitive display system 112 in FIG. 1A or touch screen 112 in FIG. 4A) that enables direct interaction with user interface elements on the touch screen display, a detected contact on the touch screen acts as a “focus selector” so that when an input (e.g., a press input by the contact) is detected on the touch screen display at a location of a particular user interface element (e.g., a button, window, slider, or other user interface element), the particular user interface element is adjusted in accordance with the detected input. In some implementations, focus is moved from one region of a user interface to another region of the user interface without corresponding movement of a cursor or movement of a contact on a touch screen display (e.g., by using a tab key or arrow keys to move focus from one button to another button); in these implementations, the focus selector moves in accordance with movement of focus between different regions of the user interface. Without regard to the specific form taken by the focus selector, the focus selector is generally the user interface element (or contact on a touch screen display) that is controlled by the user so as to communicate the user's intended interaction with the user interface (e.g., by indicating, to the device, the element of the user interface with which the user is intending to interact). For example, the location of a focus selector (e.g., a cursor, a contact, or a selection box) over a respective button while a press input is detected on the touch-sensitive surface (e.g., a touchpad or touch screen) will indicate that the user is intending to activate the respective button (as opposed to other user interface elements shown on a display of the device).

As used in the specification and claims, the term “characteristic intensity” of a contact refers to a characteristic of the contact based on one or more intensities of the contact. In some embodiments, the characteristic intensity is based on multiple intensity samples. The characteristic intensity is, optionally, based on a predefined number of intensity samples, or a set of intensity samples collected during a predetermined time period (e.g., 0.05, 0.1, 0.2, 0.5, 1, 2, 5, 10 seconds) relative to a predefined event (e.g., after detecting the contact, prior to detecting liftoff of the contact, before or after detecting a start of movement of the contact, prior to detecting an end of the contact, before or after detecting an increase in intensity of the contact, and/or before or after detecting a decrease in intensity of the contact). A characteristic intensity of a contact is, optionally, based on one or more of: a maximum value of the intensities of the contact, a mean value of the intensities of the contact, an average value of the intensities of the contact, a top 10 percentile value of the intensities of the contact, a value at the half maximum of the intensities of the contact, a value at the 90 percent maximum of the intensities of the contact, or the like. In some embodiments, the duration of the contact is used in determining the characteristic intensity (e.g., when the characteristic intensity is an average of the intensity of the contact over time). In some embodiments, the characteristic intensity is compared to a set of one or more intensity thresholds to determine whether an operation has been performed by a user. For example, the set of one or more intensity thresholds optionally includes a first intensity threshold and a second intensity threshold. In this example, a contact with a characteristic intensity that does not exceed the first threshold results in a first operation, a contact with a characteristic intensity that exceeds the first intensity threshold and does not exceed the second intensity threshold results in a second operation, and a contact with a characteristic intensity that exceeds the second threshold results in a third operation. In some embodiments, a comparison between the characteristic intensity and one or more thresholds is used to determine whether or not to perform one or more operations (e.g., whether to perform a respective operation or forgo performing the respective operation), rather than being used to determine whether to perform a first operation or a second operation.

As used herein, an “installed application” refers to a software application that has been downloaded onto an electronic device (e.g., devices 100, 300, and/or 500) and is ready to be launched (e.g., become opened) on the device. In some embodiments, a downloaded application becomes an installed application by way of an installation program that extracts program portions from a downloaded package and integrates the extracted portions with the operating system of the computer system.

As used herein, the terms “open application” or “executing application” refer to a software application with retained state information (e.g., as part of device/global internal state 157 and/or application internal state 192). An open or executing application is, optionally, any one of the following types of applications:
an active application, which is currently displayed on a display screen of the device that the application is being used on;
a background application (or background processes), which is not currently displayed, but one or more processes for the application are being processed by one or more processors; and
a suspended or hibernated application, which is not running, but has state information that is stored in memory (volatile and non-volatile, respectively) and that can be used to resume execution of the application.

As used herein, the term “closed application” refers to software applications without retained state information (e.g., state information for closed applications is not stored in a memory of the device). Accordingly, closing an application includes stopping and/or removing application processes for the application and removing state information for the application from the memory of the device. Generally, opening a second application while in a first application does not close the first application. When the second application is displayed and the first application ceases to be displayed, the first application becomes a background application.

Attention is now directed towards embodiments of user interfaces (“UI”) and associated processes that are implemented on an electronic device, such as portable multifunction device 100, device 300, or device 500.

FIGS. 6A-6O illustrate exemplary user interfaces and illumination techniques for scanning documents, in accordance with some embodiments. The user interfaces in these figures are used to illustrate the processes described below, including the processes in FIG. 7. The user interfaces and illumination techniques described herein enable the creation of higher quality scanned images of documents by utilizing different settings to take multiple image data and combine the multiple image data into a single scanned document.

FIG. 6A illustrates computer system 600 (e.g., a tablet computer) with display 602, a camera (or in some embodiments, multiple cameras such as a front facing camera, a rear facing camera, and/or a wide angle camera), and flash 620. Computer system 600 displays, on display 602, camera user interface 604 which includes capture button 604a, live preview 604b, and other affordances used to alter or change the settings of capturing images with a camera application of computer system 600. In some embodiments, prior to displaying camera user interface 604, computer system 600 displays a home screen user interface and detects an input to launch the camera application (e.g., a tap or other input selecting a button associated with the camera application). Thus, computer system 600 displays camera user interface 604, as shown in FIG. 6A, in response to detecting such an input.

Live preview 604b displays media that will be recorded and/or is being recorded through the camera of computer system 600 to provide a user with the field-of-view of the camera of computer system 600. This allows a user to understand what is currently included in the camera's field-of-view and would be captured in an image or other media (e.g., a video) when an input directed to capture button 604a is detected by computer system 600. In FIG. 6A, live preview 604b includes table 606 and mug 608, which are currently at least partially within the field-of-view of the camera of computer system 600.

At FIG. 6B, computer system 600 detects document 610a (e.g., in live preview 604b and/or within the field-of-view of the camera of computer system 600) and displays live preview 604b which includes document 610a to be scanned. In some embodiments, computer system 600 is moved through the environment around computer system 600 (e.g., by a user of computer system 600) before detecting document 610a. In some embodiments, document 610a is moved through the environment around computer system 600 until it enters live preview 604b and/or the field-of-view of the camera of computer system 600. Upon (e.g., in response to and/or after) detecting document 610a (e.g., within live preview 604b and/or within the field-of-view of the camera of computer system 600), computer system 600 updates camera user interface 604 to include document indicators 604c and scan button 604d. Document indicators 604c show where a document has been detected and is being displayed within live preview 604b and can include lines at the corners, as shown in FIG. 6B. In some embodiments, document indicators 604c can include a full outline of document 610a, a line on each side of document 610a, or any other visual indicator that provides information about the size, shape, and/or placement of document 610a within live preview 604b.

Computer system 600 detects document 610a within live preview 604b based on the size, shape, and/or content of the document. For example, computer system 600 detects objects that have similar dimensions to known paper dimensions such as 8.5 inches by 11 inches, 8.5 inches by 14 inches, 11 by 17 inches, and/or 8.3 inches by 11.7 inches. As another example, computer system 600 detects objects that include text, script, pictures, and/or a combination of these types of content. In some embodiments, computer system 600 detects document 610a within live preview 604b based on a combination of the size, shape, and/or content of the document and thus may consider each of the size, shape, and/or content alone or in combination to determine whether to display document indicators 604c and/or scan button 604d.

At FIG. 6B, computer system 600 detects an input indicative of capturing image data and in response to detecting the input and based on the type of input detected and/or whether a document is detected within live preview 604b, utilizes one of the several configurations of flash 620 that are shown in FIG. 6C. Flash 620 includes nine, separately-controllable segments that each include one or more light emitting diodes (LEDs) for illuminating a portion of the environment to be captured by the camera (e.g., that is included within the field-of-view of the camera). The individual segments of flash 620 are selectively enabled to provide different patterns of illumination of the environment and objects within the environment to produce higher quality image data, including photographs, videos, and/or document scans based on the content that is to be captured within the image data.

As shown in FIG. 6C, in configuration 622a the middle segment of the nine segments is illuminated while the outer eight segments are not illuminated. In configuration 622b, the outer ring of eight segments are illuminated while the middle segment is not illuminated. In configuration 622c, the middle segment and the four edge segments are illuminated while the corner segments are not illuminated. In configuration 622d, the four corner segments are illuminated while the middle segment and the four edge segments are not illuminated. Each of these configurations provides advantages and disadvantages when capturing image data while they are enabled. For example, configurations 622a illuminates the middle of the field-of-view of the camera which provides more clarity for objects in the middle of the field-of-view but may wash out reflective surfaces. Thus, utilizing each of configurations 622a, 622b, 622c, 622d, and/or any other configurations in the proper circumstances can increase the quality of the image data that is captured by computer system 600.

Additionally, as will be discussed in greater detail below, the quality and fidelity of image data and in particular, document scans, can be increased by capturing data for multiple images of the same document while utilizing different configurations of flash 620 and combining the multiple image data using image processing techniques. In this way, unwanted contrast, shadows, and/or other artifacts can be removed from the document scans increasing the readability and overall quality of the produced copies of the document.

Returning to FIG. 6B, computer system 600 detects input 640a on capture button 604a. In some embodiments, input 640a includes a touch input (e.g., tap and/or swipe), click (e.g., using a mouse), press of a hardware button, and/or an air gesture. Other inputs on buttons and/or affordances described herein can similarly be different types of inputs, including the types of inputs described above. In response to detecting input 640a on capture button 604a, computer system 600 captures image data 650a using the camera of computer system 600 while illuminating flash 620 with configuration 622a. Computer system 600 illuminates flash 620 with configuration 622a because input 640a is on capture button 604a and thus indicates that a picture should be taken, rather than a document scan, a video, or another type of media. Computer system 600 is configured to utilize configuration 622a when capturing pictures because configuration 622a provides a level of illumination that is helpful when taking images and increases the quality by providing general levels of illumination.

As shown in FIG. 6D, in response to detecting input 640a and after capturing image data 650a, computer system 600 displays image data 650a. Image data 650a includes representations of mug 608 and document 610a as well as shadow 612a of computer system 600. Image data 650a includes the full field-of-view of the camera of computer system 600 because input 640a causes a picture to be taken and thus the camera of computer system 600 does not edit or reduce the field-of-view during capture of image data 650a. Further, because configuration 622a of flash 620 is used during the capture of image data 650a, shadow 612a is brighter near the center of image data 650a and fades to full darkness at the edges of image data 650a.

In some embodiments, in response to detecting input 640a on capture button 604a, computer system 600 determines whether live preview 604b includes a document, such as document 610a. When computer system 600 determines that live preview 604b includes a document, computer system 600 enters the scanning user interface and creates a scan of document 610a, as discussed further below with reference to FIGS. 6E-6I, rather than capturing image data 650a as discussed above.

In some embodiments, computer system 600 determines that live preview 604b does not include a document in response to detecting input 640a on capture button 604a and does not enter the scanning user interface. Rather, computer system 600 captures image data 650a using the camera of computer system 600 while illuminating flash 620 with configuration 622a, as discussed above.

Returning to FIG. 6B, computer system 600 detects input 640b on scan button 604d. In response to detecting input 640b on scan button 604d, computer system 600 enters a scanning mode and displays scanning user interface 660, as shown in FIG. 6E. Scanning user interface 660 includes live preview 604b, which displays document 610a highlighted with an overlay. The overlay indicates the portion of live preview 604b that includes the document to be scanned. After highlighting document 610a within live preview 604b, computer system 600 captures image data 650b (e.g., a digital version of document 610a) and displays image data 650b within scanning user interface 660, as shown in FIG. 6F. Scanning user interface 660 displays image data 650b in an expanded and rectified view, which does not reflect the entire current field-of-view of the camera of computer system 600 (e.g., does not include mug 608). This focuses scanning user interface 660 on the current state of the scan of document 610a and conveys to the user information about the progress of the scan, without displaying information that is not necessary to scanning document 610a (e.g., the rest of the field-of-view of the camera of computer system 600). In some embodiments, computer system 600 captures image data 650b automatically without receiving any other user input after a predetermined time of detecting input 640b. In some embodiments, computer system 600 captures image data 650b after detecting another user input indicating that image data should be captured, such as an input on capture button 604a.

While capturing image data 650b, computer system 600 illuminates flash 620 with configuration 622b. Configuration 622b (e.g., a ring configuration) is used to illuminate the document that is being scanned, without placing an emphasis on the middle of the document which may reflect more light. Accordingly, the resulting image data 650b includes a representation of document 610a in which the outer edges are slightly washed out from the light emitted by flash 620 as well as shadow 612b. However, because the configuration 622b is used when capturing image data 650b, shadow 612b appears different from shadow 612a. In particular, shadow 612b is lighter at the edge of image data 650b and darkens near the center of image data 650b, the opposite of shadow 612a in image data 650a. Additionally, the displayed image data 650b contains a version of document 610a that is enlarged and fits the display of computer system 600 without being angled.

In addition to displaying image data 650b, scanning user interface 660 further includes save button 660a, cancel button 660b, and notifications 660c and 660d. In response to detecting selection of save button 660a, computer system 600 saves image data 650b as a scan of document 610a and exits scanning user interface 660. In response to detecting selection of cancel button 660b, computer system 600 exits scanning user interface 660 and disregards image data 650b without saving image data 650b. Notification 660c indicates to a user of computer system 600 that if additional image data is taken, the scan of document 610a can be improved (e.g., by removing more of shadow 612b, adjusting the contrast, and/or removing other artifacts). Notification 660d indicates to a user that by moving and/or tilting computer system 600 along a vertical access (e.g., to the left or right) when capturing further image data the scan of document 610a will be improved. In some embodiments, notification 660d is animated to indicate how computer system 600 should be moved.

After capturing and displaying image data 650b, as shown in FIG. 6F, computer system 600 captures additional image data and combines the new image data with image data 650b to create image data 650c (e.g., a digital version of document 610a), as shown in FIG. 6G. In some embodiments, computer system 600 captures the new image data automatically after a predetermined amount of time (e.g., 0.5, 1, 2, or 3 seconds) without detecting additional user input. In some embodiments, computer system 600 captures the new image data in response to detecting a user input indicating capture of image data, such as a tap on the display of computer system 600 and/or a press of a button of computer system 600. In some embodiments, computer system 600 automatically captures the new image data in response to detecting that computer system 600 has moved and/or tilted in a direction displayed within notification 660d or another notification of scanning user interface 660.

While capturing the new image data to be combined with image data 650b, computer system 600 utilizes flash 620 in configuration 622d. Configurations 622d illuminates the corners of document 610a during capture of the new image data to further remove shadow 612b and to rectify the washed-out appearance caused by using flash 620 in configuration 622b when capturing image data 650b. In this way, the scan of document 610a is improved by capturing additional image data while illuminating document 610a with different configurations of flash 620.

Computer system 600 updates scanning user interface 660 to include image data 650c reflecting the increase in quality of the scan of document 610a after capturing the new image data and combing the new image data with image data 650b. Computer system 600 further updates notification 660d of scanning user interface 660 to show that if further image data is captured after computer system 600 is moved and/or tilted along a horizontal access (e.g., up and/or down), the scan of document 610a can be further improved. In some embodiments, scanning user interface 660 includes a user interface element that is displayed over image data 650c that moves in response to movement of computer system 600. For example, when computer system 600 is moved and/or tilted along a horizontal access (e.g., up and/or down) the user interface element includes a line that moves up and down image data 650c.

After displaying image data 650c as shown in FIG. 6G, computer system 600 captures even more image data and combines the new image data with image data 650c to create image data 650d (e.g., a digital version of document 610a), as shown in FIG. 6H. In some embodiments, computer system 600 captures the new image data automatically after a predetermined amount of time (e.g., 0.5, 1, 2, or 3 seconds) without detecting additional user input. In some embodiments, computer system 600 captures the new image data in response to detecting a user input indicating capture of image data, such as a tap on the display of computer system 600 and/or a press of a button of computer system 600. In some embodiments, computer system 600 automatically captures the new image data in response to detecting that computer system 600 has moved and/or tilted in a direction displayed within notification 660d or another notification of scanning user interface 660.

While capturing the new image data to be combined with image data 650c, computer system 600 utilizes flash 620 in configuration 622c. Configurations 622c illuminates the edges and the center of document 610a during capture of the new image data to further remove shadow 612b and to rectify the washed-out appearance caused by using flash 620 in configuration 622b when capturing image data 650b. Computer system 600 combines each of the captured image data to create image data 650d and utilizes various types of image processing to remove shadow 612b and correct other effects that occurred during image capture.

Accordingly, computer system 600 can capture data for multiple images of document 610a using different flash configurations to remove shadows, adjust the contrast of the image data, and/or otherwise improve the quality of the scan of document 610a. In some embodiments, computer system 600 captures a predetermined number of image data using a preset list of flash configurations (e.g., first configuration 622b, then configuration 622d, and then configuration 622c). In some embodiments, computer system 600 determines which configurations to use in each image data based on a type of document (e.g., an article, a business card, a coupon, an identification card, and/or any other type of document). In some embodiments, computer system 600 determines which configurations to use in each image data based on the content of the document being scanned (e.g., glossy content, matte content, content that is covered with a shadow, and/or content that is overexposed). In some embodiments, computer system 600 determines a configuration based on the image data that is captured with a previous configuration (e.g., when a first image data includes a shadow computer system 600 selects an appropriate configuration that will help to remove the shadow).

After creating and displaying image data 650d (e.g., a digital version of document 610a), computer system recognizes the type of document (e.g., a receipt, a coupon, a user identification, an article, a book, a photograph, a form, and/or a brochure) captured in image data 650d and updates scanning user interface 660 as shown in FIG. 6I. At FIG. 6I, computer system 600 stops scanning document 610a and updates scanning user interface 660 to include options menu 660e and link 660f. In some embodiments, computer system 600 stops scanning document 610a after detecting that the scan is complete. In some embodiments, computer system 600 stops scanning document 610a after detecting a request to pause the scanning process. In some embodiments, computer system 600 stops scanning document 610a and waits for an indication to continue the scanning process such as a tap on the display of computer system 600 or a press of a button.

Options menu 660e includes copy button 660g, save to file button 660h, and share button 660i. In response to detecting input 640c on save to file button 660h, computer system 600 saves image data 650d as a finalized version of the digital document and optionally, exits scanning user interface 660. After finalizing the scan (e.g., the digital document) of document 610a, computer system 600 provides access to a representation of document 610a to one or more appropriate applications based on the type of content and/or document that is detected, as discussed further with respect to FIGS. 8A-8AC. In some embodiments, the representation of document 610a includes the scan and/or the digital version of document 610a.

At FIG. 6I, link 660f is displayed by computer system 600 in response to computer system 600 determining that image data 650d includes an article that has been published digitally and is available on the internet. Accordingly, link 660f includes a hyperlink to the digitally published version of document 610a which is represented in image data 650d. Computer system 600 detects user input 640d on link 660f.

In response to detecting user input 640d on link 660f, computer system 600 opens a web browsing application and displays digitally published article 670 which corresponds to document 610a and image data 650d, as shown in FIG. 6J. Computer system 600 further displays button 670a corresponding to an option to display the portion of the article that was captured in image data 650d (e.g., the scanned document). Computer system 600 detects user input 640e on button 670a and in response to detecting user input 640e displays the portion of the article corresponding to the portion of the article that was captured in image data 650d, as shown in FIG. 6K. Alternatively, computer system 600 detects user input 650f dragging across the displayed article and in response to detecting user input 650f also displays the portion of the article corresponding to the portion of the article that was captured in image data 650d, as shown in FIG. 6K.

In FIG. 6K, computer system 600 displays portion 670b of the article corresponding to the portion of the article that was captured in image data 650d in a manner that visually distinguishes portion 670b of the article from the rest of the article. For example, the distinguished portion of the article may be highlighted, bolded, displayed in another color, and/or displayed brighter than the rest of the article.

Turning to FIG. 6L, computer system 600 detects document 610b within live preview 604b and in response to detecting document 610b within live preview 604b, displays document indicators 604c and scan button 604d as discussed above. Document 610b is the second page of document 610a discussed above. In some embodiments, document 610b is a second document unrelated to document 610a. Computer system 600 detects user input 640g on scan button 604d and enters scanning mode to scan document 610b. Because document 610b is a second page of document 610a, computer system 600 appends the scan of document 610b to the scan of document 610a (e.g., image data 650d) in a single file, such as a PDF. In some embodiments, computer system 600 creates a new scan when starting to scan document 610b.

Computer system 600 automatically detects that document 610b includes several different portions with different types of content. Each type of content has different properties that affect how the content will response to the type of flash that is used when capturing image data of document 610b. Accordingly, computer system 600 captures image data of each different portion of document 610b using flash settings and other settings that are appropriate for the type of content included in the captured portion.

As shown in FIG. 6M, computer system 600 captures image data 650e corresponding to the portion of document 610b that includes an image with a flash strength of 50%, a temperature setting of warm, and a photo filter. Similarly, computer system 600 captures image data 650f corresponding to the portion of document 610b that includes text with a flash strength of 100%, a temperature setting of cool, and a greyscale filter. Computer system 600 further captures image data 650g corresponding to the portion of document 610b that includes graphics with a flash strength of 100%, a temperature setting of cool, and a black and white filter. In some embodiments, the settings used to capture the different portions of document 610b include different configurations of flash 620, such as those discussed above. In some embodiments, the settings used to capture the different portions of document 610b include different image processing techniques and/or tools. In this way, each portion of document 610b is captured with settings that increase the quality of each image data and thus the resulting scan of document 610b.

After capturing image data 650e, 650f, and 650g, computer system 600 combines image data 650e, 650f, and 650g to create digital document 650h and displays prompt 660j including a request of whether digital document 650h (e.g., the scanned document) should be displayed in a document editor user interface. Computer system 600 detects user input 640h on prompt 660j indicating that image data 650h should be displayed in the document editor user interface and in response to detecting user input 640h on prompt 660j, computer system displays image data 650h within scanning user interface 660, as shown in FIG. 6O.

AT FIG. 6O, computer system 600 indicates that each of portions 650i, 650j, 650k, 6501, and 650m of image data 650h are editable. Computer system 600 detects user input 640i on portion 650i and, in response, allows editing of portion 650i by, for example, displaying a digital keyboard so that a user may delete and/or enter text. Similarly, computer system 600 detects user input 640j on portion 650j and in response allows editing of portion 650j by, for example, displaying other pictures that can be inserted into portion 650j. Computer system 600 then saves image data 650d and 650h as a single file that can be exported, accessed, and/or manipulated by the user.

FIG. 7 is a flow diagram illustrating a method for scanning documents using a computer system in accordance with some embodiments. Method 700 is performed at a computer system (e.g., 100, 300, 500, 600) (e.g., a smartphone, a desktop computer, a laptop, a tablet, and/or a wearable electronic device) that is in communication with a display generation component (e.g., a display controller and/or a touch-sensitive display system), one or more input devices (e.g., a button, a motion detector (e.g., an accelerometer and/or gyroscope), a location sensor (e.g., GPS, Wi-Fi, and/or a radio that indicates a location of the computer system), a camera, and/or a touch sensitive surface), a camera (in some embodiments, a plurality of cameras), and a light source. In some embodiments, the light source comprises a plurality of light segments. In some embodiments, the flash comprises a plurality of light emitting diodes (LED's). In some embodiments, the plurality of light segments can be selectively enabled based on one or more settings of the computer system and/or the camera. In some embodiments, the light source is associated with the camera of the computer system. In some embodiments the light source is a flash of a camera. Some operations in method 700 are, optionally, combined, the orders of some operations are, optionally, changed, and some operations are, optionally, omitted.

As described below, method 700 provides an intuitive way for a method for scanning documents with a dynamic flash. The method reduces the cognitive burden on a user for a method for scanning documents, thereby creating a more efficient human-machine interface. For battery-operated computing devices, enabling a user to scan documents faster and more efficiently conserves power and increases the time between battery charges.

The computer system (e.g., 600) detects (702), via the one or more input devices, a request (e.g., an input such as a tap on a touch sensitive surface, a press of a button, an air gesture, and/or an audio input) (e.g., 640a, and/or 640b) to capture image data (e.g., a scan of a document, a photo, and/or a video) with the camera. In some embodiments, the request to capture image data includes an input on a button associated with capturing image data (e.g., a shutter button and/or a scan button). In some embodiments, the request to capture image data is detected while displaying a user interface of a camera application. In some embodiments, the request to capture image data is detected while displaying a home user interface and in response to detecting the request to capture image data a user interface of a camera application is displayed.

In response to detecting, via the one or more input devices (e.g., 604a and/or 604d), the request to capture image data with the camera (704) and in accordance with a determination that the request to capture image data corresponds to a request (e.g., 640b) to scan a document (e.g., 610a) (706) (e.g., detecting an input on a button and/or affordance to scan a document detected within the field of view of the camera and/or the preview captured by the camera) (in some embodiments, in accordance with a determination that the image being captured includes a document), the computer system (e.g., 600) illuminates (708) (e.g., a subject of the scan and/or an image) at least a first portion of an environment within a field-of-view of the camera by generating light from the light source (e.g., 620) in a first manner (e.g., 622a, 622b, 622c, and/or 622d) (e.g., with a first number of lights, a first light pattern; and/or a first exposure time); and captures (710), via the camera, first image data (e.g., 650b) (e.g., image data to be used to create a scan of a document). In some embodiments, the request to scan the document is detected in response to displaying a prompt to perform a scan. In some embodiments the prompt to perform a scan is provided in response to detecting a document within the field of view of the camera. In some embodiments, the prompt to perform the scan is provided in response to detecting text within the field of view of the camera. In some embodiments, the first manner of illumination of the flash includes a first number of lights. In some embodiments, the first manner of illumination of the flash includes a first exposure setting. In some embodiments, the first manner of illumination includes a first light pattern. In some embodiments, the first image data is converted to a scan (e.g., by image processing such as correcting distortion, removing visual artifacts, increasing contrast, and/or evening brightness of the image data) after the first image data is captured, In some embodiments, the first image data is combined with a plurality of image data to create a scan of a document (e.g., by processing the plurality of images to correct distortion, remove visual artifacts, increase contrast, and/or even the brightness of the document captured by the plurality of image data).

In response to detecting, via the one or more input devices, the request to capture image data with the camera (704) and in accordance with a determination that the request to capture image data corresponds to a request to capture visual media (712) (e.g., 640a) (e.g., a photo and/or a video): the computer system (e.g., 600) illuminates (714) (e.g., a subject of the media) at least a second portion (in some embodiments, the first and second portions are the same) of the environment within a field-of-view of the camera by generating light from the light source (e.g., 620) in a second manner (e.g., 622a, 622b, 622c, and/or 622d) different from the first manner (e.g., with a second number of lights, a second light pattern; and/or a second exposure time); and captures (716) via the camera, second image data (650a) different from the first image data. In some embodiments, the photo and/or video is a standard (e.g., 2D) photo or video. In some embodiments, the photo or video is a spatial photo or video (e.g., 3D photo or video or a photo or video that provides the illusion of depth when viewed). In some embodiments, a request to capture visual media that does not include a document, is not captured in a document capture mode, and/or is not identified as including a document. In some embodiments, the second manner of illumination of the light source includes a second number of lights. In some embodiments, the second manner of illumination of the light source includes a second exposure setting. In some embodiments the second manner of illumination includes a second light pattern. In some embodiments, when a camera capture request is detected, a computer system captures image data with the camera, if the camera capture request is a request to scan a document using a camera, the computer system uses a flash that is configured to illuminate the document in a first manner, and if the camera capture request is a request is to take a photo or video, the computer system uses a flash that is configured to illuminate in a second manner. Using a light source that is configured to illuminate in a first manner in response to a request to scan a document and to illuminate in a second manner in response to a request to capture visual media enables the capture of image data with settings that are customized for the type of media being captured without requiring the user to provide additional inputs to configure the settings for media capture (e.g., selecting a number of illumination components to illuminate, an exposure setting to use, and/or a light pattern), thereby performing an operation when a set of conditions has been met without requiring further user input.

In some embodiments, generating light from the light source (e.g., 620) in the first manner comprises generating light with a first pattern (e.g., 622a, 622b, 622c, and/or 622d) (e.g., a pattern that varies over time and/or in spatial distribution); and generating light from the light source in the second manner comprises generating light with a second pattern (e.g., 622a, 622b, 622c, and/or 622d) different from the first pattern (e.g., the second pattern that varies over time and/or in spatial distribution in a manner that is different from how the first pattern varies over time and/or in spatial distribution). In some embodiments, at least a portion of the first pattern and at least a portion of the second pattern overlap. In some embodiments, no portion of the first pattern and no portion of the second pattern overlap. In some embodiments, the first pattern and the second pattern are selected from a plurality of patterns. In some embodiments, the manner of illumination of the flash determines a light pattern of the flash. Determining a light pattern based on the type of request enables the light pattern to be automatically selected based on the type of request detected without requiring the user to provide additional inputs to select a light pattern, thereby performing an operation when a set of conditions has been met without requiring further user input.

In some embodiments, generating light from the light source (e.g., 620) in the first manner comprises generating light with a first spatial distribution of illumination (e.g., 622a, 622b, 622c, and/or 622d) (e.g., a distribution that is center-weighted or edge-weighted); and generating light from the light source in the second manner comprises generating light with a second spatial distribution (e.g., 622a, 622b, 622c, and/or 622d) of illumination different from the first spatial distribution of illumination. In some embodiments, at least a portion of the first spatial distribution and at least a portion of the second spatial distribution overlap. In some embodiments, no portion of the first spatial distribution and no portion of the second spatial distribution overlap. In some embodiments, the first spatial distribution and the second spatial distribution are selected from a plurality of spatial distributions. In some embodiments, the manner of illumination of the flash determines a spatial distribution of illumination. Determining a spatial distribution of illumination based on the based on the type of request detected enables the spatial distribution to be automatically selected based on the type of request detected without requiring the user to provide additional inputs to select a spatial distribution, thereby performing an operation when a set of conditions has been met without requiring further user input.

In some embodiments, the light source comprises a plurality of illumination components (e.g., discrete and/or addressable light sources that make up the light source), generating light with the first spatial distribution of illumination comprises illuminating a first set of the plurality of illumination components (e.g., 620 as shown in FIG. 6F); and generating light with the second spatial distribution of illumination different from the first spatial distribution of illumination comprises illuminating a second set of the plurality of illumination components (e.g., 620 as shown in FIG. 6G) different from the first set of the plurality of illumination components. In some embodiments, the first set of the plurality of illumination components includes a center pixel of plurality of illumination components. In some embodiments, the first set of the plurality of illumination components includes an outer pixel of the plurality of illumination components. In some embodiments, the first set of the plurality of illumination components includes a plurality of outer illumination components of the plurality of illumination components. In some embodiments, the first set of the plurality of illumination components includes a set of corner illumination components of the plurality of illumination components. In some embodiments, the first set of the plurality of illumination components includes the center pixel and the plurality of outer illumination components of the plurality of illumination components. In some embodiments, the first set of the plurality of illumination components includes the center pixel and the plurality of outer illumination components of the plurality of illumination components without the corner illumination components. In some embodiments, the first set of the plurality of illumination components includes a set of outer illumination components of the plurality of illumination components without the corner illumination components and/or a center pixel. In some embodiments, the second set of the plurality of illumination components includes a center pixel of plurality of illumination components. In some embodiments, the second set of the plurality of illumination components includes an outer pixel of the plurality of illumination components. In some embodiments, the second set of the plurality of illumination components includes a plurality of outer illumination components of the plurality of illumination components. In some embodiments, the second set of the plurality of illumination components includes a set of corner illumination components of the plurality of illumination components. In some embodiments, the second set of the plurality of illumination components includes the center pixel and the plurality of outer illumination components of the plurality of illumination components. In some embodiments, the second set of the plurality of illumination components includes the center pixel and the plurality of outer illumination components of the plurality of illumination components without the corner illumination components. In some embodiments, the second set of the plurality of illumination components includes a set of outer illumination components of the plurality of illumination components without the corner illumination components and/or a center pixel. In some embodiments, the computer system changes the flash illumination components of the flash that are illuminated (e.g., inner region, outer region, corners, center and sides without corners, and/or sides without corners or center). Determining a set of illumination components to be illuminated based on the manner of illumination of the light source enables appropriate illumination components to be automatically selected based on the type of request detected without requiring the user to provide additional inputs to select specific illumination components, thereby performing an operation when a set of conditions has been met without requiring further user input.

In some embodiments, in response to detecting, via the one or more input devices, the request to capture image data (e.g., 640b) with the camera: in accordance with a determination that the request is a request to scan content (e.g., 610a) having a first document property (e.g., the document is glossy, the document is matte, the document is reflective, the document is not reflective, and/or the document absorbs light), the computer system (e.g., 600) illuminates (e.g., a subject of the scan and/or an image) at least the first portion of the environment within the field-of-view of the camera by generating light from the light source (e.g., 620) in a third manner (e.g., 622a, 622b, 622c, and/or 622d) (e.g., with a third number of lights, a third light pattern; and/or a third exposure time); and in accordance with a determination that the request is a request to scan content having a second document property different from the first document property (e.g., the document is glossy, the document is matte, the document is reflective, the document is not reflective, and/or the document absorbs light), the computer system illuminates (e.g., a subject of the scan and/or an image) at least the first portion of the environment within the field-of-view of the camera by generating light from the light source in a fourth manner (e.g., 622a, 622b, 622c, and/or 622d) that is different from the third manner (e.g., with a fourth number of lights, a fourth light pattern; and/or a fourth exposure time). In some embodiments, the manner of illumination is based on the content being scanned (e.g., glossy vs matte). The manner of illumination being based on a document property of the content being scanned enables the manner of illumination to be based on the type of content without requiring the user to provide additional inputs, thereby performing an operation when a set of conditions has been met without requiring further user input.

In some embodiments, illuminating (e.g., a subject of the scan and/or an image) at least the first portion of the environment within the field-of-view of the camera by generating light from the light source (e.g., 620) in the first manner includes: in accordance with a determination that a document (e.g., 610a) within the field-of-view of the camera is a first type of document (e.g., an article, a receipt, a business card, a photograph, an identification card, a book, and/or a coupon), using a first flash setting (e.g., 622a, 622b, 622c, and/or 622d) (e.g., with a first number of lights, a first light pattern; and/or a first exposure time); and in accordance with a determination that the document within the field-of-view of the camera is a second type of document different from the first type of document (e.g., an article, a receipt, a business card, a photograph, an identification card, a book, and/or a coupon), using a second flash setting (e.g., 622a, 622b, 622c, and/or 622d) (e.g., with a first number of lights, a first light pattern; and/or a first exposure time), different from the first flash setting. In some embodiments, when scanning a document the computer system picks a flash setting based on detected type of document. Selecting a flash setting based on a detected type of document enables the flash setting to be automatically selected based a type of document that has been detected without requiring the user to provide additional inputs about the document and/or the light source, thereby performing an operation when a set of conditions has been met without requiring further user input.

In some embodiments, capturing, via the camera, first image data (e.g., 650b) includes using a first exposure setting (e.g., using a first aperture setting, a first shutter speed, and/or a first light sensitivity (e.g., ISO) setting) and wherein capturing, via the camera, second image data (e.g., 650a) different from the first image data includes using a second exposure setting that is different from the first exposure setting (e.g., a second aperture setting that is different from the first aperture setting, a second shutter speed that is different from the first shutter speed, and/or a second light sensitivity (e.g., ISO) setting that is different from the first light sensitivity setting). In some embodiments, the first exposure setting causes at least a portion of the field-of-view of the camera to be ignored during capture of the first image data. In some embodiments, the first exposure setting causes at least a portion of the field-of-view of the camera to be deemphasized during capture of the first image data. In some embodiments, using the first exposure setting includes using a first plurality of settings to achieve a first desired exposure. In some embodiments, using the second exposure setting includes using a second plurality of settings to achieve a second desired exposure. In some embodiments, when scanning a document, the computer system uses a document-specific exposure setting (ignoring or deemphasizing other portions of the field of view of the camera). In some embodiments, the second exposure setting causes at least a portion of the field-of-view of the camera to be ignored during capture of the second image data different from the first image data. In some embodiments, the second exposure setting causes at least a portion of the field-of-view of the camera to be deemphasized during capture of the second image data different from the first image data. Automatically using a document specific exposure setting when scanning the document enables the exposure setting to be selected without requiring the user to provide additional inputs about the document, thereby performing an operation when a set of conditions has been met without requiring further user input.

In some embodiments, capturing, via the camera, first image data (e.g., 650b) includes: performing a first type of image processing (e.g., a first type of distortion correction, a first type of visual artifact removal, a first type of contrast increase, and/or a first type of brightness evening) on a first component (e.g., 650e, 650f, and/or 650g) (e.g., a portion or segment of the image data that is identified as corresponding to photos, text, and/or graphics) of the first image data; and performing a second type of image processing (e.g., a second type of distortion correction, a second type of visual artifact removal, a second type of contrast increase, and/or a second type of brightness evening) different from the first type of image processing on a second component (e.g., 650e, 650f, 650g) (e.g., a portion or segment of the image data that is identified as corresponding to photos, text, and/or graphics) of the first image data, wherein the second component is different from the first component. In some embodiments, when scanning a document, the computer system uses different image processing for different components of the document (e.g., photos, text, or graphics). Using different image processing for different components of the document enables the image processing without requiring the user to provide additional inputs to select different portions of the image and different image processing, thereby reducing the number of inputs needed to perform an operation.

In some embodiments, capturing, via the camera, first image data (e.g., 650b) further includes: illuminating (e.g., a subject of the scan and/or an image) at least the first portion of the environment within the field-of-view of the camera by generating light from the light source in a third manner (e.g., 622a, 622b, 622c, and/or 622d) (e.g., with a third number of lights that is different from the first number of lights, a third light pattern that is different from the first lighting pattern; and/or a third exposure time that is different from the first exposure time) that is different from the first manner; capturing, via the camera, third image data different from the first image data (e.g., image data to be used to create a scan of a document); and combining the first image data and the third image data to create a digital document (e.g., 650c, and/or 650d) (e.g., a scan, copy, facsimile, and/or digital version). In some embodiments, when scanning a document, the computer system takes multiple photos with different flash settings and combines the multiple photos together (e.g., no flash, full flash, and/or center flash). In some embodiments, no light is generated. Capturing multiple image data while generating light in different manners and combining the image data enables a higher quality scan of the document without requiring the user to provide additional inputs to enter the scanning interface and combine the images, thereby reducing the number of inputs needed to perform an operation.

In some embodiments, illuminating at least the first portion of the environment within the field-of-view of the camera by generating light from the light source (e.g., 620) in the first manner (e.g., 622a, 622b, 622c, and/or 622d) includes illuminating at least the first portion of the environment within the field-of-view of the camera by generating light from the light source in the first manner while the light source (in some embodiments, the computer system) is at a first location within the environment (e.g., a first location relative to a document being captured); capturing, via the camera, first image data (e.g., 650b) includes capturing the first image data while the camera (in some embodiments, the computer system) is at the first location within the environment; and after capturing the first image data while the camera is at the first location within the environment: the computer system (e.g., 600) illuminates at least the first portion of the environment within the field-of-view of the camera by generating light from the light source in a third manner (e.g., 622a, 622b, 622c, and/or 622d) different from the first manner while the light source (in some embodiments, the computer system) is at a second location (e.g., a location relative to the document) within the environment that is different from the first location within the environment; the computer system captures, via the camera, third image data that is different from the first image data while the camera (in some embodiments, the computer system) is at the second location within the environment; and the computer system combines the first image data and the third image data to create a digital document (e.g., 650c, 650d, and/or 650h) that is based on at least a portion of the first image data and at least a portion of the third image data. In some embodiments, when scanning a document, the computer system captures image data from different locations relative to the document and then combines the image data into a single scan. Capturing multiple image data at different locations and combining the image data together enables a higher quality scan of the document without requiring the user to provide additional inputs to enter the scanning interface and combine the images, thereby reducing the number of inputs needed to perform an operation.

In some embodiments, after (e.g., in response to) capturing the first image data (e.g., 650b) and before capturing the third image data, the computer system (e.g., 600) displays a prompt (e.g., 660c, and/or 660d) requesting the capture of third image data at the second location within the environment that is different from the first location within the environment. In some embodiments, the computer system prompts a user to take pictures from different locations relative to the document. Prompting a user to take pictures from different locations relative to the document provides visual feedback about a scanning process and helps the user quickly and easily determine how to improve the quality of the scan, thereby providing improved feedback to the user.

In some embodiments, the prompt (e.g., 660c, and/or 660d) includes a request to move the computer system while capturing the third image data. (e.g., is displayed within a user interface for capturing the image data and/or provided as an audio output while capturing the image data). In some embodiments, the computer system asks the user to move the computer system while capturing the image data. Asking a user to move the device while capturing the image data provides visual feedback about a scanning process and helps the user quickly and easily determine how to improve the quality of the scan, thereby providing improved feedback to the user.

In some embodiments, the digital document (e.g., 650c, 650d, and/or 650h) (e.g., a scan, copy, facsimile, and/or digital version) includes fourth image data with a visual quality that is higher than the first image data and/or the third image data (e.g., the image data are combined to create a new image and image processing is applied to remove artifacts, increase contrast, and/or improve the readability of a document within the image). In some embodiments, the computer system improves the scan with subsequent captures of image data. The digital document including image data with a visual quality that is higher than previously captured image data provides visual feedback about a scanning process and helps the user quickly and easily determine that the quality of the scan is improving, thereby providing improved feedback to the user.

In some embodiments, while capturing the third image data: the computer system (e.g., 600) displays, via the display generation component, a document scanning user interface (e.g., 660) including: a representation (e.g., a preview) of the digital document (e.g., 650c, 650d, and/or 650h) (e.g., a scan, copy, facsimile, and/or digital version); and visual feedback (e.g., 660d) including movement of a graphical element over the representation of the digital document indicating progress in creating the digital document. In some embodiments, the computer system shows feedback while capturing image data that includes moving graphical elements over a copy of the content to indicate scanning progress. Displaying feedback including moving graphical elements over a representation of the document to indicate scanning progress while capturing the image data provides visual feedback about the scanning process and helps the user quickly and easily determine the improved quality of the scan, thereby providing improved feedback to the user.

In some embodiments, the representation of the digital document (e.g., 650c, 650d, and/or 650h) is an expanded (e.g., an enlarged version of the document being scanned as viewed in a live preview, a version that is bigger than the actual size of the document being scanned, and/or a magnified version of the document being scanned) (in some embodiments, also rectified) version of the document (e.g., 610a). In some embodiments, the representation of the digital document is rectified (e.g., realigned, straightened, and/or perspective-corrected relative to the document, as captured by the camera). Displaying an expanded version of the document while capturing the image data provides visual feedback about the scanning process and helps the user quickly and easily determine the improved quality of the scan, thereby providing improved feedback to the user.

In some embodiments, the computer system (e.g., 600) detects a first type of movement of the computer system (e.g., movement left to right, right to left, and/or a tilt along a vertical axis of the document) while capturing the third image data; and in response in response to detecting the first type of movement of the computer system while capturing third image, the computer system displays a first graphical element (e.g., 660d as shown in FIG. 6F) moving over the representation of the digital document (e.g., 650b, 650c). In some embodiments, the movement of the first graphical element matches the detected first type of movement. In some embodiments, the movement of the first graphical element is along a same axis as the detected first type of movement. In some embodiments, the computer system detects a second type of movement of the computer system different from the first type of movement of the computer system (e.g., movement up to down, down to up, and/or a tilt along a horizontal axis of the document) while capturing the third image data; and in response to detecting the second type of movement of the computer system while capturing the third image data, the computer system displays a second graphical element (e.g., 660d as shown in FIG. 6G) moving over the representation of the digital document (e.g., 650b, 650c), wherein the second graphical element is different from the first graphical element (e.g., the second graphical element has a different appearance and/or direction of movement than the appearance and/or direction of movement of the first graphical element). In some embodiments, the movement of the second graphical element matches the detected second type of movement. In some embodiments, the movement of the second graphical element is along a same axis as the detected second type of movement. In some embodiments, the computer system displays one element moving with one type of movement of the computer system (left/right movement or tilt along vertical document axis) and another element moving with a second type of movement of the computer system (e.g., up/down movement or tilt along a horizontal document axis). Moving one graphical element in response to one type of movement of the computer system and another graphical element in response to another type of movement of the computer system provides visual feedback about the movement of the computer system during the scanning process and helps the user quickly and easily determine how the movement of the computer system is improving the quality of the scan, thereby providing improved feedback to the user.

In some embodiments, the computer system (e.g., 600) displays, via the display generation component, a media capture user interface (e.g., 604) including a live preview (e.g., 604b) of the field-of-view of the camera; detects a document (e.g., 610a) within the field-of-view of the camera (in some embodiments, within a live preview); and in response to detecting the document within the field-of-view of the camera, displays a prompt (e.g., 604d) (e.g., a button, affordance, and/or notification) to scan the document in the media capture user interface. In some embodiments, the computer system displays a prompt to scan document when a document is detected in a field of view of a camera in a media capture user interface (e.g., a media capture user interface with a live preview, capture affordance, media capture settings, camera mode switcher, or other media capture controls). In some embodiments, the prompt is a user-selectable graphical object. In some embodiments, the request to capture image data with the camera includes selection of the prompt. In some embodiments, the document is detected while displaying the media capture user interface. Displaying a prompt to scan the document when the document is detected in a field-of-view of the camera in a media capture user interface provides visual feedback that a document has been detected and is eligible to be scanned and helps the user quickly and easily determine options for capturing the document, thereby providing improved feedback to the user.

In some embodiments, the computer system (e.g., 600) detects selection (e.g., 640b) (e.g., an input directed to the prompt, a tap gesture (e.g., on a touch-sensitive surface), and/or a button press) of the prompt (e.g., 604d) (e.g., a button, affordance, and/or notification) to scan the document (e.g., 610a); and in response to detecting selection of the prompt to scan the document, displays, via the display generation component, a document scanning user interface (e.g., 660). In some embodiments, the computer system causes a document scanning user interface to be displayed in response to selection of the document scanning prompt. Causing a document scanning user interface to be displayed in response to selection of the document scanning prompt provides visual feedback about the scanning process and helps the user quickly and easily determine that the scanning process is occurring, thereby providing improved feedback to the user.

In some embodiments, in response to detecting the document (e.g., 610a) within the field-of-view of the camera (in some embodiments, within a live preview), the computer system (e.g., 600) displays an indication (e.g., 604c) (e.g., a box, lines, shapes, and/or highlighted regions) of a location of the document within the field-of-view of the camera. In some embodiments, the computer system displays an indication of a detected location of the document. Displaying an indication of a detected location of the document provides visual feedback about the document that has been detected and helps the user quickly and easily determine whether documents are being detected for scanning correctly, thereby providing improved feedback to the user.

In some embodiments, in response to detecting the document (e.g., 610a) within the field-of-view of the camera: in accordance with a determination that the first image data (e.g., 650d) includes a document that is digitally published (e.g., a version of the document that is available to be accessed, retrieved, and/or viewed by a computer system with access to the internet such as through a news application, a web browsing application, and/or another media application), the computer system (e.g., 600) provides access to (e.g., displays) a link (e.g., 660f) to a digitally published version of the document. In some embodiments, when a document is scanned that has been digitally published, the computer system provides a link to a digital copy of the document. Automatically providing a link to a digital copy of the document when the document is scanned and has been digitally published enables user access to the digital version without requiring the user to provide additional inputs to locate to the digital version, thereby performing an operation when a set of conditions has been met without requiring further user input.

In some embodiments, while providing access to (e.g., displaying) the link (e.g., 660f) to the digitally published version of the document, the computer system (e.g., 600) detects selection of the link (e.g., 640d) (e.g., an input directed to the link, a tap gesture (e.g., on a touch-sensitive surface), and/or a button press) to the digitally published version of the document; and in response to detecting selection of the link to the digitally published version of the document, the computer system displays the digitally published version of the document (e.g., 670), wherein a portion of the digitally published version of the document corresponding to a portion of the document included in the first image data is visually distinguished (e.g., 670b) (e.g., highlighted, indicated, enhanced, and/or emphasized) from other portions of the digitally published version of the document. In some embodiments, when the digital copy of the document is opened, the computer system visually indicates the portion scanned by the computer system. Visually indicating the portion of the digital copy of the document that has been scanned by the computer system provides visual feedback relating the scan to the digital copy of the document and helps the user quickly and easily determine which portions of the document they may be interested in, thereby providing improved feedback to the user.

In some embodiments, the first image data (e.g., 650d) includes a document (e.g., 610a), and after capturing the first image data the computer system (e.g., 600) concurrently displays: a representation of the document generated based on the first image data (e.g., 650d); and a plurality of options (e.g., 660g, 660h, and/or 660i) (e.g., displaying a plurality of buttons associated with copying, saving, and/or sharing the digital document) corresponding to the digital document including a first option that, when selected, initiates a process to perform a first operation corresponding to the digital document. In some embodiments, the plurality of options includes an option to copy the document, an option to save the document, and/or an option to share the document. In some embodiments, when a document is detected (e.g., in a camera) the computer system provides multiple options for next steps with the scanned document (e.g., option to copy, save to files, and/or share the scanned document). In some embodiments, selection of the first option includes an input directed to the first option, a tap gesture (e.g., on a touch-sensitive surface) on the first option, and/or a button press. In some embodiments, selecting the option to copy the document includes an input directed to the option to copy the document, a tap-gesture on the option to copy the document, and/or a button press on a button associated with the option to copy the document. In some embodiments, selecting the option to save the document includes an input directed to the option to save the document, a tap-gesture on the option to save the document, and/or a button press on a button associated with the option to save the document. In some embodiments, selecting the option to share the document includes an input directed to the option to share the document, a tap-gesture on the option to share the document, and/or a button press on a button associated with the option to share the document. Providing multiple options for operations corresponding to the scanned documents when the digital document is generated provides visual feedback about the options available to the user and helps the user quickly and easily determine which option they would like to pursue, thereby providing improved feedback to the user.

Note that details of the processes described above with respect to method 700 (e.g., FIG. 7) are also applicable in an analogous manner to the methods described below. For example, method 900 optionally includes one or more of the characteristics of the various methods described above with reference to method 700. For example, method 900 can scan documents with a dynamic flash as described in method 700 before storing and/or providing access to the scanned documents. For brevity, these details are not repeated below.

FIGS. 8A-8AC illustrate exemplary user interfaces for managing access to scanned documents, in accordance with some embodiments. The user interfaces in these figures are used to illustrate the processes described below, including the processes in FIG. 9. The user interfaces described herein enable the automatic sorting and storage of scanned documents in association with appropriate applications, allowing a user to quickly and efficiently interact with scanned documents.

FIG. 8A illustrates computer system 800 (e.g., a tablet computer) with display 802. Computer system 800 displays camera user interface 804 on display 802 which includes capture button 804a and live preview 804b. Computer system 800 detects document 810a (e.g., within live preview 804b and/or within the field-of-view of the camera of computer system 800) and in response to detecting document 810a, computer system 800 displays document 810a within live preview 804b, as shown in FIG. 8B.

In response to detecting document 810a (e.g., within live preview 804b and/or within the field-of-view of the camera of computer system 800) computer system 800 updates camera user interface 804 to include document indicators 804c and scan button 804d. Document indicators 804c show where a document has been detected and is being displayed within live preview 804b and can include lines at the corners, as shown in FIG. 8B. In some embodiments, document indicators 804c can include a full outline of document 810a, a line on each side of document 810a, or any other visual indicator that provide information about the size, shape, and placement of document 810a within live preview 604b.

After displaying scan button 804d, computer system 800 detects input 840a on button 804d and in response to detecting input 840a on button 804d, computer system 800 begins a scanning process and displays scanning user interface 860, as shown in FIG. 8C. In some embodiments, input 840a includes a touch input (e.g., tap and/or swipe), click (e.g., via a mouse), press of a hardware button, and/or an air gesture. Other inputs on buttons and/or affordances described herein can similarly be different types of inputs, including the types of inputs described above. Scanning user interface 860 includes save button 860a, document representation 862a, image data 850a, and scan indicator 860g. Computer system 800 displays scan indicator 860g as moving over image data 850a to indicate a progress of the scanning process within scanning user interface 860. As scan indicator 860g moves over image data 850a, document representation 862a is progressively populated with the information from image data 860f and reformatted into a standard format for the type of content that is included in image data 850a. Thus, as shown in FIG. 8C, the scanning process is halfway between the start and finish and document representation 862a is halfway populated and/or created. As the scanning process continues, document representation 862a will continue to be populated until the scanning process is complete.

As the scanning process occurs, computer system 800 detects the type of content included in the document of image data 850a and formats document representation 862a accordingly. In particular, as shown in FIGS. 8C and 8F, when computer system 800 detects that the content of the document includes a receipt for payment computer system 800 converts the information into a standard format that is used for all receipts, regardless of the original format or type of receipt that is being scanned.

As shown in FIG. 8D, after the scanning process is completed, computer system 800 ceases display of scan indicator 860g and displays the completed document representation 862a which includes information from the document of image data 850a. Computer system 800 detects input 840b on save button 860a and, in response to detecting the input on save button 860a, determines an appropriate application for the type of content included in the document and provides the appropriate application access to document representation 862a, as shown in FIG. 8H.

In some embodiments, computer system 800 captures data for multiple images using different flash configurations and combines the multiple image data into document representation 862a, as discussed above with respect to FIGS. 6A-6O.

Turning to FIG. 8E, computer system 800 detects the presence of document 810b and displays document indicators 804c and scan button 804d as discussed above. In response to detecting input 840a on button 804d, computer system enters the scanning process and displays scanning user interface 860, as shown in FIG. 8F. Computer system 800 displays scan indicator 860g as moving over image data 850b to indicate a progress of the scanning process within scanning user interface 860. As scan indicator 860g moves over image data 850b, document representation 862b is progressively populated with the information from image data 850b and reformatted into the standard format for receipts based on the detected content of the document in image data 860f. Accordingly, the format of document representation 862b and 862a are the same even though the format of the documents included in image data 850a and 850b are different.

As shown in FIG. 8G, after the scanning process is completed, computer system 800 ceases display of scan indicator 860g and displays the completed document representation 862b including information from the document of image data 850b. Computer system 800 detects input 840c on save button 860a, and in response to detecting input 840c on save button 860a, determines an appropriate application for the type of content included in the document and provides the appropriate application access to document representation 862b, as shown in FIG. 8H.

In FIG. 8H, computer system 800 displays user interface 870 for a wallet application which has access to any document representations of receipts that computer system 800 has access to, including document representation 862a and document representation 862b. The user interface for the wallet application includes document representation 862a and document representation 862b that can be selected by, for example, a user input. In response to detecting a user input, computer system 800 displays an enlarged version of the selected document representation for further review.

Computer system 800 intelligently determines different types of content included in scanned documents and provides access to the representations of the scanned documents to appropriate applications to efficiently and automatically sort the scanned documents and provide access to the documents in an intuitive manner.

At FIG. 8I, computer system detects document 810c and displays document indicators 804c and scan button 804d as discussed above. In response to detecting input 840a on button 804d, computer system 800 scans document 810c by, for example, entering and executing the scanning process as discussed above with respect to FIGS. 8C-8G. After scanning document 810c, computer system 800 determines that the content of document 810c includes a coupon and provides access to document representation 862c of the coupon to a wallet application, as shown in FIG. 8J.

At FIG. 8J, computer system 800 displays user interface 870 for the wallet application including document representation 862c of the coupon that was scanned by computer system 800 as well as other coupons that have been added to computer system 800 (e.g., by being scanned, downloaded, and/or saved). In some embodiments, in response to detecting an input on document representation 862c, computer system 800 displays an enlarged version of document representation 862c.

At FIG. 8K, computer system 800 detects that computer system 800 is at a location associated with document representation 862c. In response to detecting that computer system 800 is at a location where document representation 862c can be used, computer system 800 displays banner 872 corresponding to document representation 862c providing notification that the coupon can be used. In some embodiments, computer system 800 displays banner 872 in response to other criteria being met including timing criteria (e.g., it is now an appropriate date for the coupon to be used and/or the coupon will expire) or other location criteria (e.g., computer system 800 is near a location associated with the coupon). Computer system 800 detects input 840d on button 872 and in response to detecting input 840d displays document representation 862c and/or user interface 870 as shown in FIG. 8J.

At FIG. 8L, computer system detects document 810d and displays document indicators 804c and scan button 804d as discussed above. In response to detecting input 840a on button 804d, computer system 800 scans document 810d by, for example, entering and executing the scanning process as discussed above with respect to FIGS. 8C-8G. After scanning document 810d, computer system 800 determines that the content of document 810d includes a user identification and provides access to document representation 862d of the user identification to a wallet application, as shown in FIG. 8M.

At FIG. 8M, computer system 800 displays user interface 870 for the wallet application including document representation 862d of the user identification that was scanned by computer system 800. In some embodiments, in response to detecting an input on document representation 862d, computer system 800 displays an enlarged version of document representation 862d. Computer system 800 further displays button 870a corresponding to a process to create a digital identification from document representation 862d. In response to detecting input 840e on button 870a computer system 800 starts a process to convert document representation 862d into a digital driver's license (e.g., for the state of Arizona).

At FIG. 8N, computer system detects document 810e and displays document indicators 804c and scan button 804d as discussed above. In response to detecting input 840a on button 804d, computer system 800 scans document 810e by, for example, entering and executing the scanning process as discussed above with respect to FIGS. 8C-8G. After scanning document 810e, computer system 800 determines that the content of document 810e includes an article and provides access to document representation 862e of the article to a news application, as shown in FIG. 8O. Computer system 800 further detects that the document includes information that was also published digitally online and displays button 804e associated with the process of navigating to the digitally published article. In response to detecting input 840f on button 804e, computer system 800 displays the digital published article within web browser 882, as shown in FIG. 8P.

At FIG. 8O, computer system 800 displays user interface 880 for the news application including document representation 862e of the article that was scanned by computer system 800. Computer system 800 detects input 840g on document representation 862e and in response to detecting input 840g on document representation 862e, computer system 800 displays a digitally published version of the article included in document representation 862e within web browser 882, as shown in FIG. 8P. Computer system 800 further displays button 882a associated with the function of displaying the portion of the digitally published article that corresponds to the portion of the article was scanned. As discussed above with respect to FIGS. 6J and 6K, in response to detecting input 840h on button 882a, computer system 800 displays the portion of the digitally published article that corresponds to the portion of the article was scanned, which is optionally distinguished from the rest of the digitally published article. In some embodiments, computer system 800 provides access to document representation 862e to the web browsing application as shown in FIG. 8P without displaying user interface 880 of the news application.

At FIG. 8Q, computer system detects document 810f and displays document indicators 804c and scan button 804d as discussed above. In response to detecting input 840a on button 804d, computer system 800 scans document 810f by, for example, entering and executing the scanning process as discussed above with respect to FIGS. 8C-8G. After scanning document 810f, computer system 800 determines that the content of document 810f includes a fillable form and provides access to document representation 862f of the form to a document management application, as shown in FIG. 8R. In some embodiments, computer system 800 displays a prompt requesting if document representation 862f should be provided to a document management application and/or a document editing application, as discussed above with respect to FIG. 6N, and provides document representation 862f (or any other document representation) to the document management application and/or the document editing application in response to detecting an input indicating that document representation 862f is to be provided to the document management application and/or the document editing application.

At FIG. 8R, computer system 800 displays user interface 884 for the document management application, including document representation 862f of the form that was scanned by computer system 800 and button 884a corresponding to a process to retrieve a digital version of the form that was scanned. Computer system 800 detects input 840i on button 882a and in response to detecting input 840i on button 884a, computer system 800 accesses a website where the digital version of the form can be found and displays this website in user interface 882 for the web browsing application, as shown in FIG. 8S.

After displaying the website in the web browsing application, as shown in FIG. 8S, computer system 800 detects input 840j on button 882b corresponding to a process to download the digital version of the form. In response to detecting input 840j on button 882b, computer system 800 downloads the digital version of the form to computer system 800 and provides access to the digital version of the form to the document management application, as shown in FIG. 8T.

At FIG. 8T, after computer system 800 downloads the digital version of the form and provides access to the digital version of the form to the document management application, computer system 800 displays digital form 886 and imports (e.g., transposes) data 886a from document representation 862f to digital form 886. Accordingly, the information that was handwritten on document representation 862f is converted into text and inserted into the appropriate fillable fields of digital form 886 automatically when digital form 886 is accessed by the document management application.

In some embodiments, in response to detecting input 840h on button 882a, computer system 800 automatically downloads the digital version of the form and provides access to the digital version of the form to the document management application, as shown in FIG. 8T, without displaying the website and/or the web browsing application. In some embodiments, computer system 800 provides (e.g., displays) a prompt requesting confirmation that digital form 886 is to be downloaded and detects a user input confirming that digital form 886 is to be downloaded. In some embodiments, computer system 800 provides (e.g., displays) a prompt requesting confirmation that the information from document representation 862f is to be imported into digital form 886 and detects a user input confirming that the information from document representation 862f is to be imported into digital form 886 prior to importing the information into digital form 886. In some embodiments, in response to detecting input 840p on button 884a, computer system 800 accesses digital form 886 through the web browsing application and imports the information from document representation 862f into digital form 886 within the web browsing application.

At FIG. 8U, computer system detects document 810g and displays document indicators 804c and scan button 804d as discussed above. In response to detecting input 840a on button 804d, computer system 800 scans document 810g by, for example, entering and executing the scanning process as discussed above with respect to FIGS. 8C-8G. After scanning document 810g, computer system 800 determines that the content of document 810g includes contact information and provides access to document representation 862g of the contact information to a contacts application, as shown in FIG. 8V.

At FIG. 8V, computer system 800 displays user interface 868 for the contacts application including document representation 862g of the data from business card that was scanned by computer system 800 and button 868a corresponding to a process to save the contact information as a new contact. Computer system 800 detects input 840k on button 868a and in response to detecting input 840k on button 868a saves (e.g., stores) the information from document 810g as a contact for “John Appleseed.”

At FIG. 8W, computer system 800 displays user interface 888 for an images application that accesses and displays images that computer system 800 has previously captured, downloaded, and/or otherwise accessed. User interface 888 includes image data 850c and gallery 888a consisting of smaller versions of the available image data, including image data 850a. In some embodiments, computer system 800 displays a most recently captured and/or downloaded image within user interface 888. In some embodiments, computer system 800 displays a most recently viewed image within user interface 888.

While displaying user interface 888, computer system 800 detects input 840l, which includes movement across display 802. In response to detecting input 840l, computer system 800 updates user interface 888 to include a different image available to computer system 800 and optionally, indicated in gallery 888a. In particular, in response to the detecting input 840l, computer system 800 scrolls through the available image data and displays image data 850d, as shown in FIG. 8X.

In FIG. 8X, computer system 800 has updated user interface 888 to include image data 850d that has been previously captured, retrieved, and/or downloaded by computer system 800 at a time prior to the current display of image data 850d. While displaying image data 850d, computer system 800 detects that image data 850d includes document 810h. In response to detecting that image data 850d includes document 810h, computer system 800 displays document indicators 888c and scan button 888d. In some embodiments, computer system 800 detects the presence of document 810h within image data 850d similarly to how computer system 800 detects the presence of document 810a within live preview 804b, as discussed above with reference to FIG. 8B except that document 810h is included in previously captured image data rather than a live preview of image data to be captured.

Computer system 800 detects input 840m on scan button 888d and in response to detecting input 840m on button 888d, computer system 800 scans document 810h by, for example, entering and executing the scanning process as discussed above with respect to FIGS. 8C-8G. Once computer system 800 has finished scanning document 810h, computer system 800 provides access to the document representation to an appropriate application, such as the document management application shown in FIG. 8R. Computer system 800 provides access to the document representation corresponding to document 810h to an appropriate application based on the content included in document 810h. Thus, if document 810h were to include a receipt and/or a coupon, computer system 800 would provide access to the document representation of the receipt and/or the coupon to a wallet application, as shown in FIGS. 8H and 8J.

At FIG. 8Y, computer system 800 detects page 810i, which is recognized as being a document (e.g., a book and/or a portion of a book) and detects an input to scan page 810i. In response to detecting the input to scan page 810i, computer system 800 scans page 810i by, for example, entering and executing the scanning process as discussed above with respect to FIGS. 8C-8G.

Computer system 800 uses camera 818 to capture the area in front of computer system 800 including page 810i as document representation 862i. In some embodiments, camera 818 has a wide angle and/or wide angle mode that is used to capture a larger portion of the area in front of computer system 800 including page 810i. In some embodiments, document representation 862i is (or has been) modified (e.g., to correct distortion of the image of the surface) (e.g., adjusted, manipulated, corrected) based on a position (e.g., location and/or orientation) of page 810i relative to camera 818. In some embodiments, document representation 862i is modified using image processing software (e.g., skewing, rotating, flipping, and/or otherwise manipulating image data captured by camera 818). In some embodiments, document representation 862i is modified without physically adjusting the camera (e.g., without rotating the camera, without lifting the camera, without lowering the camera, without adjusting an angle of the camera, and/or without adjusting a physical component (e.g., lens and/or sensor) of the camera). In some embodiments, document representation 862i is modified such that the camera appears to be pointed at page 810i (e.g., facing the document, aimed at the document, pointed along an axis that is normal to the document). In some embodiments, document representation 862i automatically modified in real time (e.g., prior to and/or during the capture of image data used to generate document representation 862i). In some embodiments, document representation 862i is automatically modified (e.g., without user input) based on the position of page 810i relative to camera 818. In some embodiments, document representation 862i is modified such that the pages of document representation 862i appear to be flat. In some embodiments, document representation 862i is modified using image processing to remove waves, bends, and/or other artifacts that are captured in image data of page 810i.

After the image data captured by camera 818 is modified to create document representation 862i and computer system 800 has finished scanning page 810i, computer system 800 displays document representation 862i including the two pages of the book that were scanned, as shown in FIG. 8Z. Computer system 800 further displays button 826 associated with a process for saving document representation 862i and providing access to document representation 862i to a books application. Computer system 800 detects input 840n on button 826. In response to detecting input 840n on button 826, computer system 800 provides access to document representation 862i in the books application.

In FIG. 8AA, computer system 800 displays a user interface 836 for the books application. User interface 836 includes page 836a for the book that was previously scanned by computer system 800 and button 836b associated with a process for purchasing and downloading the full book. In some embodiments, user interface 836 is displayed in response to computer system 800 detecting user input 840n on button 826. In some embodiments, user interface 836 is displayed in response to computer system 800 detecting an input to read a portion of the book that was not included in document representation 862i. While displaying page 836a, computer system 800 detects user input 8400 on button 836b and in response to detecting user input 840m, starts a process to purchase the book displayed in page 836a. In some embodiments, the process to purchase the book displayed includes downloading the book and displaying the digital version of the book, as shown in FIG. 8AB.

In FIG. 8AB, computer system 800 displays user interface 836 for the books application including book 836c. Portion 836d of the displayed book 836c that coincides with the portion of the book that is included in document representation 862i is highlighted and/or otherwise visually distinguished to indicate which portions of the book were previously captured in a scan by computer system 800. When computer system 800 is rotated, user interface 836 adjusts to display two pages of downloaded book 836c and also includes highlighted and/or otherwise visually distinguished portion 836d to indicate which portions of the book were previously captured in a scan by computer system 800, as shown in FIG. 8AC.

FIG. 9 is a flow diagram illustrating a method for managing access to scanned documents using a computer system in accordance with some embodiments. Method 900 is performed at a computer system (e.g., 100, 300, 500, 600, 800) (e.g., a smartphone, a desktop computer, a laptop, a tablet, and/or a wearable electronic device) that is in communication with a display generation component (e.g., a display controller and/or a touch-sensitive display system), one or more input devices (e.g., a button, a motion detector (e.g., an accelerometer and/or gyroscope), a location sensor (e.g., GPS, Wi-Fi, and/or a radio that indicates a location of the computer system), a camera, and/or a touch sensitive surface). Some operations in method 900 are, optionally, combined, the orders of some operations are, optionally, changed, and some operations are, optionally, omitted.

As described below, method 900 provides an intuitive way for a method for managing access to scanned documents. The method reduces the cognitive burden on a user for a method for managing access to scanned documents, thereby creating a more efficient human-machine interface. For battery-operated computing devices, enabling a user to scan and access documents faster and more efficiently conserves power and increases the time between battery charges.

The computer system (e.g., 800) obtains image data (e.g., 850a, 850b, and/or 850d) (e.g., a scan and/or a photo) including visual information corresponding to a document (902) (e.g., 810a, 810b, 810c, 810d, 810e, 810f, 810g, 810h, and/or 810i) (e.g., an image or video of a flyer, a receipt, an article, a book, a coupon, an identification card and/or other document information). In some embodiments, the image data including the document is captured via a camera that is configured to communicate with the computer system. In some embodiments, the image data including the document is received from another computer system (e.g., a server, a smartphone, a desktop computer, a laptop, a tablet, and/or a wearable electronic device). In some embodiments, the image data including the document is captured using a scanning application. In some embodiments, the image data including the document is captured using a camera operating in a scanning mode. In some embodiments, the image data including the document is captured in response to detecting an input directed to a capture and/or scanning button.

In response to obtaining the image data (e.g., 850a, 850b, and/or 850d) including the visual information corresponding to the document (e.g., 810a, 810b, 810c, 810d, 810e, 810f, 810g, 810h, and/or 810i) (904): in accordance with a determination that the document includes a first type of content (e.g., a picture, numerical text, a chapter of a book, a news article, and/or user identification), the computer system (e.g. 800) provides access to a representation of the document (e.g., 862a, 862b, 862c, 862d, 862e, 862f, 862g, and/or 862i) via a first application (906) (e.g., displayed within user interface 870 as shown in FIG. 8H) (e.g., a payment application, a news application, a web browser, a photo application, a reading and/or book application, and/or a credential application) (e.g., without providing access to the representation of the document via a second application). In some embodiments, an application installed on the computer system. In some embodiments, after providing access to the representation of the document via the first application, the first application is opened and the representation of the document is displayed with the first application. In some embodiments, an input is detected to open the first application and in response to detecting the input, the first application is opened (e.g., displayed) and the representation of the document is displayed with the first application.

In response to obtaining the image data (e.g., 850a, 850b, and/or 850d) including the visual information corresponding to the document (e.g., 810a, 810b, 810c, 810d, 810e, 810f, 810g, 810h, and/or 810i) (904): in accordance with a determination that the document includes a second type of content different from the first type of content (e.g., a picture, numerical text, a chapter of a book, a news article, and/or user identification), the computer system (e.g., 800) provides access to the representation of the document (e.g., 862a, 862b, 862c, 862d, 862e, 862f, 862g, and/or 862i) via a second application (e.g., displayed within user interface 870 as shown in FIG. 8H, as displayed within user interface 880 as shown in FIG. 8O, as displayed within user interface 884 as shown in FIG. 8R, and/or as displayed within user interface 868 as shown in FIG. 8V) different from the first application (908) (e.g., a payment application, a news application, a web browser, a photo application, a reading and/or book application, and/or a credential application) (e.g., without providing access to the representation of the document via the first application). In some embodiments, in accordance with the determination that the document includes the first type of content, providing the representation of the document to a third type of application (e.g., when the document is a news article it is provided to both a web browser and a news application). In some embodiments, the image data is processed to create the representation of the document. In some embodiments, the image data is digitized to create a digital version of the document included in the image data. In some embodiments, a first representation of the document (e.g., a digitized version) and a second representation of the document (e.g., an image of the document) are provided to the first application. In some embodiments, after providing the representation of the document to the first application or the second application, the representation of the document is stored in association with the application. In some embodiments, after providing the representation of the document to the first application or the second application, the representation of the document is displayed via the display generation component. In some embodiments, after providing the representation of the document to the first application, a user interface associated with the first application including the representation of the document is displayed via the display generation component. In some embodiments, after providing the representation of the document to the second application, a user interface associated with the second application including the representation of the document is displayed via the display generation component. In some embodiments, after providing access to the representation of the document via the second application, the second application is opened and the representation of the document is displayed with the second application. In some embodiments, an input is detected to open the second application and in response to detecting the input, the second application is opened (e.g., displayed) and the representation of the document is displayed with the second application. In some embodiments, the computer system scans a document and after scanning the document provides a representation of the document to a first application or a second application based on the content of the document. Obtaining image data corresponding to a document and providing a representation of the document to a first application or a second application based on the content of the document enables the computer system to provide the representation of the document to an appropriate application automatically without requiring further input from the user (e.g., selecting an application to provide the representation of the document to), thereby performing an operation when a set of conditions has been met without requiring further user input.

In some embodiments, the first type of content includes a receipt for payment (e.g., 810a) and the first application is a payment application (e.g., as displayed in user interface 810) (e.g., a wallet application, an expense application, and/or a banking application). In some embodiments, receipts are provided to a payment application (e.g., a digital wallet). Automatically providing receipts to a payment application enables the computer system to provide the scanned receipts to an appropriate application without requiring input from the user selecting the payment application, thereby performing an operation when a set of conditions has been met without requiring further user input.

In some embodiments, providing access to the representation of the document via the first application includes displaying the visual information corresponding to the document to a representation of the document (e.g., the digital receipt) with a standard style (e.g., 862a as shown in FIGS. 8C and 8D and/or 862b as shown in FIG. 8F) (e.g., a style with uniform margins, spacing, text size, and/or other properties that is applied to all scanned documents of the same type). In some embodiments, a predetermined format that can, for example, include a predetermined order of elements of data (e.g., date, cost, location). In some embodiments, all receipts are converted to the standard style, regardless of original format or source. In some embodiments, the computer system reformats scanned receipts as digital receipts with a standard style. Reformatting the scanned receipts as digital receipts with a standard style provides visual feedback about the scanned receipts and helps the user quickly and easily determine the contents of the receipt, thereby providing improved feedback to the user.

In some embodiments, after (in some embodiments, in response to) obtaining at least a first portion of the image data including visual information corresponding to the document, the computer system (e.g., 800) displays a first portion of the representation of the document with the standard style (in some embodiments, while (e.g., simultaneously and/or concurrently with the image data) converting the visual information corresponding to the document to the representation of the document with the standard style) (e.g., 862a as shown in FIGS. 8C and 8D and/or 862b as shown in FIG. 8F). In some embodiments, the computer system displays the digital receipt during the scanning process. Displaying the digital receipt with the standard style during the scanning process provides visual feedback about the progress of the scanning process and helps the user quickly and easily determine the status of the scanning process, thereby providing improved feedback to the user.

In some embodiments, after (in some embodiments, in response to) displaying the first portion of the representation of the document with the standard style: the computer system (e.g., 800) displays an updated representation of the document with the standard style (e.g., 862a as shown in 8D), wherein the updated representation of the document with the standard style includes the first portion of the representation of the document with the standard style and a second portion of the representation of the document with the standard style that was generated based on a second portion of the image data including visual information corresponding to the document that was obtained after obtaining the first portion of the image data that was used to generated the first portion of the representation (in some embodiments, while (e.g., simultaneously and/or concurrently with the image data) converting the visual information corresponding to the document to the representation of the document with the standard style). In some embodiments, the second portion of the image data including visual information corresponding to the document corresponds to (e.g., matches) the second portion of the representation of the document with the standard style. In some embodiments, the computer system progressively populates the digital receipt as the scan progresses. Progressively populating the digital receipt with the standard style as the scan progresses provides visual feedback about the progress of the scanning process and helps the user quickly and easily determine the status of the scanning process, thereby providing improved feedback to the user.

In some embodiments, after displaying the representation of the document with the standard style (e.g., 862a as shown in FIGS. 8C and 8D and/or 862b as shown in FIG. 8F): the computer system (e.g., 800) receives a request to access the image data including the visual information corresponding to the document without the standard style; and in response to receiving the request to access the image data, displays the image data including the visual information corresponding to the document without the standard style (e.g., 850b as shown in FIG. 8G). In some embodiments, the computer system keeps a copy of the scanned receipt available after converting the scanned receipt to a digital receipt. Accessing and displaying the receipt without the standard style after displaying the scanned receipt with the standard style provides visual feedback about the scanned receipt and helps the user determine that the scanning process correctly captured the receipt, thereby providing improved feedback to the user.

In some embodiments, the computer system (e.g., 800) detects a digital document (e.g., 810a and/or 810b) including the first type of content (e.g., a receipt attached to and/or in a communication (e.g., email and/or text message) received from another user); and in response to detecting the digital document including the first type of content, provides access to a representation of the digital document via the payment application (e.g., 862a and/or 862b as displayed in 870 as shown in FIG. 8H) (e.g., a payment application, wallet, expense application, and/or banking application). In some embodiments, the computer system pulls in digital receipts from other sources (e.g., email and/or messages) into a payment application. In some embodiments, digital receipts are available in a same user interface and/or application. In some embodiments, digital receipts are available in the same user interface and/or application regardless of a source of a digital receipt. Automatically providing access to digital receipts from other sources enables the computer system to gather receipts in the same location for review by the user without requiring input to find and select each receipt, thereby reducing the number of inputs needed to perform an operation.

In some embodiments, the second type of content includes a coupon (e.g., 810c) (e.g., a voucher, form, and/or other document entitling the holder to a discount) and the second application includes a second payment application (e.g., as shown in FIG. 8J) (e.g., a payment application, wallet, expense application, and/or banking application). In some embodiments, the payment application and the second payment application are the same application. In some embodiments, the second payment application includes an application for storing coupons, receipts, credit card information, bank information, and/or other financial information associated with a user of the computer system. In some embodiments, the computer system provides coupons to a payment application. Automatically providing coupons to a payment application enables the computer system to provide the scanned coupons to an appropriate application without requiring input from the user selecting the payment application, thereby performing an operation when a set of conditions has been met without requiring further user input.

In some embodiments, after providing access to the representation of the document via the second payment application: the computer system (e.g., 800) detects that a condition (e.g., a location criteria, a timing criteria, a location condition, and/or a timing condition) associated with the coupon is met; and in response to detecting that the condition associated with the coupon is met, provides (e.g., displaying and/or providing an audio output) a notification (e.g., 872) of an opportunity to use the coupon. In some embodiments, the computer system reminds the user when there is an opportunity to use the coupon (e.g., based on location and/or date/time). Reminding the user when there is an opportunity to use a previously scanned coupon provides visual feedback about the availability of coupons and helps the user quickly and easily determine when a coupon that has been scanned can be used, thereby providing improved feedback to the user.

In some embodiments, the second type of content includes a news article (e.g., 810e) (e.g., a text, piece, and/or work for the propagation of news, research, and/or analysis to the public) and the second application includes a news application (e.g., as shown in FIG. 8O). In some embodiments, the computer system provides news articles to a news application. In some embodiments, the news application includes an application for accessing digital versions of news articles. In some embodiments, the news application includes access to news articles from a plurality of publications (e.g., magazines, newspapers, and/or digital publishers). Automatically providing news articles to a news application enables the computer system to provide the scanned news articles to an appropriate application without requiring input from the user selecting the news application, thereby performing an operation when a set of conditions has been met without requiring further user input.

In some embodiments, after providing access to the representation of the document via the news application: the computer system (e.g., 800) displays, via the display generation component, a news application user interface (e.g., 880) including a link (e.g., 862e and/or 804e) to a digitally published version of the document (e.g., a version of the document that is available to be accessed, retrieved, and/or viewed by a computer system with access to the internet such as through a news application, a web browsing application, and/or another media application). In some embodiments, the computer system provides a link to digital versions of a scanned news article. Displaying a link to a digital version of the scanned news article enables user access to the digital version without requiring the user to provide additional inputs to locate to the digital version, thereby reducing the number of inputs needed to perform an operation.

In some embodiments, the second type of content includes a news article (e.g., 810e) and the second application includes a web browsing application (e.g., as shown in FIG. 8P). In some embodiments, the computer system provides news articles to a web browser. In some embodiments, a web browsing application includes an application for displaying web pages and/or accessing information available on the internet. Automatically providing news articles to a web browsing application enables the computer system to provide the scanned news articles to an appropriate application without requiring input from the user selecting the web browser, thereby performing an operation when a set of conditions has been met without requiring further user input.

In some embodiments, the second type of content includes contact information (e.g., 810g) (e.g., information corresponding to a contactable user such as a name, phone number, and/or address) and the second application includes a contacts application (e.g., as shown in FIG. 8V). In some embodiments, the computer system provides the contact information to a contacts application. In some embodiments, a contacts application includes an application for storing information associated with users including names, phone numbers, email addresses, and/or physical addresses. Automatically providing contact information to a contacts application enables the computer system to provide the scanned contact information to an appropriate application without requiring input from the user selecting the contact application, thereby performing an operation when a set of conditions has been met without requiring further user input.

In some embodiments, the second type of content includes a photograph (e.g., 850c) and the second application includes a media library application (e.g., as shown in FIG. 8W). In some embodiments, the computer system provides photographs to a photographs application. In some embodiments, the media library application includes an application that accesses and/or displays media (e.g., photographs, videos, and/or other images) that is available to the computer system. In some embodiments, the media available to the computer system includes media stored on the computer system and/or media that the computer system accesses over a network (e.g., a local network and/or the internet). Automatically providing photographs to a media library application enables the computer system to provide the scanned photographs to an appropriate application without requiring input from the user selecting the photograph application, thereby performing an operation when a set of conditions has been met without requiring further user input.

In some embodiments, the second type of content includes a book (e.g., 810i) and the second application includes a content reader application (e.g., as shown in FIG. 8Z and/or FIG. 8AB). In some examples, the computer system provides books to a books application. In some examples, the content reader application includes an application that accesses and/or displays documents such as books, magazines, comic books, articles, and/or brochures that are available to the computer system. In some embodiments, the books, magazines, comic books, articles, and/or brochures that are available to the computer system are stored on the computer system and/or accessible to the computer system over a network (e.g., a local network and/or the internet). Automatically providing books to a content reader application enables the computer system to provide the scanned books to an appropriate application without requiring input from the user selecting the books application, thereby performing an operation when a set of conditions has been met without requiring further user input.

In some embodiments, the second type of content includes a user identification (e.g., 810d) (e.g., a driver's license, passport, identification card, registration card, and/or other identification associated with the user) and the second application is a secure credential application (e.g., as shown in FIG. 8M) (e.g., a payment application, a wallet, and/or another secure application). In some examples, the computer system provides driver's license photographs to a secure credential application (e.g., a wallet application). In some examples, the secure credential application includes an application that accesses and/or displays sensitive information associated with a user such as identification cards, credit cards, financial information, identification information, and/or other private information. In some embodiments, the secure credential application displays the sensitive information in response to detecting proof of a user's identity such as a password and/or a biometric identification associated with the user. Automatically providing user identification to a secure credential application enables the computer system to provide the scanned user identification to an appropriate application without requiring input from the user selecting the secure credential application, thereby performing an operation when a set of conditions has been met without requiring further user input.

In some embodiments, after providing access to the representation of the document via the secure credential application: the computer system (e.g., 800) displays via the display generation component, a user interface of the secure credential application (e.g., 870) including an option (e.g., 870a) (in some examples, a user interface selectable object) for converting the representation of the document to a digital identification (e.g., a digital version of the user identification issued by a government, secure, and/or otherwise authorized organization); detects selection (e.g., 840e) (e.g., an input directed to the option, a tap gesture (e.g., on a touch-sensitive surface), and/or a button press) of the option for converting the representation of the document to the digital identification; and in response to detecting selection of the option for converting the representation of the document to the digital identification, updates the display of the user interface of the secure credential application to include the digital identification. In some embodiments, the digital identification includes a version of the document retrieved from a government and/or secure resource such as a website, server, and/or database. In some embodiments, in response to detecting selection of the option for converting the representation of the document to the digital identification, the computer system downloads the digital identification to the computer system. In some embodiments, updating the display of the user interface of the secure credential application to include the digital identification includes displaying a representation of the digital identification. In some embodiments, updating the display of the user interface of the secure credential application to include the digital identification includes replacing the representation of the document with the digital identification. In some embodiments, the computer system provides an option to convert a scanned driver's license photograph to a digital identification. Providing an option to convert the scanned user identification to a digital identification enables a user to convert the scanned driver's license to digital identification without requiring the user to provide additional inputs to request a digital identification (e.g., navigating to a website and/or application associated with the digital identification and providing inputs to create the digital identification), thereby reducing the number of inputs needed to perform an operation.

In some embodiments, after providing access to the representation of the document via the second application: the computer system (e.g., 800) displays, via the display generation component, a user interface of the second application (e.g., 884) including a link (e.g., 8884a) to a digital version of the document (e.g., a hyperlink to a web version of the document, a hyperlink that downloads a local version of the digital version of the document hosted on a website, and/or a hyperlink to a website where the digital version of the document is found); detects selection (e.g., an input directed to the link, a tap gesture (e.g., on a touch-sensitive surface), and/or a button press) of the link to the digital version of the document; and in response to detecting selection of the link to the digital version of the document, displays the digital version of the document (e.g., in a web browsing application, a news application, and/or a content reader application). In some embodiments, displaying the digital version of the document includes displaying a user interface for an application other than the second application. In some embodiments, displaying the digital version of the document includes displaying the digital version of the document in the user interface of the second application. In some embodiments the representation of the document includes the link to the digital version of the document when the digital version of the document is found via a web search. In some embodiments, the representation of the document includes a link to a digital version of the document. Displaying a digital version of the document in response to detecting selection of a link to a digital version of the document enables user access to the digital version without requiring the user to provide additional inputs to locate the digital version (e.g., navigating to a website and/or application associated with the digital version and selecting the digital version), thereby reducing the number of inputs needed to perform an operation.

In some embodiments, displaying the digital version of the document (886) includes displaying the digital version of the document with information imported (e.g., 886a) (e.g., copied, converted, and/or retrieved) from the representation of the document (e.g., importing the information from the representation of the document to the web version of the document and/or copying the information from the representation of the document to a local version of the digital version of the document). In some embodiments importing the detected information included in the representation of the document to the digital version of the document includes converting handwritten text to typewritten text. In some embodiments, importing the detected information included in the representation of the document to the digital version of the document includes importing a first field of the detected information to a first field of the digital version of the document. In some embodiments, the computer system imports the information into the digital version of the document after downloading the digital version of the document. In some embodiments, the computer system detects the information while displaying the representation of the document. In some embodiments, the computer system imports the information into the digital version of the document in response to detecting the information while displaying the representation of the document. In some embodiments, the computer system imports information entered into a scanned physical form into the digital version of the document (e.g., converting from handwriting to text). Displaying the digital version of the document including information imported from the scanned document enables filling of the digital version of the document without requiring the user to provide additional inputs to copy the text, thereby reducing the number of inputs needed to perform an operation.

In some embodiments, the document has a first format (e.g., 810a, 810b, and/or 810f); the representation of the document includes a digital document that has a second format different from the first format (e.g., 862a, 862b, and/or 886) (e.g., the representation of the document is a digital document that has been reformatted from the formatting of the document captured in the image data); and the digital document includes information from the visual information corresponding to the document. In some embodiments, the representation of the document includes a digital document that has been reformatted and includes the information from the scanned document. The representation of the document including a digital document that has been reformatted and includes the information from the scanned document enables user access to the digital version without requiring the user to provide additional inputs to reformat the scanned information, thereby reducing the number of inputs needed to perform an operation.

In some embodiments, the representation of the document (e.g., 862a, 862b, 862c, 862d, 862e, 862f, 862g, and/or 862i) includes at least a portion of the visual information corresponding to the document (e.g., 810a, 810b, 810c, 810d, 810e, 810f, 810g, 810h, and/or 810i). In some embodiments, the representation of the document includes captured visual information from the document (e.g., some or all of the scanned document). The representation of the document including captured visual information from the document enables user access to the information of the scanned document without requiring the user to provide additional inputs to select certain information, thereby reducing the number of inputs needed to perform an operation.

In some embodiments, in response to obtaining the image data including visual information corresponding to the document (e.g., 810a, 810b, 810c, 810d, 810e, 810f, 810g, 810h, and/or 810i) the computer system (e.g., 800): displays, via the display generation component, an option (e.g., 884a and/or options displayed in FIG. 8X) (in some examples, a user interface selectable object) for providing access to the representation of the document via a document editing application (e.g., 884 as shown in FIG. 8R); detects selection of the option for providing access to the representation of the document via the document editing application (e.g., 840i, and/or 840j); and in response to detecting selection of the option providing access to the representation of the document via the document editing application, displays a document editing application user interface including an editable version of the representation of the document (e.g., 886). In some embodiments, the editable version of the representation of the document includes one or more editable fields. In some embodiments, the one or more editable fields include a portion of the displayed representation of the document that changes in response to a detected selection. In some embodiments, the computer system displays the portion of the representation of the document with a first property (e.g., a first picture, first text, first color, first spacing, first highlighting, and/or other first editable property of a portion of a document). In some embodiments, the computer system displays the portion of the representation of the document with a second property (e.g., a second picture different from the first picture, second text different from the first text, second color different from the first color, second spacing different from the first spacing, second highlighting different from the first highlighting, and/or other second editable property of a portion of a document different from the first editable property of the portion of the document) different from the first property in response to detecting a selection of the second property. In some embodiments, the computer system provides the scanned document to a document editing application. Displaying an option to provide the scanned document to a document editing application and displaying the document editing application user interface including the editable version of the representation of the document in response to detecting selection of the option provides visual feedback about options available to the user and helps the user quickly and easily determine how they would like to access the scanned document, thereby providing improved feedback to the user.

In some embodiments, obtaining the image data (e.g., a scan and/or a photo) including visual information corresponding to the document further comprises: retrieving a previously captured media including a detected document (e.g., as shown in FIG. 8X). In some embodiments, the computer system performs a scan on previously captured media (e.g., a photo or video) that has a recognized document. Performing a scan on previously captured media that has a detected document enables a user to scan documents without requiring additional inputs to take additional image data of the documents, thereby reducing the number of inputs needed to perform an operation.

In some embodiments, obtaining the image data (e.g., a scan and/or a photo) including visual information corresponding to the document further comprises: capturing the image data with a camera (in some embodiments, a front-facing camera) in a wide angle mode of operation (e.g., as shown in FIG. 8Y). In some embodiments, the computer system captures a scan with a front facing camera using a desk view (e.g., rectified wide angle camera). In some embodiments, the image data is captured using a camera in a mode configured to capture a surface in front of the computer system similar to the modes described in U.S. Patent Application Pub. No. 2023/0109787 and in particular as described with respect to FIGS. 6A-6AL, 8, 13A-13K, and 14 of U.S. Patent Application Pub. No. 2023/0109787. In some embodiments, the image data is modified (e.g., to correct distortion of the image document) (e.g., adjusted, manipulated, corrected). In some embodiments, the image data is modified using image processing software (e.g., skewing, rotating, flipping, and/or otherwise manipulating image data captured by the one or more cameras). In some embodiments, the image data is modified without physically adjusting the camera (e.g., without rotating the camera, without lifting the camera, without lowering the camera, without adjusting an angle of the camera, and/or without adjusting a physical component (e.g., lens and/or sensor) of the camera). In some embodiments, the image data is modified such that the camera appears to be pointed at the document (e.g., facing the document, aimed at the document, pointed along an axis that is normal to the document). In some embodiments, the image data is corrected such that the line of sight of the camera appears to be perpendicular to the document. In some embodiments, the image data is not modified based on the location of the document relative to one or more cameras of the computer system. In some embodiments, the image data is automatically modified in real time (e.g., during the scanning process). In some embodiments, the image data is automatically modified (e.g., without user input) based on the position of the document relative to one or more cameras of the computer system. Capturing a scan with a camera in a wide angle mode of operation enables the computer system to capture wide view scans without requiring further input from the user (e.g., selecting a wide view camera or setting an exposure setting to include a wide view), thereby performing an operation when a set of conditions has been met without requiring further user input.

Note that details of the processes described above with respect to method 900 (e.g., FIG. 9) are also applicable in an analogous manner to the methods described above. For example, method 700 optionally includes one or more of the characteristics of the various methods described above with reference to method 900. For example, method 700 can provide access to scanned documents as described in method 900 after scanning the documents. For brevity, these details are not repeated above.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the techniques and their practical applications. Others skilled in the art are thereby enabled to best utilize the techniques and various embodiments with various modifications as are suited to the particular use contemplated.

Although the disclosure and examples have been fully described with reference to the accompanying drawings, it is to be noted that various changes and modifications will become apparent to those skilled in the art. Such changes and modifications are to be understood as being included within the scope of the disclosure and examples as defined by the claims.

As described above, one aspect of the present technology is the gathering and use of data available from various sources to improve processes and user interfaces for scanning and accessing documents. The present disclosure contemplates that in some instances, this gathered data may include personal information data that uniquely identifies or can be used to contact or locate a specific person. Such personal information data can include demographic data, location-based data, telephone numbers, email addresses, social network IDs, home addresses, data or records relating to a user's health or level of fitness (e.g., vital signs measurements, medication information, exercise information), date of birth, or any other identifying or personal information.

The present disclosure recognizes that the use of such personal information data, in the present technology, can be used to the benefit of users. For example, the personal information data can be used to provide scanned documents to appropriate applications. Accordingly, use of such personal information data enables users to have calculated control of how scanned documents are stored. Further, other uses for personal information data that benefit the user are also contemplated by the present disclosure. For instance, health and fitness data may be used to provide insights into a user's general wellness, or may be used as positive feedback to individuals using technology to pursue wellness goals.

The present disclosure contemplates that the entities responsible for the collection, analysis, disclosure, transfer, storage, or other use of such personal information data will comply with well-established privacy policies and/or privacy practices. In particular, such entities should implement and consistently use privacy policies and practices that are generally recognized as meeting or exceeding industry or governmental requirements for maintaining personal information data private and secure. Such policies should be easily accessible by users, and should be updated as the collection and/or use of data changes. Personal information from users should be collected for legitimate and reasonable uses of the entity and not shared or sold outside of those legitimate uses. Further, such collection/sharing should occur after receiving the informed consent of the users. Additionally, such entities should consider taking any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices. In addition, policies and practices should be adapted for the particular types of personal information data being collected and/or accessed and adapted to applicable laws and standards, including jurisdiction-specific considerations. For instance, in the US, collection of or access to certain health data may be governed by federal and/or state laws, such as the Health Insurance Portability and Accountability Act (HIPAA); whereas health data in other countries may be subject to other regulations and policies and should be handled accordingly. Hence different privacy practices should be maintained for different personal data types in each country.

Despite the foregoing, the present disclosure also contemplates embodiments in which users selectively block the use of, or access to, personal information data. That is, the present disclosure contemplates that hardware and/or software elements can be provided to prevent or block access to such personal information data. For example, in the case of document scanning processes, the present technology can be configured to allow users to select to “opt in” or “opt out” of participation in the collection of personal information data during registration for services or anytime thereafter. In another example, users can select not to provide usage statistics for providing scanned documents to applications. In yet another example, users can select to limit the length of time usage statistics are stored. In addition to providing “opt in” and “opt out” options, the present disclosure contemplates providing notifications relating to the access or use of personal information. For instance, a user may be notified upon downloading an app that their personal information data will be accessed and then reminded again just before personal information data is accessed by the app.

Moreover, it is the intent of the present disclosure that personal information data should be managed and handled in a way to minimize risks of unintentional or unauthorized access or use. Risk can be minimized by limiting the collection of data and deleting data once it is no longer needed. In addition, and when applicable, including in certain health related applications, data de-identification can be used to protect a user's privacy. De-identification may be facilitated, when appropriate, by removing specific identifiers (e.g., date of birth, etc.), controlling the amount or specificity of data stored (e.g., collecting location data a city level rather than at an address level), controlling how data is stored (e.g., aggregating data across users), and/or other methods.

Therefore, although the present disclosure broadly covers use of personal information data to implement one or more various disclosed embodiments, the present disclosure also contemplates that the various embodiments can also be implemented without the need for accessing such personal information data. That is, the various embodiments of the present technology are not rendered inoperable due to the lack of all or a portion of such personal information data. For example, applications for scanned documents can be selected and delivered to users by inferring preferences based on non-personal information data or a bare minimum amount of personal information, such as the content being requested by the device associated with a user, other non-personal information available to the document scanning processes, or publicly available information.

What is claimed is:

1. A computer system configured to communicate with a display generation component, one or more input devices, a camera, and a light source, comprising:
one or more processors; and
memory storing one or more programs configured to be executed by the one or more processors, the one or more programs including instructions for:
detecting, via the one or more input devices, a request to capture image data with the camera;
in response to detecting, via the one or more input devices, the request to capture image data with the camera:
in accordance with a determination that the request to capture image data corresponds to a request to scan a document:
illuminating at least a first portion of an environment within a field-of-view of the camera by generating light from the light source in a first manner; and
capturing, via the camera, first image data; and
in accordance with a determination that the request to capture image data corresponds to a request to capture visual media:
illuminating at least a second portion of the environment within a field-of-view of the camera by generating light from the light source in a second manner different from the first manner; and
capturing, via the camera, second image data different from the first image data.

2. The computer system of claim 1, wherein:
generating light from the light source in the first manner comprises generating light with a first pattern; and
generating light from the light source in the second manner comprises generating light with a second pattern different from the first pattern.

3. The computer system of claim 1, wherein:
generating light from the light source in the first manner comprises generating light with a first spatial distribution of illumination; and
generating light from the light source in the second manner comprises generating light with a second spatial distribution of illumination different from the first spatial distribution of illumination.

4. The computer system of claim 3, wherein the light source comprises a plurality of illumination components and wherein:
generating light with the first spatial distribution of illumination comprises illuminating a first set of the plurality of illumination components; and
generating light with the second spatial distribution of illumination different from the first spatial distribution of illumination comprises illuminating a second set of the plurality of illumination components different from the first set of the plurality of illumination components.

5. The computer system of claim 1, the one or more programs further including instructions for:
in response to detecting, via the one or more input devices, the request to capture image data with the camera:
in accordance with a determination that the request is a request to scan content having a first document property, illuminating at least the first portion of the environment within the field-of-view of the camera by generating light from the light source in a third manner; and
in accordance with a determination that the request is a request to scan content having a second document property different from the first document property, illuminating at least the first portion of the environment within the field-of-view of the camera by generating light from the light source in a fourth manner that is different from the third manner.

6. The computer system of claim 1, wherein illuminating at least the first portion of the environment within the field-of-view of the camera by generating light from the light source in the first manner includes:
in accordance with a determination that a document within the field-of-view of the camera is a first type of document, using a first flash setting; and
in accordance with a determination that the document within the field-of-view of the camera is a second type of document different from the first type of document, using a second flash setting, different from the first flash setting.

7. The computer system of claim 1, wherein capturing, via the camera, first image data includes using a first exposure setting and wherein capturing, via the camera, second image data different from the first image data includes using a second exposure setting that is different from the first exposure setting.

8. The computer system of claim 1, wherein capturing, via the camera, first image data includes:
performing a first type of image processing on a first component of the first image data; and
performing a second type of image processing different from the first type of image processing on a second component of the first image data, wherein the second component is different from the first component.

9. The computer system of claim 1, wherein capturing, via the camera, first image data further includes:
illuminating at least the first portion of the environment within the field-of-view of the camera by generating light from the light source in a third manner that is different from the first manner;
capturing, via the camera, third image data different from the first image data; and
combining the first image data and the third image data to create a digital document.

10. The computer system of claim 1, wherein:
illuminating at least the first portion of the environment within the field-of-view of the camera by generating light from the light source in the first manner includes illuminating at least the first portion of the environment within the field-of-view of the camera by generating light from the light source in the first manner while the light source is at a first location within the environment;
capturing, via the camera, first image data includes capturing the first image data while the camera is at the first location within the environment; and
the method further comprises:
after capturing the first image data while the camera is at the first location within the environment:
illuminating at least the first portion of the environment within the field-of-view of the camera by generating light from the light source in a third manner different from the first manner while the light source is at a second location within the environment that is different from the first location within the environment;
capturing, via the camera, third image data that is different from the first image data while the camera is at the second location within the environment; and
combining the first image data and the third image data to create a digital document that is based on at least a portion of the first image data and at least a portion of the third image data.

11. The computer system of claim 10, the one or more programs further including instructions for:
after capturing the first image data and before capturing the third image data, displaying a prompt requesting the capture of third image data at the second location within the environment that is different from the first location within the environment.

12. The computer system of claim 11, wherein the prompt includes a request to move the computer system while capturing the third image data.

13. The computer system of claim 10, wherein the digital document includes fourth image data with a visual quality that is higher than the first image data and/or the third image data.

14. The computer system of claim 10, the one or more programs further including instructions for:
while capturing the third image data:
displaying, via the display generation component, a document scanning user interface including:
a representation of the digital document; and
visual feedback including movement of a graphical element over the representation of the digital document indicating progress in creating the digital document.

15. The computer system of claim 14, wherein the representation of the digital document is an expanded version of the document.

16. The computer system of claim 14, the one or more programs further including instructions for:
detecting a first type of movement of the computer system while capturing the third image data;
in response to detecting the first type of movement of the computer system while capturing third image, displaying a first graphical element moving over the representation of the digital document;
detecting a second type of movement of the computer system different from the first type of movement of the computer system while capturing the third image data; and
in response to detecting the second type of movement of the computer system while capturing the third image data, displaying a second graphical element moving over the representation of the digital document, wherein the second graphical element is different from the first graphical element.

17. The computer system of claim 1, the one or more programs further including instructions for:
displaying, via the display generation component, a media capture user interface including a live preview of the field-of-view of the camera;
detecting a document within the field-of-view of the camera; and
in response to detecting the document within the field-of-view of the camera, displaying a prompt to scan the document in the media capture user interface.

18. The computer system of claim 17, the one or more programs further including instructions for:
detecting selection of the prompt to scan the document; and
in response to detecting selection of the prompt to scan the document, displaying, via the display generation component, a document scanning user interface.

19. The computer system of claim 17, the one or more programs further including instructions for:
in response to detecting the document within the field-of-view of the camera, displaying an indication of a location of the document within the field-of-view of the camera.

20. The computer system of claim 1, the one or more programs further including instructions for:
in response to detecting the document within the field-of-view of the camera:
in accordance with a determination that the first image data includes a document that is digitally published, provide access to a link to a digitally published version of the document.

21. The computer system of claim 20, the one or more programs further including instructions for:
while providing access to the link to the digitally published version of the document, detecting selection of the link to the digitally published version of the document; and
in response to detecting selection of the link to the digitally published version of the document, displaying the digitally published version of the document, wherein a portion of the digitally published version of the document corresponding to a portion of the document included in the first image data is visually distinguished from other portions of the digitally published version of the document.

22. The computer system of claim 1, wherein the first image data includes a document and wherein the one or more programs further include instructions for:
after capturing the first image data concurrently displaying:
a representation of the document generated based on the first image data; and
a plurality of options corresponding to the digital document including a first option that, when selected, initiates a process to perform a first operation corresponding to the digital document.

23. A non-transitory computer-readable storage medium storing one or more programs configured to be executed by one or more processors of a computer system that is in communication with a display generation component, one or more input devices, a camera, and a light source, the one or more programs including instructions for:
detecting, via the one or more input devices, a request to capture image data with the camera;
in response to detecting, via the one or more input devices, the request to capture image data with the camera:
in accordance with a determination that the request to capture image data corresponds to a request to scan a document:
illuminating at least a first portion of an environment within a field-of-view of the camera by generating light from the light source in a first manner; and
capturing, via the camera, first image data; and
in accordance with a determination that the request to capture image data corresponds to a request to capture visual media:
illuminating at least a second portion of the environment within a field-of-view of the camera by generating light from the light source in a second manner different from the first manner; and
capturing, via the camera, second image data different from the first image data.

24. A method comprising:
at a computer system that is in communication with a display generation component, one or more input devices, a camera, and a light source:
detecting, via the one or more input devices, a request to capture image data with the camera;
in response to detecting, via the one or more input devices, the request to capture image data with the camera:
in accordance with a determination that the request to capture image data corresponds to a request to scan a document:
illuminating at least a first portion of an environment within a field-of-view of the camera by generating light from the light source in a first manner; and
capturing, via the camera, first image data; and
in accordance with a determination that the request to capture image data corresponds to a request to capture visual media:
illuminating at least a second portion of the environment within a field-of-view of the camera by generating light from the light source in a second manner different from the first manner; and
capturing, via the camera, second image data different from the first image data.
